(19) United States
(12) Patent Application Publication
(10) Pub. No.: US 2008/0001751 A1
(43) Pub. Date: Jan. 3, 2008

(54) RFID ENTERPRISE SERVER IMPROVEMENTS

(75) Inventors: Eric J. Gieseke, Lincoln, MA (US); Manju James, Lexington, MA (US); Kenneth R. Traub, Lexington, MA (US)

Correspondence Address: FLIESLER MEYER LLP, 650 CALIFORNIA STREET, 14TH FLOOR, SAN FRANCISCO, CA, 94108, US

(73) Assignee: BEA Systems, Inc., San Jose, CA (US)

(21) Appl. No.: 11/757,192

(22) Filed: Jun. 1, 2007

Related U.S. Application Data
(60) Provisional application No. 60/823,885, filed on Aug. 29, 2006.
(60) Provisional application No. 60/812,460, filed on Jun. 9, 2006.

(51) Int. Cl. G08B 13/14; H04Q 5/22

(52) U.S. Cl. 340/572.1; 340/10.1; 705/28

(57) ABSTRACT

An RFID enterprise server can store ECPCIS events and master data.

### CLAIM OF PRIORITY

This application claims priority to U.S. Provisional Application No. 60/812,460 entitled “Enterprise Server” by Traub et al., filed Jun. 9, 2006 [Atty. Docket No. BEAS-02087US0]; and U.S. Provisional Application No. 60/823,885 entitled “RFID Enterprise Server Improvements” by Traub et al., filed Aug. 29, 2006 [Atty. Docket No. BEAS-02100US0]; which are hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

The present invention relates to RFID enterprise servers.

### BRIEF DESCRIPTION OF THE DRAWINGS

FIGS. 1A-1C illustrates systems of the present invention.

FIGS. 2A-2G illustrates Master Data of one embodiment of the present invention.

FIG. 3A-3J illustrate a query interface of one embodiment

FIGS. 4A-4I illustrates Enterprise reports of one embodiment.

FIGS. 5A-5M illustrates an EPCIS server design of one embodiment.

FIGS. 6A-6I illustrate an EPCIS Event capture and Query service Design

FIGS. 7A-7D illustrates a compliance express enterprise data of one embodiment.

### DETAILED DESCRIPTION

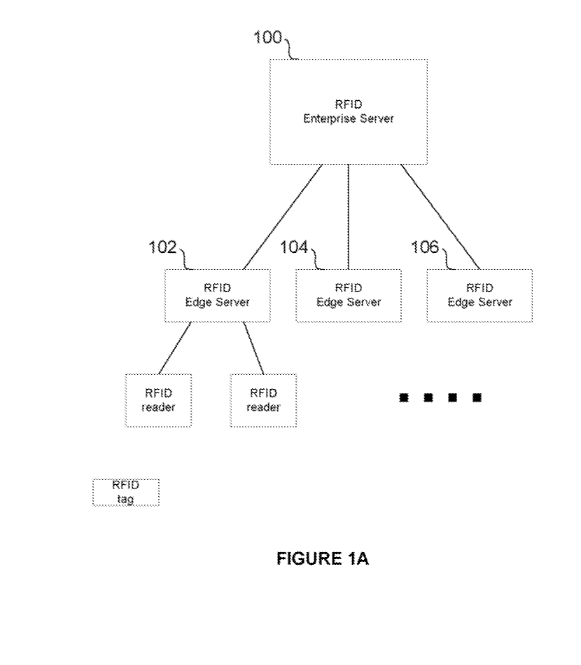

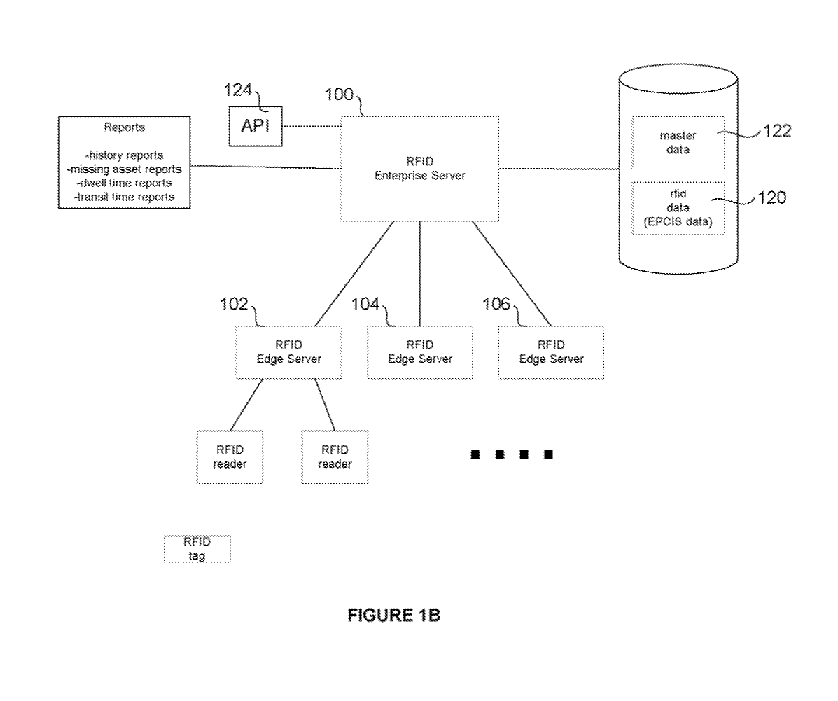

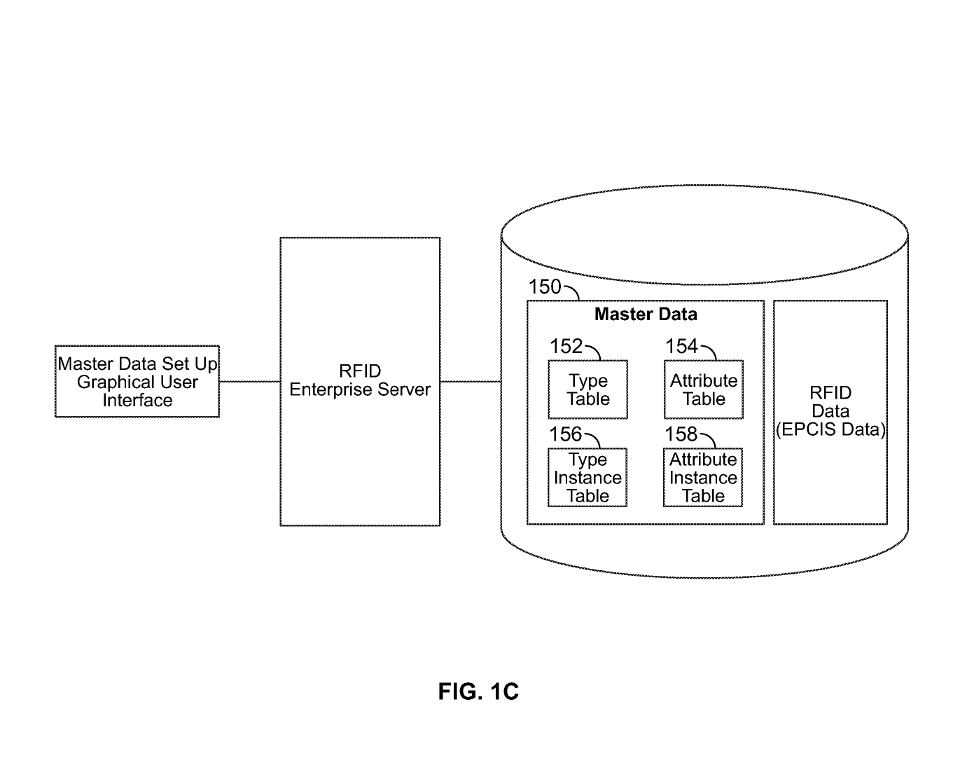

FIG. 1A shows an RFID enterprise server 102 that is associated with multiple RFID Edge servers 104, 106, and 108. Each of the RFID edge servers 104, 106, and 108 can be associated with RFID readers that obtain RFID data from RFID tags.

As shown in FIG. 1B, RFID enterprise server 100 can store Electronic Product Code Information Services (EPCIS) event data 120 and master data 122. The master data can be non-RFID data that can be used to produce reports.

As shown in FIG. 1C, an RFID enterprise server can store master data 150. The master data 150 can be stored such that new master data types can be added without changing a master data type table 152.

The master data database can have a type table 152 indicating master data types, an attribute table 154 including master data attributes, a type instance table 156 indicating instances of the master data types, and a master data attribute instance table 158 indicating master data attribute instances. The use of both a type table 152 and an attribute table 154 means that the format of the type table 152 and type instance table 156 do not have to change with a new master data type.

Master data attributes of table 154 can link to the master data types of table 152. The attribute instances of table 158 can link to the corresponding type instance of table 156 as well as the attributes of table 154. The type instance in table 156 can link to a type in table 152.

The master data types can include location information, shipping related information or other relatively unchanging information.

A graphical interface 160 can allow for adding master data types. The graphical interface can be a web based interface.

In one embodiment, an RFID enterprise server can support Master Data as defined in the EPCglobal EPCIS Specification. Instances of Master Data can be referenced by multiple EPCIS Events. Master Data can support the concept of meta-information that describes and constrains instances of Master Data.

Master Data can provide Meta information that describes the allowable data types and associated attributes (corresponding to a type table 152 and attribute table 154). Master Data can also include instances of the master data types (corresponding to type instance table 156 and master data attribute instance table 158). The Meta Information can be structured in a way to support any arbitrary type composed of a set of name value attributes. The meta information can be defined by a collection of VocabularyElementMeta and VocabularyAttributeMeta.

Vocabulary Meta Data can define a set of Vocabulary Element Meta instances. A Vocabulary Element Meta instance defines one or more Vocabulary Attribute Meta instances. The combination of a Vocabulary Element Meta and the set of Vocabulary Attribute Meta instances define a Vocabulary Type. An example of a vocabulary type is location, where attributes of a location may include Address and GPS coordinate.

Vocabulary Data can be instances of Vocabulary Elements and contained Vocabulary Attributes. Instances of Vocabulary Elements can be identified through a unique URI. This URI can be used by EPCIS events to reference the Vocabulary Element (e.g. read point location). A Vocabulary Element can have one or more Vocabulary Attributes, where each attribute contains a name and a value. Vocabulary Elements reference and are constrained by a Vocabulary Element Meta instance.

The master data can be available in the generation of reports and querying of EPCIS Events. A Master Data Administration interface can be available to support the creation, lookup, update, and deletion of MasterData meta and instance information.

The Master Data information can be persisted within the database.

The Master Data Administration interface can support the creation, lookup, modification and deletion of Master Data types.

The following methods can be supported by the Vocabulary Meta Administration Interface:
−createVocabularyElementMeta(vocabularyElementMeta : VocabularyElementMeta) void
+lookupVocabularyElementMeta(vocabularyElementMetaName : String) : VocabularyElementMeta
+updateVocabularyElementMeta(vocabularyElementMeta : VocabularyElementMeta) : void
+deleteVocabularyElementMeta(vocabularyElementMetaName : String) : void
+getVocabularyElementMetaList( ) : List
+getVocabularyElementMetaNames( ) : List

The Master Data interface can support the creation, lookup, modification and deletion of Master Data instances.

The following methods can be supported by the Vocabulary Instance Administration Interface:
+createVocabularyElement(vocabularyElement : VocabularyElement) : void
+lookupVocabularyElement(vocabularyElementName : String) : VocabularyElement
+updateVocabularyElement(vocabularyElement : VocabularyElement): void
+deleteVocabularyElement(vocabularyElementName : String): void
+getVocabularyElementList(type : String): List
+getVocabularyElementNames(type : String): List

A Vocabulary Element Table can contain master data associated that may be associated with more than one EPCIS Event. Master data can include locations, dispositions, business transactions, and business steps. It can also contain other types of data required to describe one or more EPCIS Events.

The Vocabulary Attribute Table can contain vocabulary attributes associated with a specific Vocabulary Element instance. Attributes can consist of name value pairs.

The Vocabulary Meta Table can describe vocabulary Meta information.

The Vocabulary Attribute Meta Table can describe Vocabulary Attribute Meta Information.

A web based interface can be provided to support the configuration and reporting of Master Data information. The interface can be implemented using JSP pages interacting with vocabulary API objects.

In one embodiment, existing tables can be converted or kept in a legacy format. In one example, tables like product catalog, destination catalog, and label template catalog—need not be reformulated as instances of the generic master data scheme. Instead, they can be brought into the enterprise server “as is”, including the views and the Java APIs. They can sit adjacent to the generic master data tables, but not be connected to them other than sharing a database and enterprise server instance.

### DETAILS OF ONE EXEMPLARY EMBODIMENT

An EPCIS Server can be a standalone service to support
Capture, persistence and query of EPCIS Events
Management and publishing of Master Data

The core of the EPCIS Server can be a database that supports the capture and persistence of EPCIS events and queries on the EPCIS events.

The EPCIS Server can support a capture interface for capturing EPCIS events as defined by the EPCglobal EPCIS standard.

EPCIS events can include temporal information about EPCs including relations between EPCS, EPC location, and association with business knowledge.

Clients of the EPCIS Server can include applications, such as ConnecTerra Compliance Jump Start (CJS) and Portal WorkStation. Other RFID workflow clients can use the capture and query interfaces provided by the EPCIS Server.

One responsibility of the EPCIS Server can be to capture and store EPCIS Events sent to the server by event producers. In addition, the EPCIS Server can support queries on the EPCIS events. The following events can be supported:
Object Event
Aggregation Event
Quantity Event
Transaction Event

An interface can be used to capturing EPCIS Events as defined by the EPCglobal EPCIS Version 1.0 Specification. The capture interface can be implemented using XML over JMS and SOAP.

A Query API can support an interface for querying EPCIS Events. The query interface can be implemented as a SOAP interface. The schema used to marshal the events through the SOAP interface can use the EPCglobal EPCIS XML Schema. The Query API can support multiple types of EPCIS events.

The database can support persistence of EPCIS Events and all related information. Information can be stored in a form to support queries through the Query API.

The access server can support EPCIS Event Extension Data. Event Extension data can be defined as an arbitrary hierarchy of name value attributes associated with an EPCIS Event instance. Event Extension data can be attached to the EPCIS Events by the application that generated the EPCIS Event. The Event Extension data can be persisted with the event and accessible through the Query API.

The XML Schema can be based on the XSD document specified by the EPCglobal EPCIS working group. The XML can be extended to support additional reporting requirements of CJS.

The EPCIS Reporting can provide the ability to generate a set of standard reports. The purpose of the reports can be to provide traceability and accountability of EPC tagged items managed within the EPCIS system. The reporting functions in one embodiment can help customers harvest the benefits of RFID technology by providing useful information to address the following:
Extract information out of the supply chain.
Where is an item
Where are items delayed
What is the average time required to get a product to the shelf
What is the average transit time from point A to point B
Support timely delivery of materials
Assist with reconciliation
Improve supply chain efficiency
Provide loss detection and identification
Out of stock avoidance

The following high level requirements can be supported by all generated reports.

Reports can be accessible through Crystal Reports

Reports can be accessible through a web interface. The report generator can be provided via AN Web Interface. Reports a display as HTML.

Reports can be exportable to a file.

Support exporting reports to a file: XML, CSV.

The following four reports can be supported.
Dwell Report
Transit report
Shipment Reconciliation Report
Dynamic History View

A web based reporting mechanism can support the generation of reports. The reporting can be implemented using JSP pages interacting with the EPCIS Event API objects.

The Dwell Report can provide information on the average length of time that a product stays at a particular location.

Users can have the ability to filter by average dwell time and an option to include rows for each location.

Exemplary Inputs can include:

SKU, EPC, or EPCPattern

Location

Start time (beginning of day)

End time (end of day)

Output:

| | | | | | |
|---|---|---|---|---|---|
| | | | Average | | |
| | | | (mean) Dwell | Shortest | Longest |
| Location | SKU | Units | Time | Dwell Time | Dwell Time |

Transit Report Implementation can report how long it takes for an item or items to transit from one location to another.

Inputs can include:

SKU, EPC, or EPCPattern

Start Location (leaf location)

End Location (leaf location)

Start time (start of day)

End time (end of day)

Outputs can include:

| | | | | | | |
|---|---|---|---|---|---|---|
| | | | | Average | Shortest | Longest |
| Start | End | | | Transit | Transit | Transit |
| Location | Location | SKU | Units | Time | Time | Time |

Shipment Reconciliation Report can give a ship event and a receive event, show the difference between the EPC sent and those received. This report may be used by either the sender or receiver. Assumes that the both the send event and receive event are available, even though these reports may be stored in two different EPCIS systems (e.g. distributor and retailer)

Exemplary Inputs:

Ship Event

Receive Event

Exemplary Output:

| | | | |
|---|---|---|---|
| | | | Status: OK, |
| | | | Additional, |
| EPC | Sent? | Received? | Missing |

Extended reports can show all Receive events received within a period of time, for a specific location, indicating which Receive Events had exceptions. The reports with exceptions can be selected to produce the above report.

An EPC History Report can provide a historical list of EPCIS events for a given EPC, ordered by date. Association with parent containers can be included.

Exemplary Inputs can include:

EPC

Location

Start Time

End Time

Outputs can include:

| | | | | | | | | | |
|---|---|---|---|---|---|---|---|---|---|
| | EPCIS | | | | | | | | |
| | Event | Parent | | | Business | Read | Business | Business | |
| EPC | ID | EPC | Time | Action | Location | Point | Transaction | Step | Disposition |

Parent container can be an active link that results in a Dynamic History View for the EPC associated with the parent container.

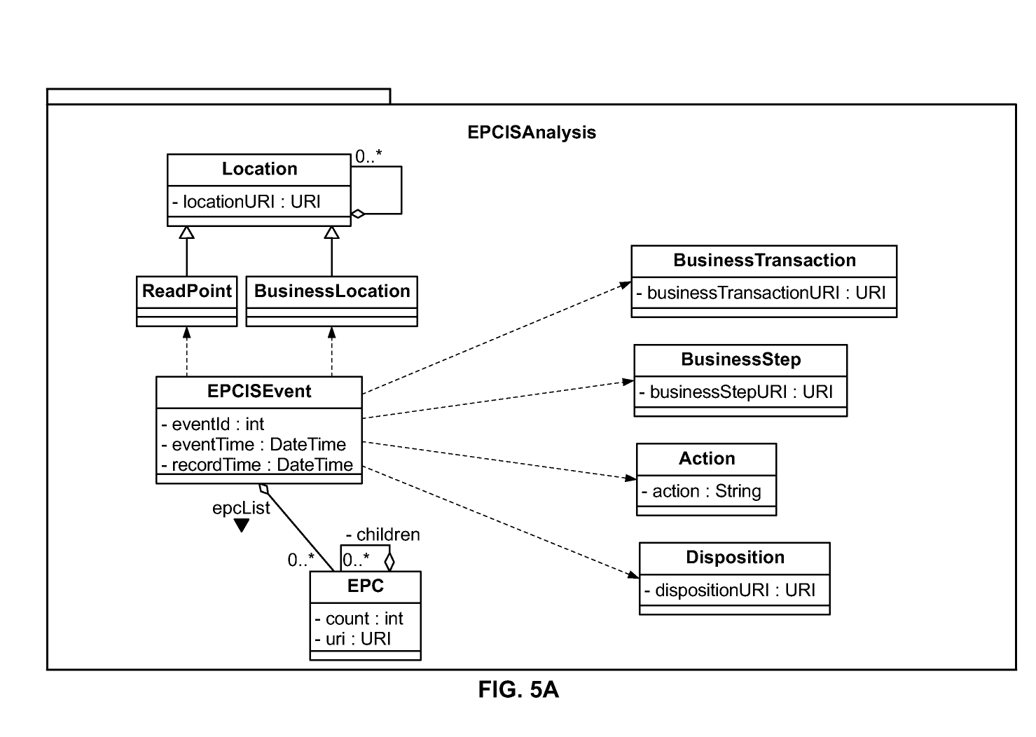

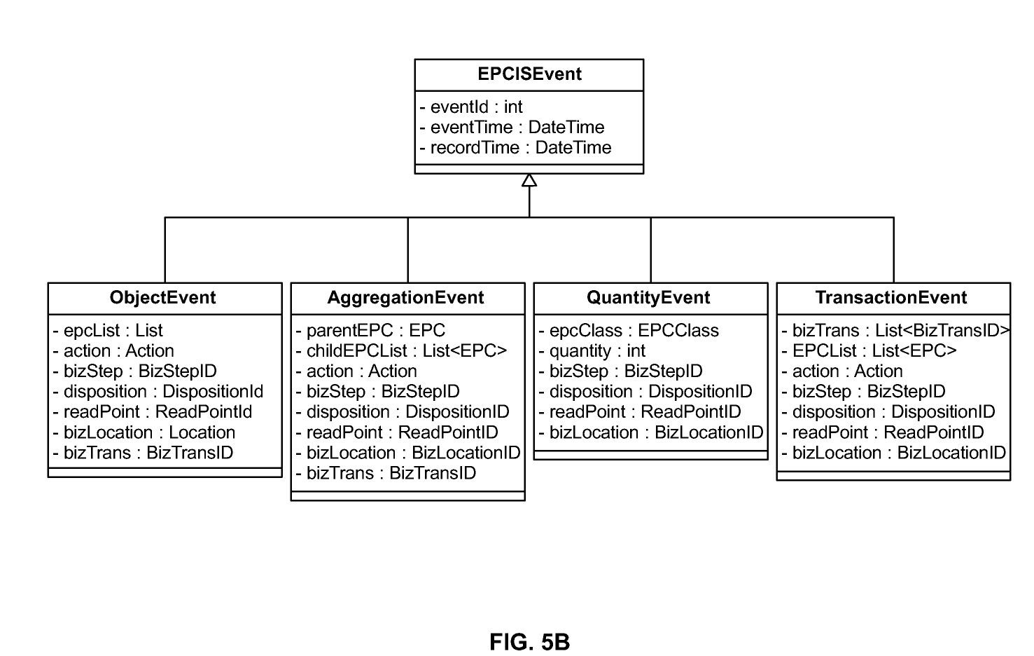

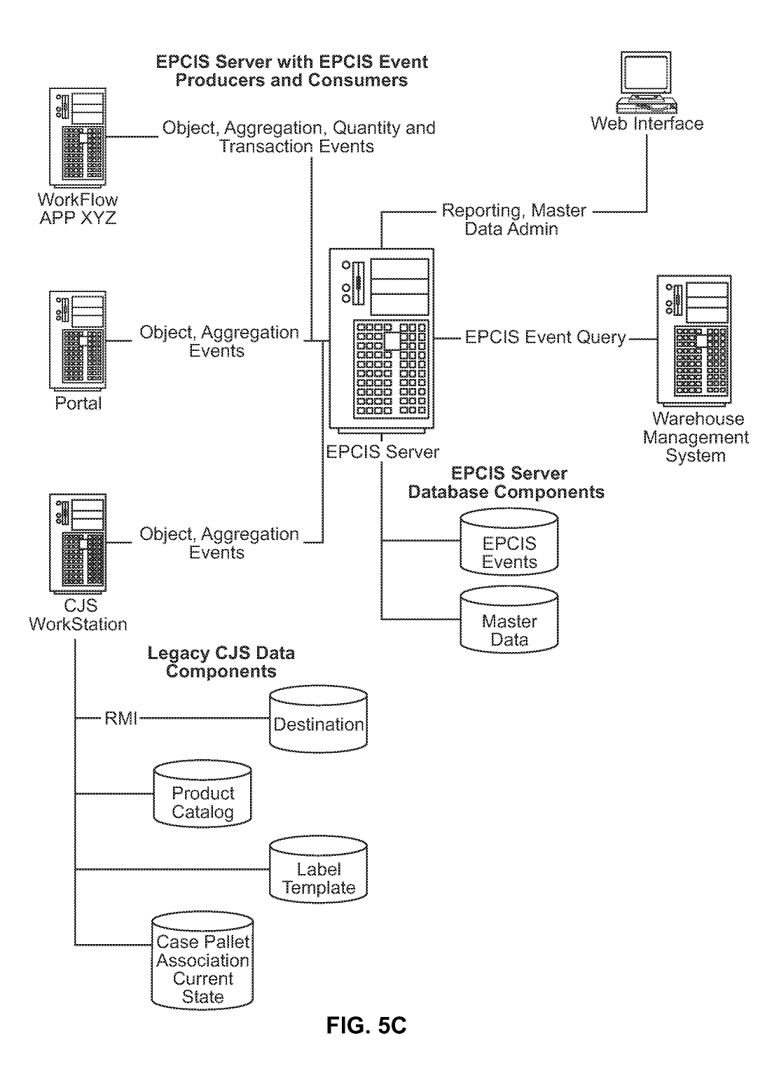

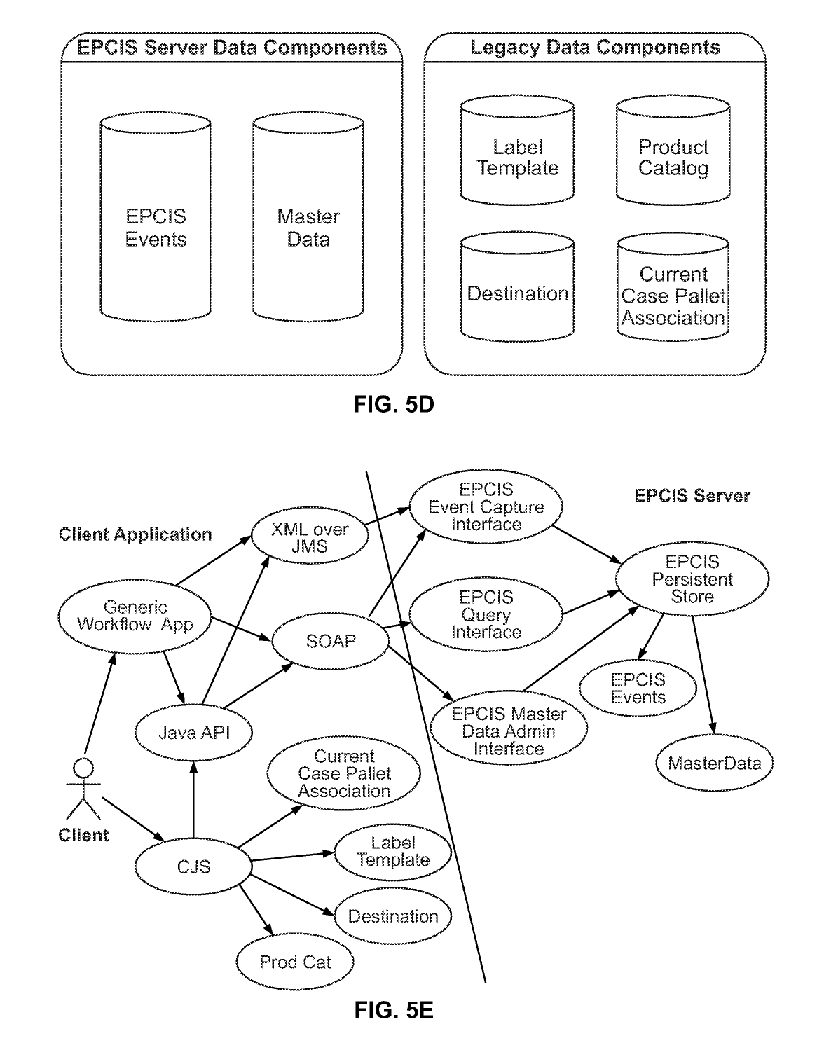

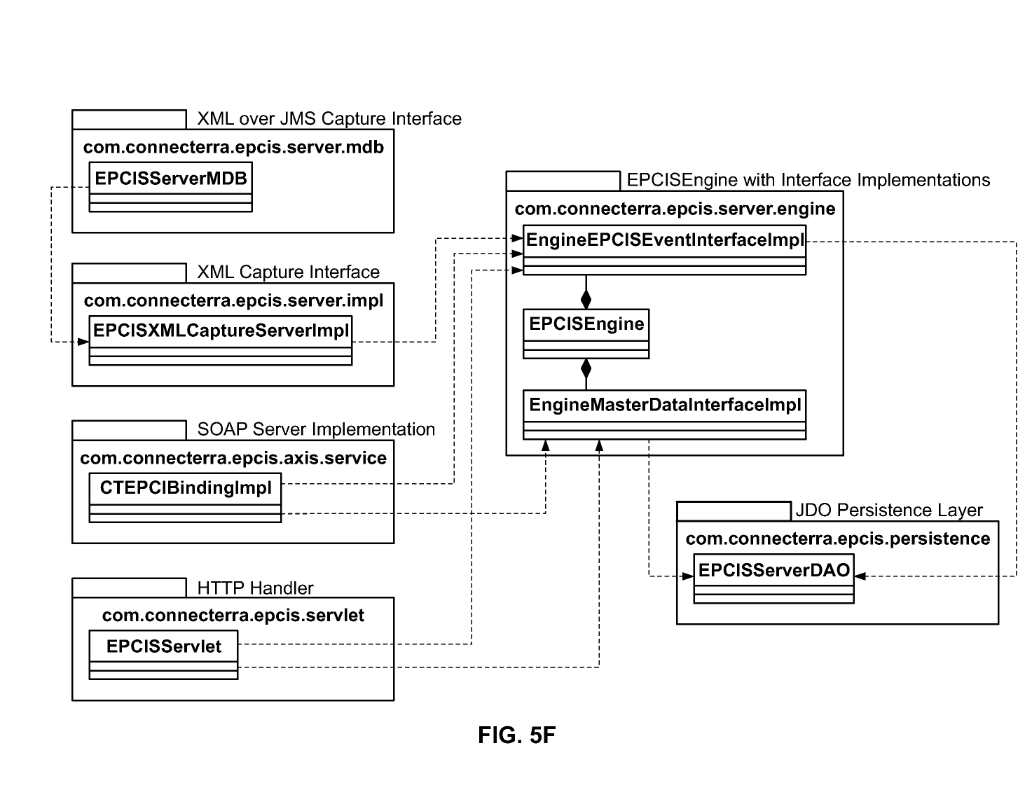

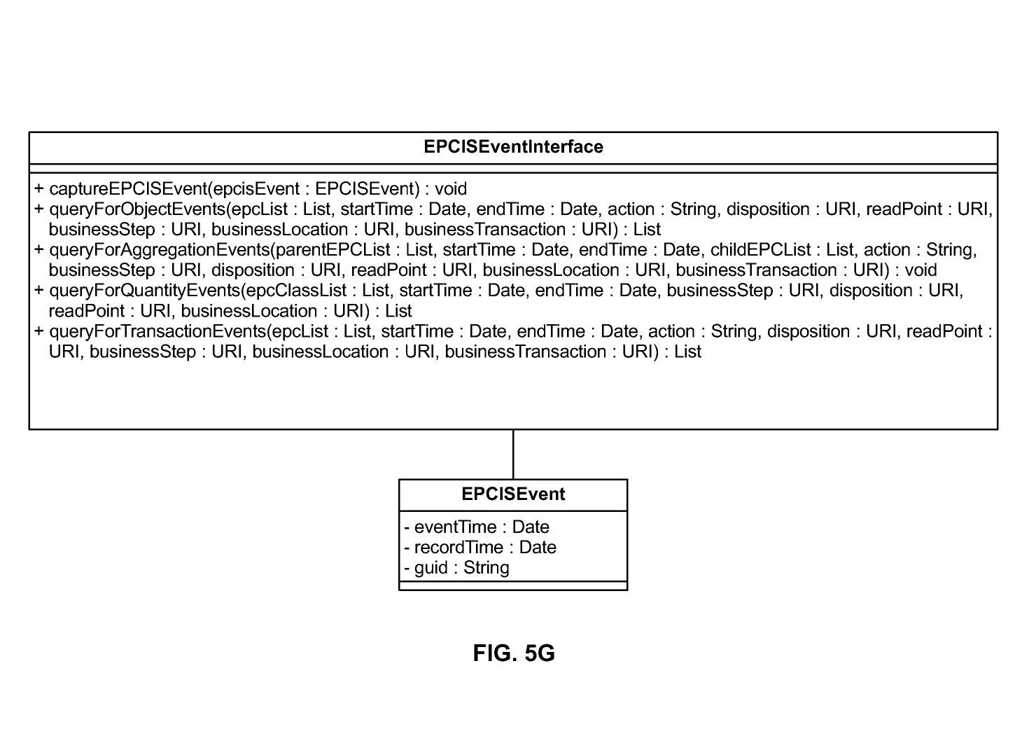

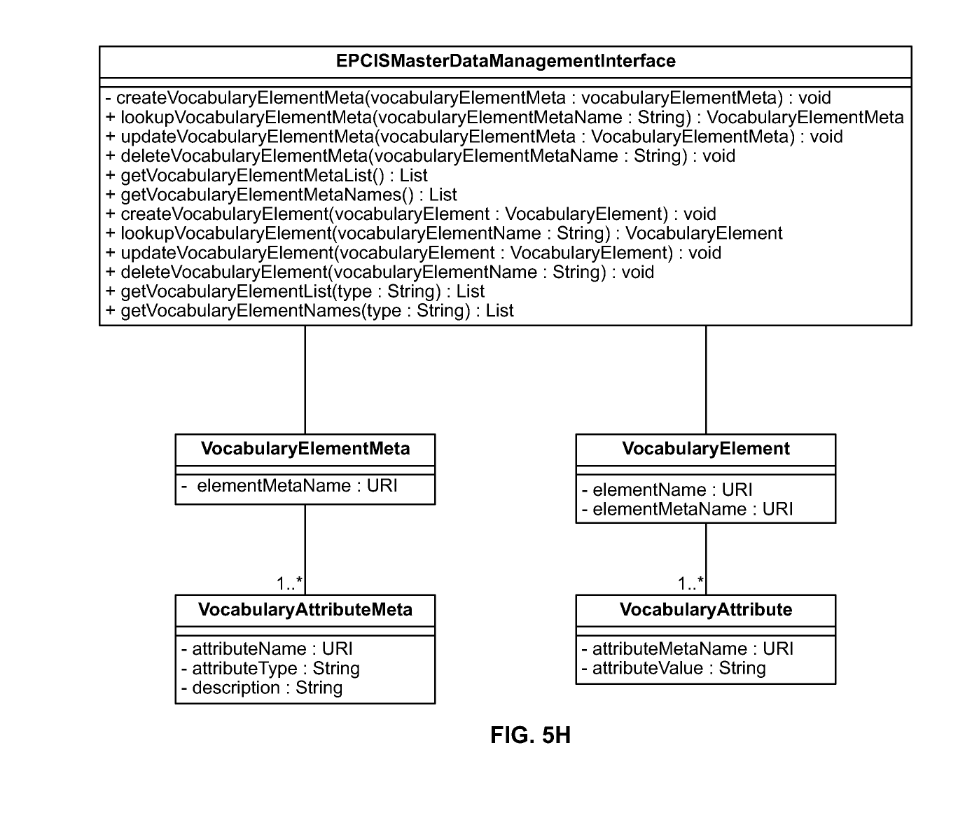

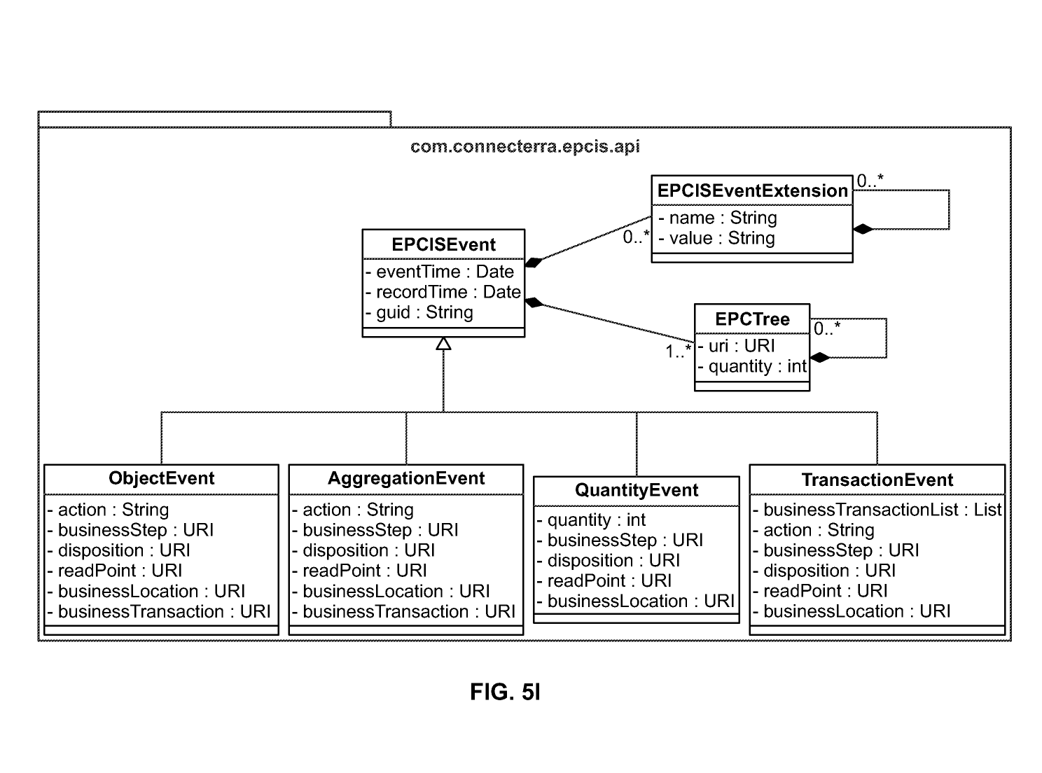

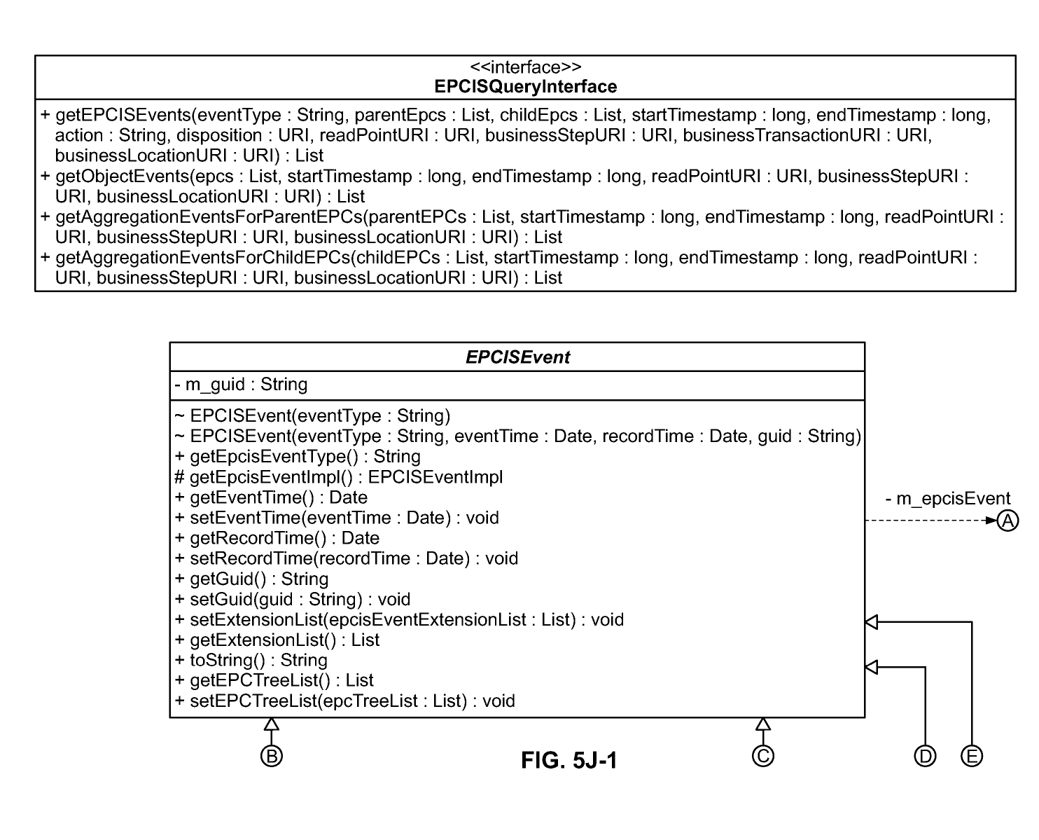

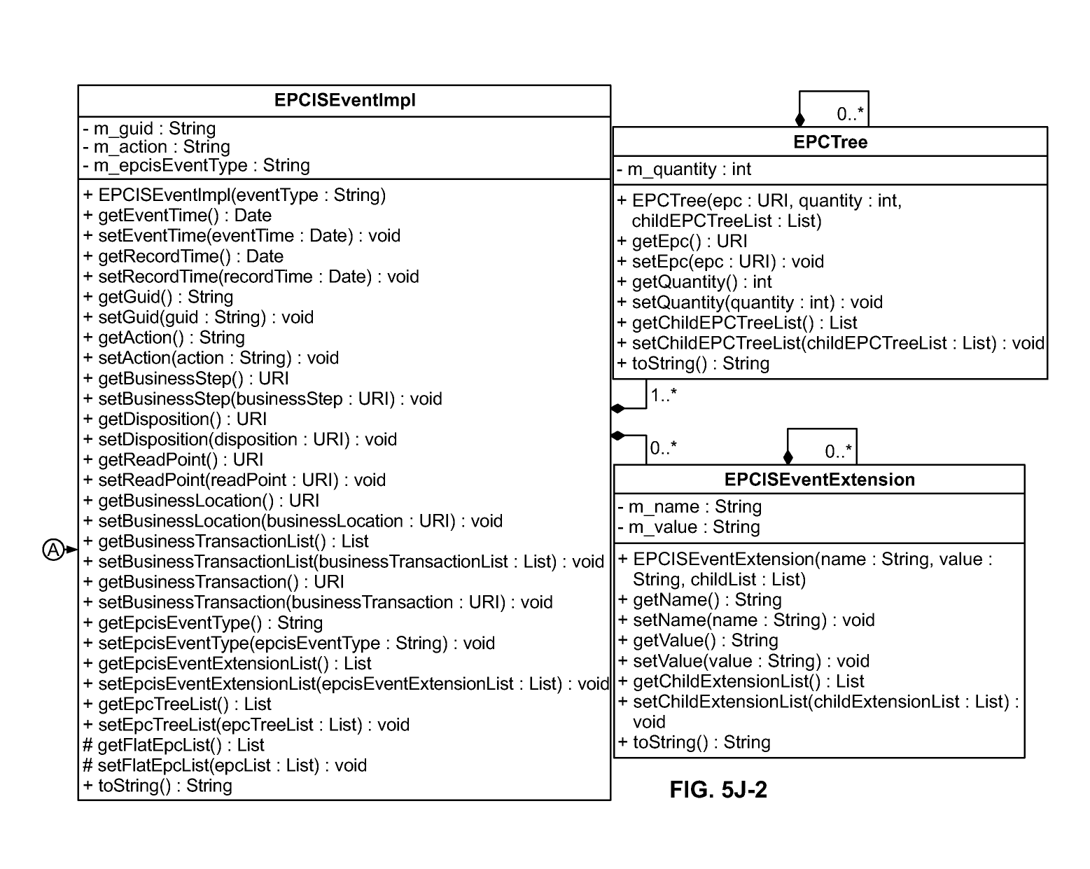

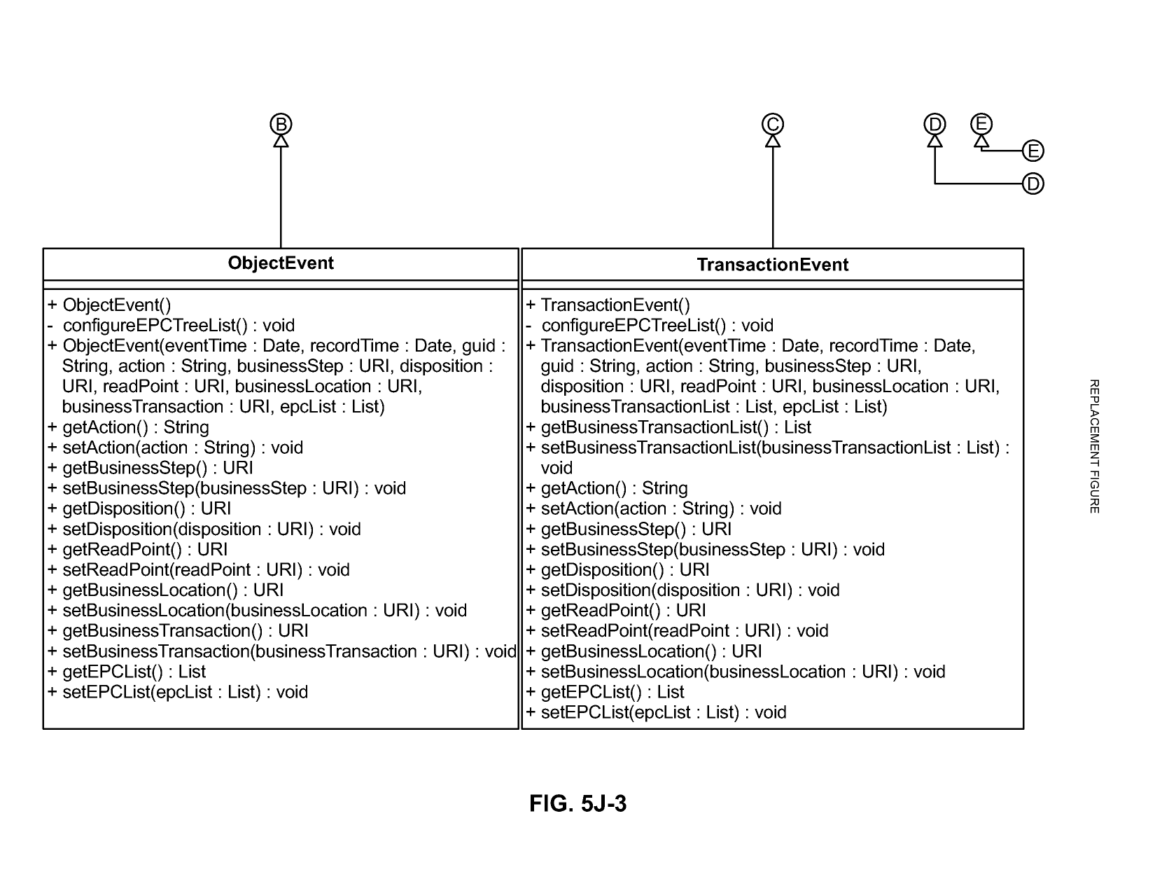

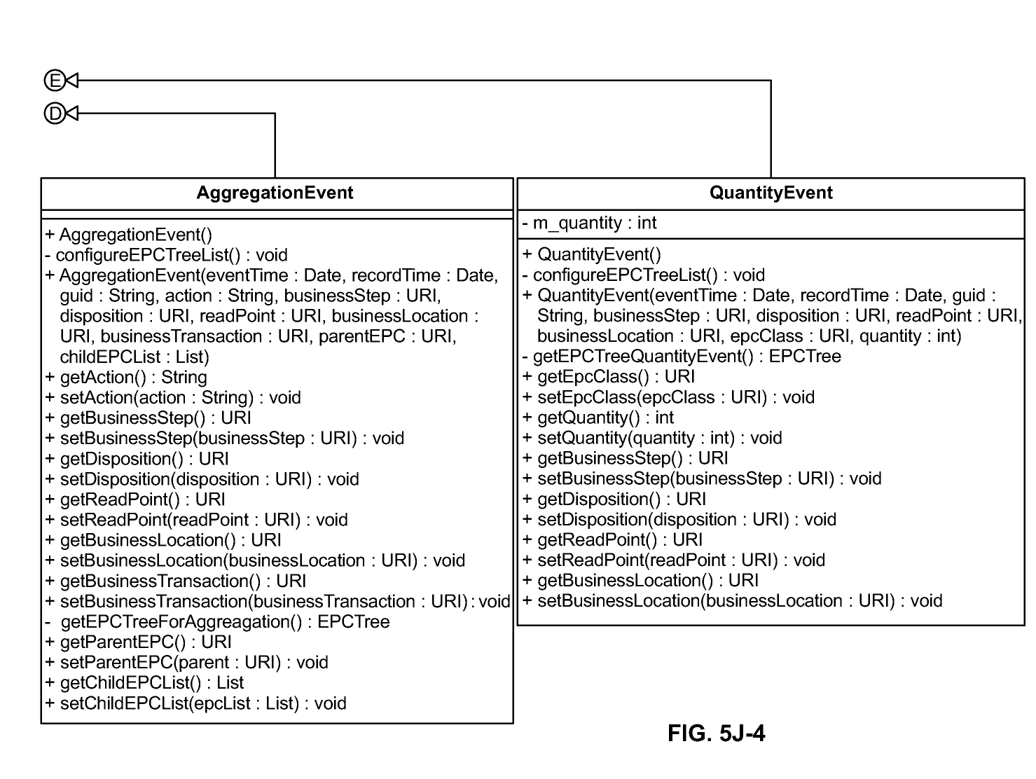

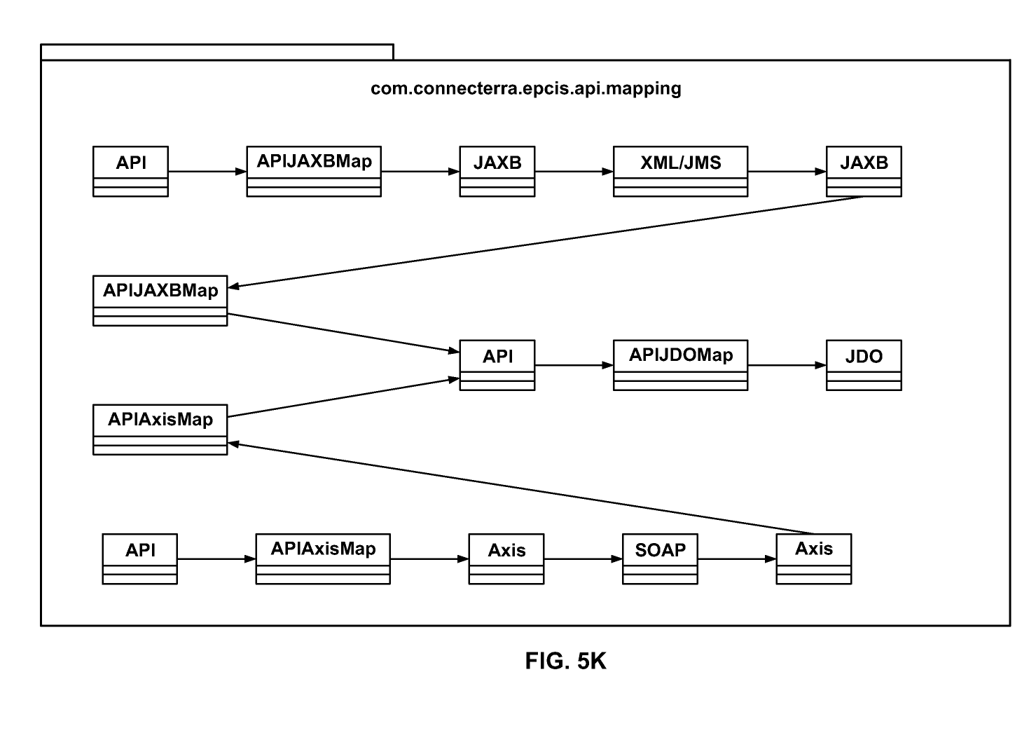

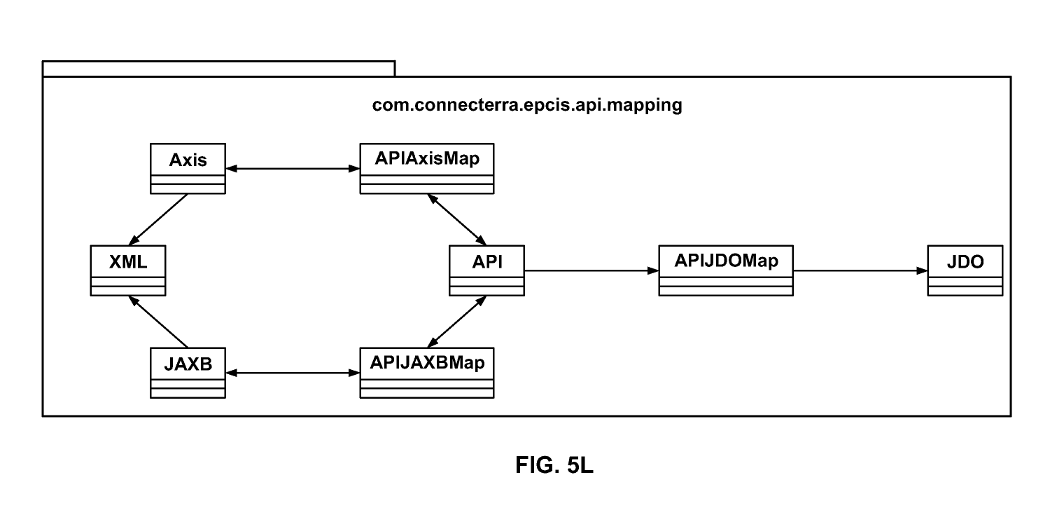

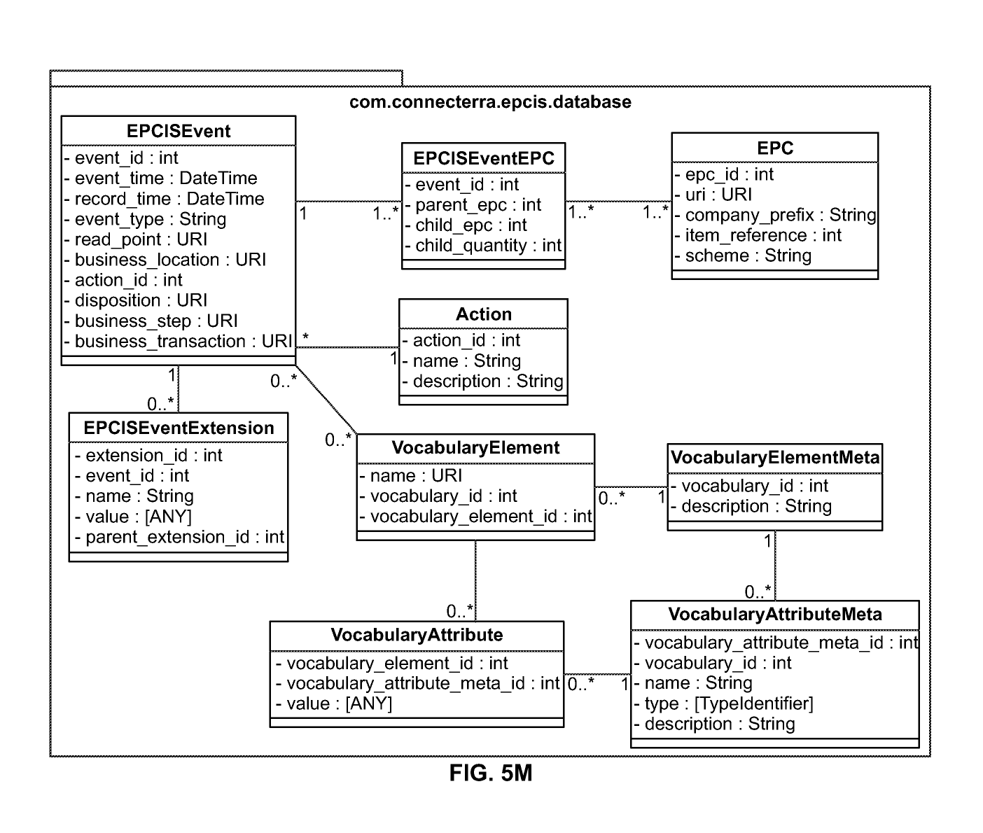

The core of the EPCIS Server analysis model can be the EPCIS Event, with a set of supporting objects that define the EPCIS Event. EPCIS Events can be associated with: location, time, hierarchy of EPC tagged items, reason for the event, and who or what generated the event. FIG. 5A shows an EPCIS analysis model of one embodiment.

FIG. 5B shows an EPCIS class diagram of the hierarchy of EPCIS Events based on the EPCIS Version 1.0 Specification (Jun. 8, 2005). The Event Types defined by the EPCIS specification can be modeled to support the known EPCIS event types. The set of event types as defined by EPCglobal can change over time.

FIG. 5C shows exemplary EPCIS server components. The EPCIS Server can manage the databases for EPCIS Events and Master Data, and interact with the CJS workstation, other workflow applications, and WMS systems. CJS and Workflow apps can be providers and consumers of EPCIS events and consumers of Master Data. The WMS system can be a consumer of EPCIS Events and Master Data. The Web based interface can provide access to EPCIS reporting and Master Data administration.

The EPCIS Server can support the EPCIS Events and Master Data components as defined by the EPCglobal EPCIS Version 1 Specification. The EPCIS Server may or may not host legacy data components:
Product Catalog
Label Template
Destination
Current Case Pallet Association

The legacy data components can remain within the domain of the legacy application. These data components can part of the EPCIS Server.

EPCIS Server design can:
Support the EPCIS Server requirements
Provide a robust, flexible, and adaptable framework
Provide good performance

Since the EPCglobal EPCIS specification can change, flexibility and adaptability useful to support expected changes to the specification.

The Design can be broken into the following EPCIS high level logical components:
EPCIS Events
Master Data

Where each logical component can have the following design details:
Capture Interface
Query Interface
XML Serialization and De-serialization
Persistence Object Layer (JDO)
Database Schema
Views for data export
Reporting

FIG. 5E shows exemplary EPCIS server components. The EPCIS Server can be composed of a database for the persistence of EPCIS Events and Master Data. The EPCIS Server can expose three interfaces for the capture and persistence of EPCIS Events, and the administration of Master Data. Interfaces can be supported with SOAP bindings. The EPCIS Event capture interface can also be supported through an XML over JMS binding. A Java API can be provided as a convenience to Java based clients. The legacy data components associated can remain within the domain of the legacy CJS workflow application.

FIG. 5F shows exemplary EPCIS server packages. A focus of the EPCIS Server can be processing of EPCIS Event capture and query request.

FIG. 5G shows an EPCIS capture and Query Interface class diagram.

A capture interface can be responsible for receiving and persisting EPCIS events. The Capture interface can support capture of the supported EPCIS Event types: Object, Aggregation, Quantity and Transaction. EPC can be provided in Pure Identity format. EPCs specified in tag format can be stored in Pure Identity format. The following method can define the EPCIS Event capture interface:
+captureEPCISEvent(epcisEvent : EPCISEvent) : void

A Query Interface can be responsible for providing a means to search for and retrieve existing EPCIS Events. The incoming query request can contain the EPCIS event query definition. The request can result in the construction and execution of a JDO query. The resulting EPCIS Events can be returned to the caller as a list of EPCIS Events. The following methods can define a EPCIS Query Interface:
+queryForObjectEvents(epcList : List, startTime : Date, endTime : Date, action : String, disposition : URI, readPoint : URI, businessStep : URI, businesLocation : URI, businessTransaction : URI) : List
+queryForAggregationEvents(parentEPCList : List, startTime : Date, endTime : Date, childEPCList : List, action : String, businessStep : URI, disposition: URI, readPoint URI, businessLocation : URI, businessTransaction : URI) : void
+queryForQuantityEvents(epcClassList : List, startTime : Date, endTime : Date, businessStep : URI, disposition : URI, readPoint : URI, businessLocation : URI) : List
+queryForTransactionEvents(epcList : List, startTime : Date, endTime : Date, action : String, disposition : URI, readPoint : URI, businessStep: URI, businesLocation : URI, businessTransaction : URI) : List

A null value passed in for any of the parameters can result in no filter applied to the associated value. In one embodiment, URIs can match exactly. EPCPatterns can be allowed for matching a range of EPCs. EPCs can also be in Pure Identity format.

FIG. 5H shows an EPCIS Master Data Management Interface class diagram of one embodiment. Master Data can provide supporting information for EPCIS Events, allowing resolution of the URIs specified by the EPCIS Event attributes: business step, disposition, read point, business location, and business transaction. Master data can also be referenced indirectly through Event Extension Data attached to an EPCIS Event. Master Data can provide Meta information that describes the allowable data types and associated attributes. Master Data can also include instances of the master data types, for example, location information. The Meta Information can be structured in a way to support any arbitrary type composed of a set of name value attributes. The meta information can be defined by a collection of VocabularyElementMeta and VocabularyAttributeMeta.

The Master Data Administration interface can support the creation, lookup, modification and deletion of Master Data types.

The following methods can be supported by the Vocabulary Meta Administration Interface:
−createVocabularyElementMeta(vocabularyElementMeta : VocabularyElementMeta) void
+lookupVocabularyElementMeta(vocabularyElementMetaName : String) : VocabularyElementMeta
+updateVocabularyElementMeta(vocabularyElementMeta : VocabularyElementMeta) : void
+deleteVocabularyElementMeta(vocabularyElementMetaName : String) : void
+getVocabularyElementMetaList( ) : List
+getVocabularyElementMetaNames( ) : List

The Master Data interface can support the creation, lookup, modification and deletion of Master Data instances.

The following methods can be supported by the Vocabulary Instance Administration Interface:
+createVocabularyElement(vocabularyElement : VocabularyElement) : void
+lookupVocabularyElement(vocabularyElementName : String) : VocabularyElement+updateVocabularyElement(vocabularyElement : VocabularyElement) : void
+deleteVocabularyElement(vocabularyElementName : String) : void
+getVocabularyElementList(type : String) : List
+getVocabularyElementNames(type : String) : List

The public interfaces for the EPCIS Server can support two types of transports:
SOAP
XML over JMS

The SOAP interface can support the EPCIS capture and query interfaces, in addition to the Master Data Administration Service. The SOAP interface can import the XML Schema definition as defined by the EPCIS working group

The EPCIS Capture interface can support an XML over JMS implementation. JMS messages can contain XML that define a single EPCIS Event. The XML can conform to the EPCIS XML Schema as defined by the EPCglobal EPCIS working group. The XML document can be de-serialized into JAXB objects. These objects can then be converted to JDO objects and persisted to the database.

The Java API can be a public facing interface for the creation and manipulation of EPCIS Events. The Java API can model the EPCIS Events and associated information as defined by the EPCglobal EPCIS1.0 Specification. Instances of EPCIS Events created using the JAVA API can be submitted to the EPCIS Server through either the XML/JMS or SOAP capture interfaces. Conversely, EPCIS Events returned as the results of the query interface can be returned in the form of Java API EPCIS events. The Java API can also be used within the EPCIS Server as a canonical representation for EPCIS Events.

FIG. 5I shows an exemplary Java API Model.

FIG. 5J shows an exemplary EPCIS Java API implementation classes.

FIG. 5K shows exemplary Event Transformation.

The upper portion of the diagram defines the path when an EPCIS event is submitted using XML over JMS, using the JAXB serialization. The lower portion of the diagram defines the path for capture and query events occurring through the SOAP interface, using the Axis serialization.

FIG. 5L shows an EPCIS Object Representation Map.

There are currently a total of 4 representations of the EPCIS events; API, JDO, JAXB, and Axis. The API classes can provide a canonical representation of the EPCIS events and associated classes. Transformations from one representation to another can pass through the API representation. This can reduce the number of mappings necessary from n! to n−1, in this case from 6 to 3, where n is 4.

The Axis and JAXB representations can also support marshaling to the XML representation defined by the EPCglobal EPCIS working group Schema.

A single EPCIS Event class can be used to persist all EPCIS Event types (Object, Aggregation, Quantity and Transaction). The event_type attribute can identify the type of the event. This can allow new types of EPCIS events to be added in the future, without requiring extensive changes to the persistent layer model. This can also simplify searching across event types. The attributes; read_point, business_location, action_id, disposition, business_step and business_transaction can be URIs. These URIs may map to VocabularyElement URI identifiers, but this is not enforced. EPCs associated with an event can be captured through the one to many associations with EPCISEventEPC class. This relation supports a hierarchy of EPCs. The EPC class can maintain the EPC URI and other descriptive information. The EPC class can be shared by multiple EPCISEventEPC instances. Event extension data can be modeled using the EPCISEventExtension, supporting a hierarchy of name value pairs. This can support any name value data hierarchy associated with the event.

Master Data can be represented with the VocabularyElement, and VocabularyAttribute classes. The associated Meta data can be represented through the VocabularyElementMeta and VocabularyAttributeMeta classes. The Meta information can describe and constrain the VocabularyElements and associated VocabularyAttributes. The identifiers for VocabularyElements can be URIs.

Exemplary database tables are described below. The EPCISEvent Table can contain all EPCIS events. There can be a single EPCIS event table for all EPCIS event types. The column type can specify the EPCIS event type.

EPCISEventEPC Table can map EPC instances to EPCIS events. It can also associate parent and child EPCs for a given EPCIS event. In the case where either the child EPC is a pattern, the child_epc_count can reflect the number of tags matching the pattern.

Sample EPCISEventEPC table.

| event_id | parent_epc | child_epc | child_quantity |
|---|---|---|---|
| 1 | 0 | 1001 | 1 |
| 1 | 1001 | 1002 | 1 |
| 1 | 1001 | 1003 | 1 |
| 2 | 0 | 1004 | 20 |

A parent_epc of 0 can indicate that the child epc does not have a parent EPC and is therefore a top level EPC element. Sample event id 2 can contain a top level EPC that is a pattern, with a child count of 20.

Corresponding Sample EPC Table.

| | | | | TAG |
|---|---|---|---|---|
| epc_id | URI | company_prefix | item_reference | Type |
| 1001 | urn:epc:id:sscc:08410580.999999999 | 08410580 | 999999999 | SSCC |
| 1002 | urn:epc:id:sgtin:08410580.65535.16711934 | 08410580 | 65535 | SGTIN |
| 1003 | urn:epc:tag:sgtin:.08410580.65535.16711935 | 08410580 | 65535 | SGTIN |
| 1004 | urn:epc:idpat:sgtin:08410580.65535.* | 08410580 | 65535 | SGTIN |

The EPC table can list unique EPCs known by the system. The epc_id can be referenced by the parent_epc and child_epc columns of the EPCISEventEPC table. All EPC and EPCPatterns can be stored in pure identity encoding.

The EPC Table can contain a list of all known EPCs. Decomposed field values can be provided as column values to support searching (e.g. searching for all EPCs with a specific company prefix).

Action Table can list all known action values. The current list of actions can be limited to: Add, Observe, and Delete.

The EPCIS Event Table can contain attribute associated with a specific EPCIS event. The table can allow nesting of attributes to support structured event information.

The Vocabulary Element Table can contain master data associated that may be associated with more than one EPCIS Event. Master data can include locations, dispositions, business transactions, and business steps. It can also contain other types of data required to describe one or more EPCIS Events.

The Vocabulary Attribute Table can contain vocabulary attributes associated with a specific Vocabulary Element instance. Attributes can consist of name value pairs.

The Vocabulary Meta Table can describe vocabulary Meta information.

The Vocabulary Attribute Meta Table can describe Vocabulary Attribute Meta Information.

A web based interface can be provided to support the configuration and reporting of master Data information. The interface can be implemented using JSP pages interacting with vocabulary API objects.

A web based reporting mechanism can support the generation of reports. The reporting can be implemented using JSP pages interacting with the EPCIS Event API objects.

The Dwell Report can provide information on the average length of time that a product stays at a particular location.

Additions:

Add ability to filter by average dwell time.

Add option to include rows for each sub location.

Inputs:

SKU, EPC, or EPCPattern

Location

Start time (beginning of day)

End time (end of day)

Output:

| | | | | | |
|---|---|---|---|---|---|
| | | | Average | | |
| | | | (mean) Dwell | Shortest | Longest |
| Location | SKU | Units | Time | Dwell Time | Dwell Time |

The dwell time report SQL can select EPCs from EPCEvent table, by SKU, start time and end time. Use either parent or child from EPCEvent table. Create temporary table with Epc, location, time. Then for each EPC, create at table with first occurrence at location or nested location, and first occurrence of EPC not at location or nested location. Compute time duration column with the difference of startTime at location, and startTime at other location. If there is no event at another location, then the difference of start time and end time (report input parameter). For All EPCs, compute average time difference, and total number of EPCs.

Variations can include Create pie chart showing the distribution of next destination for the EPC. Show graph of average dwell per destination.

A Transit Report Implementation can report how long it takes for an item or items to transit from one location to another.

Inputs can be:

SKU, EPC, or EPCPattern

Start Location (leaf location)

End Location (leaf location)

Start time (start of day)

End time (end of day)

Outputs can be:

| | | | | | | |
|---|---|---|---|---|---|---|
| | | | | Average | Shortest | Longest |
| Start | End | | | Transit | Transit | Transit |
| Location | Location | SKU | Units | Time | Time | Time |

The SQL Query can be the same as dwell report, except that the terminal location is the input destination location, rather than not the start location.

A Shipment reconciliation Report given a ship event and a receive event, show the difference between the EPC sent and those received. This report may be used by either the sender or receiver. Assumes that the both the send event and receive event are available, even though these reports may be stored in two different EPCIS systems (e.g. distributor and retailer)

Exemplary Inputs:

Ship Event

Receive Event

Exemplary Output:

| | | | |
|---|---|---|---|
| | | | Status: OK, |
| | | | Additional, |
| EPC | Sent? | Received? | Missing |

An extended report can show all Receive events received within a period of time, for a specific location, indicating which Receive Events had exceptions. Allow selecting the reports with exceptions to produce the above report.

The shipment reconciliation report The SQL Query can be some type of shipping receipt report number or other document number. From this, derive the corresponding EPCISEvent for the ship event and the receive event. Then collect the EPCs associated with each event and compare the list. Show the differences.

An EPC History Report can provide a historical list of EPCIS events for a given EPC, ordered by date. Include Association with parent containers can be included.

Exemplary Inputs:

EPC

Location

Start Time

End Time

Exemplary Outputs:

| | | | | | | | | | |
|---|---|---|---|---|---|---|---|---|---|
| | EPCIS | | | | | | | | |
| | Event | Parent | | | Business | Read | Business | Business | |
| EPC | ID | EPC | Time | Action | Location | Point | Transaction | Step | Disposition |

Parent container can be an active link that results in a Dynamic History View for the EPC associated with the parent container.

The shipment reconciliation SQL Query can Query the EPC table for matching EPC and get the epc_id. Query the EPCEvent table for all rows where either the parent or children have matching epc_ids. Query the EPCIS event table for all EPCISEvents with event time after input start time and end time window. For each EPCIS event, generate a report of the event. For each row, include links to more detailed information on the child EPCs, business transaction with attributes, read point, business location.

Variations can include supporting EPCPatterns as input and sort by matching EPC. Database view can also be used. A simple EPCIS Event view can be exposed to display EPCIS Events. A simple EPCIS EPC view can be exposed to display EPCs associated with a specific EPCIS Event. A simple EPCIS Extension Data view can be exposed to display extension data associated with an EPCIS Event.

A Master Data Service can provide the ability to resolve URIs referenced in the URI fields of EPCIS Events as defined by the EPCglobal EPC Information Services (EPCIS) Version 1.0. The ability to resolve URIs can be leveraged within an EPCIS Query Interface to extend query constraints. For example, the ability to show all EPCs within a given business location, including all nested locations.

Master Data can be composed of Vocabulary Types and Vocabulary Elements. Vocabulary Types define the meta information for a given Vocabulary, where Vocabulary Elements are instances of a Vocabulary Type. A Vocabulary is defined by a Vocabulary Type, and collection of compliant Vocabulary Elements.

As an extension to the EPCIS Specification, the Master Data Service can also supports configuration of Vocabulary Types and Vocabulary Elements. The Master Data Configuration can support two public means of access; a Web Service (SOAP) and a Web based User Interface.

In one embodiment, existing tables can be converted or kept in a legacy format. In one example, tables like product catalog, destination catalog, and label template catalog—need not be reformulated as instances of the generic master data scheme. Instead, they can be brought into the enterprise server “as is”, including the views and the Java APIs. They can sit adjacent to the generic master data tables, but not be connected to them other than sharing a database and enterprise server instance.

SOAP versions of the CX catalog APIs can support a remote CX client accessing the CX tables in ES.

The generic master data tables can support the abstract data model as specified in the EPCIS spec, in which there are multiple vocabularies, each being a set of vocabulary elements (URIs), where each vocabulary element may have zero or more attributes, where an attribute is a name/value pair. The value of an attribute can be a string.

In addition, the generic master data tables can include “attribute meta” information that says for a given vocabulary what the universe of expected attributes is. Each attribute meta can have an attribute name and a type descriptor.

The design documents can four tables:

VocabularyElement

VocabularyElementMeta

VocabularyAttribute

VocabularyAttributeMeta

Support import and export of Master Data VocabularyElementTypes and VocabularyElements can be as XML. The XML for VocabularyElements can follow the corresponding XSD defined in the EPCglobal EPCIS Specification (4 Jan. 2006).

There can be an ability to deal with master data attributes whose values are other types besides strings, including arbitrary complex types. There can be an ability to use external sources of data (legacy systems or otherwise) to provide master data into the framework.

Catalog data can become part of the general framework rather than a thing to the side. One way this might happen is to take the existing tables and consider them to be an “external source of data”.

The generic set of tables we provide as part of the enterprise server may continue to be limited to simple string-valued master data. So if you want master data that has complex types as values, you would create it using the database/web service tool of your choice, then bring it into the framework.

The MasterData Service can be used to support the MasterData Vocabulary Element Administration UI to support the creation, lookup, modification, and deletion of Vocabulary Elements. The MasterData Service can be used to support the MasterData Vocabulary Element Meta Administration UI to support the creation, lookup, and deletion of Vocabulary Element Metas.

The MasterData Service is used to support the import and export of Vocabulary Element Meta and Vocabulary Elements in the form of XML documents.

A user can invoke the EPCIS query and provides name value pairs that map to Location attributes to specify the business location rather than specifying the business location URI directly.

To determine the all sub locations for a specific business location, the EPCIS Reports implementation can first query the MasterData interface to get a list of all child locations. The parent location and resulting list of child locations can then be used to specify the business location URI in the EPCIS Event Query.

When displaying EPCIS Events, a query is first made to the MasterData Service to determine if there are Vocabulary Elements that match any of the Business Location or Read Point EPCIS Event Fields. Any Vocabulary Elements that are returned can used to replace the Vocabulary Element ID with the location description in the resulting report.

In the EPCIS Reports, for selection of Business Location and Read Point, this can be supported as a tree structure to drill down into location hierarchy. The tree structure can be based on the Location information from the Master Data. The Vocabulary Element ID for the selected Vocabulary Element can be used as the query constraint for the EPCIS Event Query. An option can include the Vocabulary Element IDs for all sub locations of the selected location.

The Master Data Service can provides the ability to define and query:
Master Data Vocabulary Types (Meta Information)
Master Data Vocabulary Elements (Instances of Vocabulary Types)

Vocabulary Types can define the meta information for instances of Master Data. The Master Data service can support addition, modification, and deletion of Vocabulary Type information.

Vocabulary Elements can represent instances of Master Data as defined by the associated Vocabulary Type. The Master Data service can support addition, modification, and deletion. Addition and Deletion can include validation of Vocabulary Elements. Public facing access to Vocabulary Types and Vocabulary Elements can be provided through:
Web based User Interface
SOAP Interface
XML Import/Export
Non public access to Master Data Vocabulary Types and Vocabulary Elements is provided by the following interfaces:
Java API
Command Line Interface (CLI)
EJB Session Bean

The Master Data Service can be composed of the following implementation components:
Java API (set of Java classes that define a canonical representation of Master Data)
XML Serialization and De-serialization (supporting import and export of Master Data Meta and Vocabularies)
Object Transformations to support conversion between JavaAPI, WLS generated SOAP classes, and JDO objects.
EJB Session Bean (common entry point for public interfaces providing transaction and threading management).
Server side implementation object (provides a implementation delegated to by the EJB Session Bean)
WLS SOAP Service (implementation engine for SOAP Service)
Persistence Object Layer, JDO, provides object to relational database mapping.
Relational Database Schema
Java Server Faces User Interface
CLI

The Enterprise Server can be deployed as an application in the form of an expanded ear file. The Master Data Service is deployed as a service within the Enterprise Server. The Master Data Service can be a sibling of the EPCIS Event Capture/Query Service. The EPCIS Event Capture/Query Service can be configured as a client of the Master Data Service. The Master Data Service has no external dependencies. Other Data Service can also be deployed as a sibling service within the enterprise service, but it has no interdependency on either the EPCIS Event Capture/Query Service or the Master Data Service.

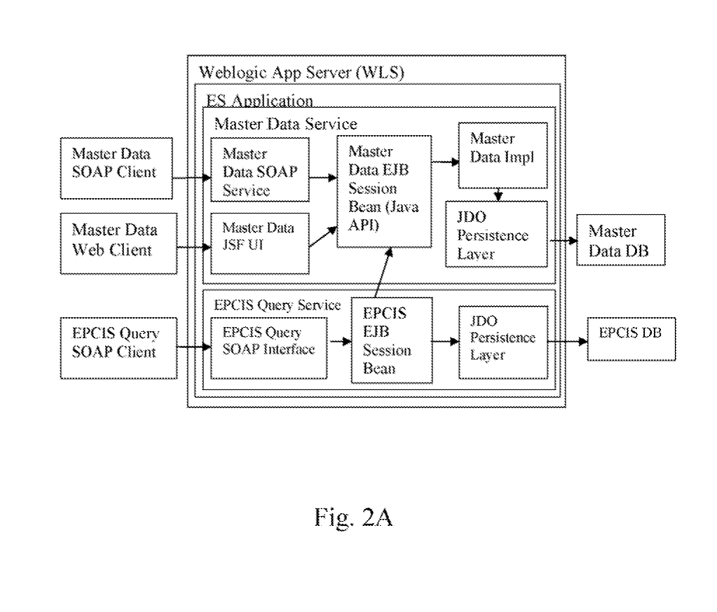

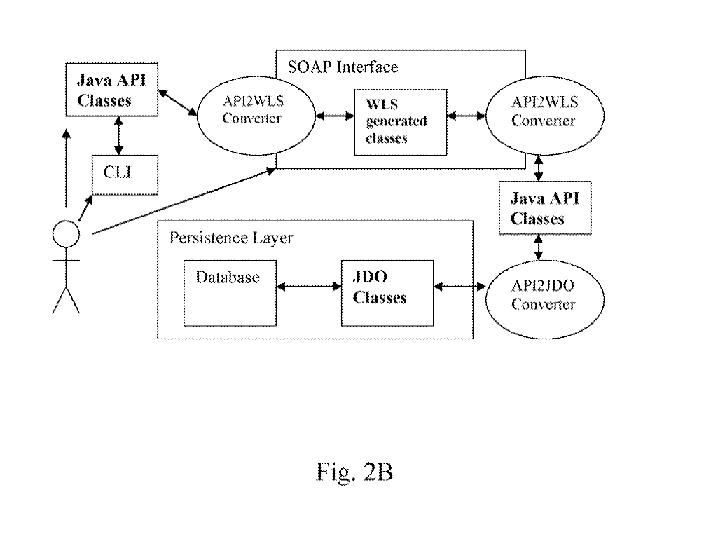

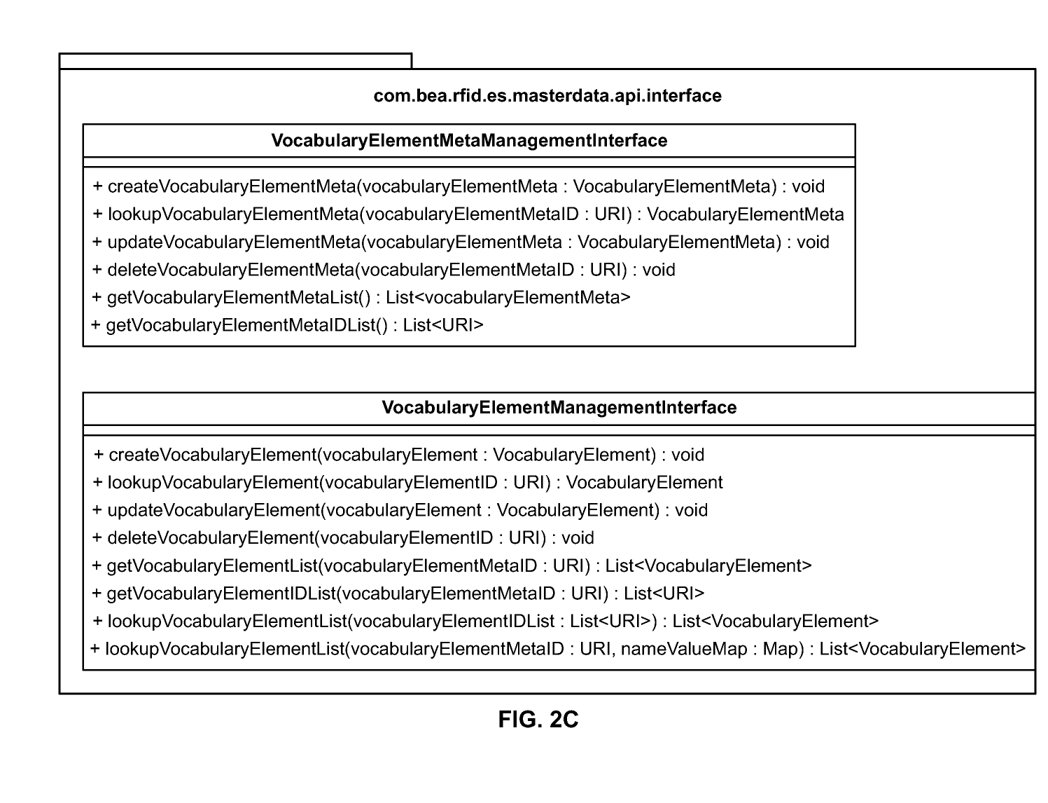

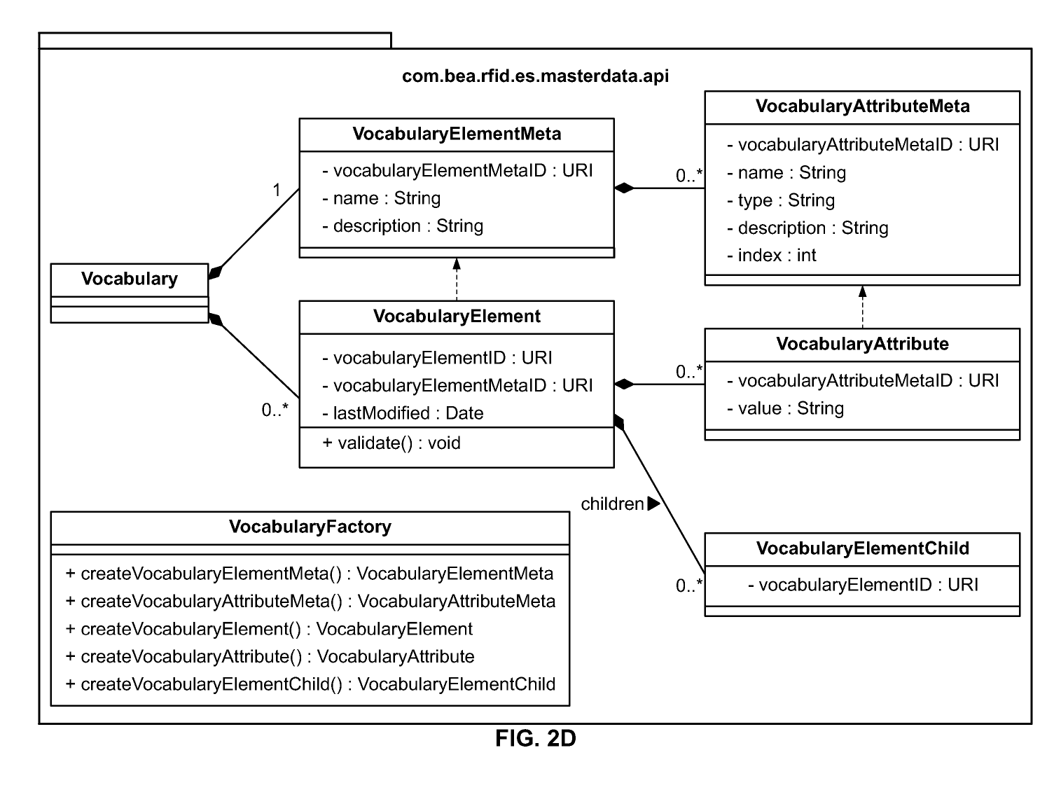

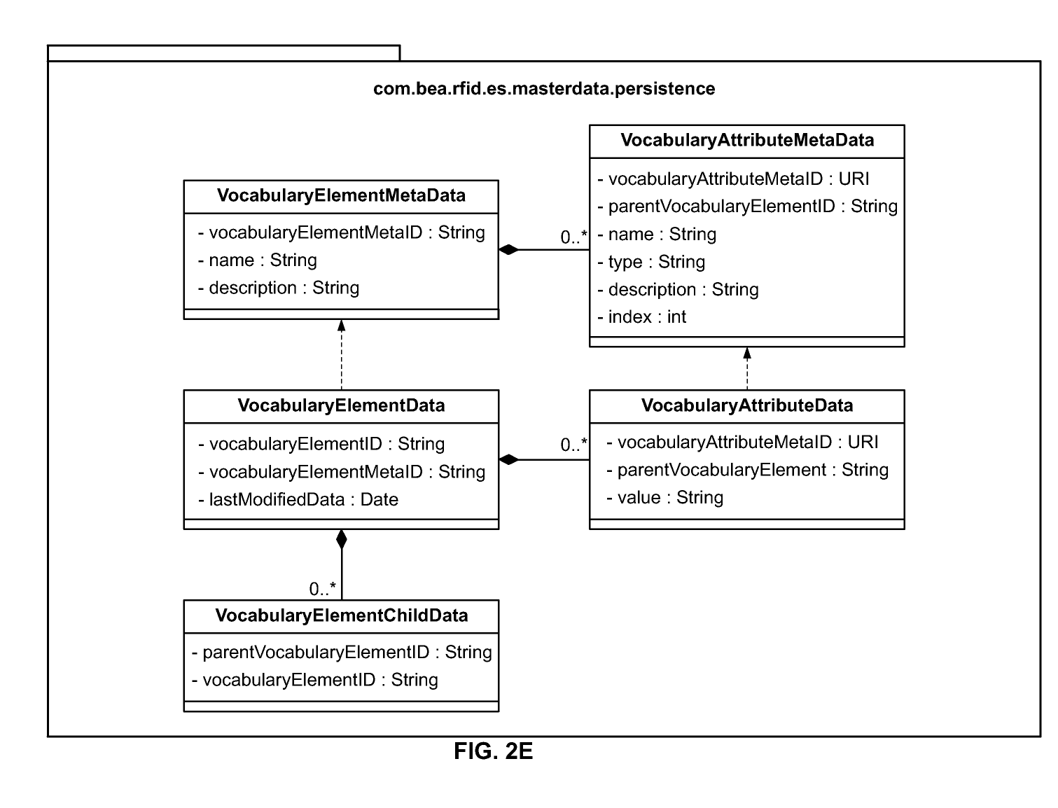

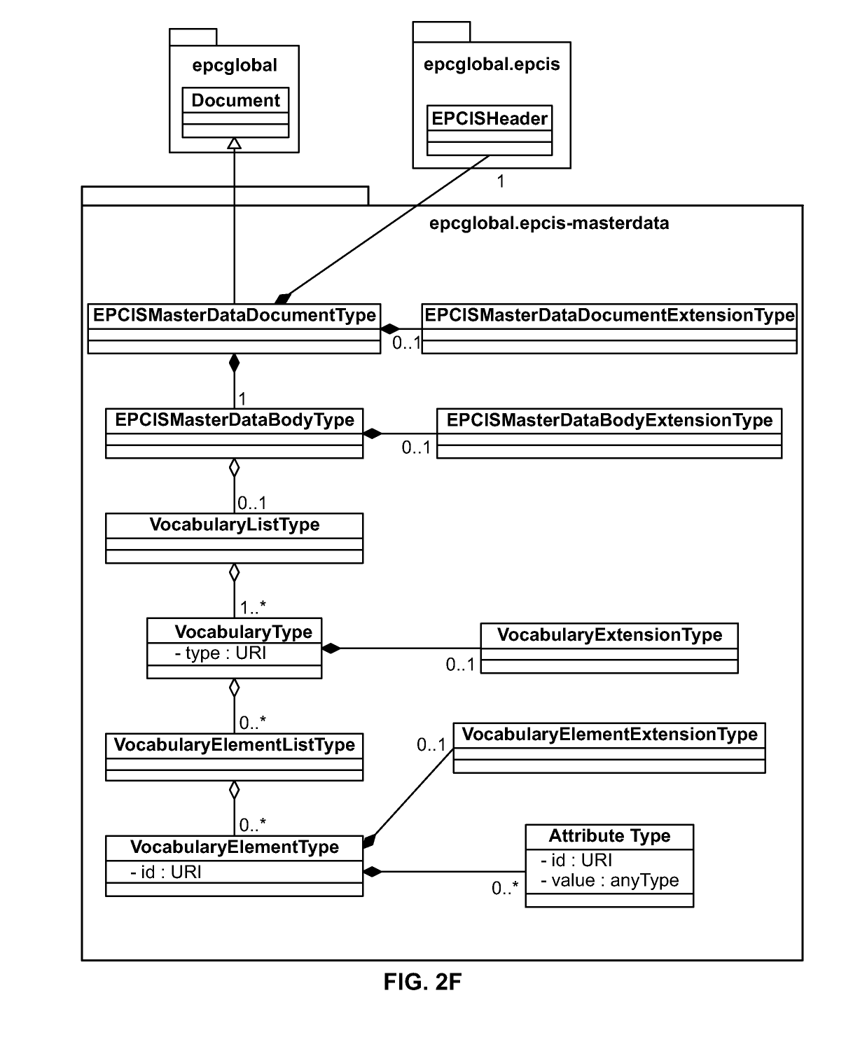

The Master Data Service can be implemented following a standard service implementation model previously used by the EPCIS and EPCPS Services. FIG. 2A outlines a Master Data implementation components including sibling EPCIS Service.

Various layers of the architecture can require different representations of the objects as they are marshaled through the system. FIG. 2B shows transformations used for Master Data of one embodiment.

Users of the Master Data Service can interact with either the CLI, the Java API or with the SOAP Interface. The SOAP interface can be publicly available. The CLI and Java API can be available for internal use. The CLI can support automated testing of the service.

The CLI can interact with Java API objects. Using the API2WSDL converter, the Java API objects can be transformed to classes that marshal the objects through the SOAP interface. Once on the server, the API2WSDL converter can be used to transform the WLS objects back to JavaAPI objects. The API2JDO converter supports conversion to JDO classes. The JDO classes support database persistence. In one embodiment, the Master Data User Interface and EPCIS Service can interact directly with the local interface of the Master Data EJB Session bean, since it is assumed that they can all be within the same WLS Application. SQL Views can provide access to the Database tables to support the requirement to provide direct access to the database.

Master Data can provide supporting information for EPCIS Events, allowing resolution of the URIs specified by the EPCIS Event attributes: business step, disposition, read point, business location, and business transaction. Master data can also be referenced indirectly through Event Extension Data attached to an EPCIS Event.

Master Data can provide Meta information that describes the allowable data types and associated attributes. Master Datacan can also include instances of the master data types, for example, location information. The Meta Information can be structured in a way to support any arbitrary type composed of a set of name value attributes. The meta information can be defined by a collection of VocabularyElementMeta and VocabularyAttributeMeta instances.

The Master Data Management interface can provide methods for management of VocabularyElementMetas and VocabularyElements.

The Master Data Administration interface can support the creation, lookup, modification and deletion of Master Data types. The following methods can be supported by the Vocabulary Meta Administration Interface:

```
+ createVocabularyElementMeta(vocabularyElementMeta :
VocabularyElementMeta) : void
    Create a VocabularyElementMeta, throw a MasterDataException
    if it already exist.
+ lookupVocabularyElementMeta(vocabularyElementMetaID : URI) :
VocabularyElementMeta
    Lookup a VocabularyElementMeta, return null if not found.
+ updateVocabularyElementMeta(vocabularyElementMeta :
VocabularyElementMeta) : void
    Update a VocabularyMeta, throw a MasterDataException if it
    does not already exist.
+ deleteVocabularyElementMeta(voabularyElementMetaID : URI) : void
    Delete a VocabularyElementMeta, throw a MasterDataException if it
    does not already exist.
+ getVocabularyElementMetaList( ) : List<VocabularyElementMeta>
    Return a list of all VocabularyElementMeta objects. Returns
    an empty list if none are available.
+ getVocabularyElementMetaIDList( ) : List<URI>
    Return a list of VocabularyElementMetaIDs., Returns an empty list if
    none are available.
```

The Master Data interface can support the creation, lookup, modification and deletion of Master Data instances. The following methods can be supported by the Vocabulary Element Administration Interface:

```
+ createVocabularyElement(vocabularyElement : VocabularyElement) : void
    Create a new vocabulary element, throw a MasterDataException, if it already exist.
+ lookupVocabularyElement(vocabularyElementID : URI) : VocabularyElement
    Lookup a vocabulary element by name, return null if not found.
+ updateVocabularyElement(vocabularyElement : VocabularyElement) : void
    Update an existing vocabulary element, throw a MasterDataException if it already exist.
+ deleteVocabularyElement(vocabualryElementID : URI) : void
    Delete an existing vocabulary element, throw a MasterDataException if it does not exist.
+ getVocabularyElementList(vocabularyElementMetaID : URI) : List<VocabularyElement>
    Return a list of vocabulary elements, throws a MasterDataException if the meta id is not found. Returns an empty list if
    there are not instances for the meta id.
+ getVocabularyElementIDList(vocabularyElementMetaID : URI) : List<URI>
    Return a list of vocabulary element ids for the give meta id, throws a MasterDataException if the meta id does not exist.
    Returns an empty list if there are no instances for the meta id.
+ lookupVocabularyElementList(vocabularyElementIDList : List<URI>) : List<VocabularyElement>
    Return a list of VocabularyElements matching the specified list of IDs, return an empty list if there are no matches.
+ lookupVocabularyElementList(vocabularyElementMetaID : URI, nameValueMap: Map) : List<VocabularyElement>
    Return a list of vocabulary element ids for the give meta id, where the name value pairs specified in the map match the
    contained VocabularyAttributes. Throws a MasterDataException if the meta id does not exist. Returns an empty list if
    there are no matching instances.
```

The Master Data Object Model can be composed of 6 classes; Vocabulary, VocabularyElementMeta, VocabularyAttributeMeta, VocabularyElement, VocabularyAttribute and VocabularyElementChild.

A Vocabulary can contain one VocabularyElementMeta and zero or more VocabularyElements. Where the VocabularyElementMeta provides the meta information for the Vocabulary, and the VocabularyElements define the instances of the vocabulary.

The VocabularyElementMeta can provide the meta information required to describe the vocabulary.

vocabularyElementMetaID: URI unique identifier for the VocabularyElementMeta

name: String descriptive unique name for the VocabularyElementMeta

description: String description for the VocabularyElementMeta

The VocabularyAttributeMeta can provide the meta information required to describe an attribute of the VocabualryElement.

vocabularyAttributeMetaID : URI unique id for the VocabularyAttributeMeta

Name: String displayable name for the VocabularyAttributeMeta

type: String type (String, Integer, Long, Boolean)

description: String description for the VocabularyAttributeMeta

index : int relative index for the attribute for UI ordering

The VocabularyElement can provide the information required to describe a vocabulary element instance.

vocabularyElementMetaID: URI identifier for the VocabularyElementMeta

vocabularyElementID: URI unique identifier for the VocabularyElement

lastModified : Date last modification date

validate( ) : boolean method to validate the VocabularyElement

The VocabularyAttribute can provide the information required to describe an attribute instance.

vocabularyAttributeMetaID : URI unique id for the associated VocabularyAttributeMeta

value: String value for the attribute, encoded as a String

The VocabularyElementChild can contain a single URI that identifies a child of the VocabularyElement. (e.g. sub location)

vocabularyElementID: URI child element for the VocabularyElement.

Vocabulary Factors can be factory for the creation of instances of Vocabulary types. This can allow the definition of interfaces later.

createVocabularyElementMeta( ): VocabularyElementMeta returns a new VocabularyElementMeta instance

createVocabularyAttributeMeta( ): VocabularyAttributeMeta returns a new VocabularyAttributeMeta instance.

createVocabularyElement( ): VocabularyElement returns a new VocabularyElement instance.

createVocabularyAttribute( ): VocabularyAttribute returns a new VocabularyAttribute instance.

createVocabularyElementChild( ): VocabularyElementChild returns a new VocabularyElementChild instance.

The Java API can define a canonical representation for the manipulation of VocabularyElementMeta and VocabularyElement instances. The Java API can implement the interface and object model defined. The Java API can support serialization and de-serialization to and from XML. A factory object can provide methods for creating instances of the Java API objects, the constructors can be package private.

A Master Data EJB Session Bean implements the interface defined by the Master Data Java API and provides an aggregation point for all external interfaces (SOAP and JSF). The application server can provide thread and transaction management for the Master Data Session Bean. The Session Bean can delegate to an implementation object to perform the work of each operation.

FIG. 2E shows a JDO object model. The JDO Persistence Layer can provide the object to relational mapping for persisting objects to the database. The layer can define an implementation of the Master Data Java API. A mapping class can support the transformation between Java API instances and Java Data objects.

In one embodiment the JDO model, the ID attributes can be defined as Strings, where in the Java API model they can be define as URIs. This is to support the JDO mapping to the Database tables.

The WSDL that defines the SOAP Interface for management of MasterData is not defined by the EPCglobal EPCIS Specification version 1.0.

The schema definition can follow the Master Data XSD defined in the EPCglobal EPCIS Specification version 1.0. An extension XSD can be defined to support the VocabularyElementMeta and VocabularyAttributeMeta types. The EPCglobal XSD can support the VocabularyElement, VocabularyAttribute, and VocabularyElementChild types.

FIG. 2F shows an exemplary EPC global master datas Schema UML diagram.

The following is an XML Schema (XSD) defining the XML binding of master data for the Core Event Types data definition module. This schema can be used for returning results from the SimplemasterDataQuery query type.

```
<?xml version=“1.0” encoding=“UTF-8”?>
<xsd:schema xmlns:epcismd=“urn:epcglobal:epcis-masterdata:xsd:1”
    xmlns:sbdh=“http://www.unece.org/cefact/namespaces/StandardBusinessDocumentHeader”
    xmlns:epcglobal=“urn:epcglobal:xsd:1”
    xmlns:xsd=“http://www.w3.org/2001/XMLSchema”
  targetNamespace=“urn:epcglobal:epcis-masterdata:xsd:1”
  elementFormDefault=“unqualified”
  attributeFormDefault=“unqualified”
  version=“1.0”>
  <xsd:annotation>
    <xsd:documentation xml:lang=“en”>
      <epcglobal:copyright>Copyright (C) 2005, 2004 EPCglobal Inc., All Rights Reserved.</epcglobal:copyright>
      <epcglobal:disclaimer>EPCglobal Inc., its members, officers, directors, employees, or agents shall not be liable for any injury,
loss, damages, financial or otherwise, arising from, related to, or caused by the use of this document. The use of said document shall
constitute your express consent to the foregoing exculpation.</epcglobal:disclaimer>
      <epcglobal:specification>EPC INFORMATION SERVICE (EPCIS) Version 1.0</epcglobal:specification>
    </xsd:documentation>
  </xsd:annotation>
  <xsd:import namespace=“urn:epcglobal:xsd:1” schemaLocation=“./EPCglobal.xsd”/>
  <xsd:import
      namespace=“http://www.unece.org/cefact/namespaces/StandardBusinessDocumentHeader”
      schemaLocation=“./StandardBusinessDocumentHeader.xsd”/>
  <!-- MasterData CORE ELEMENTS -->
  <xsd:element name=“EPCISMasterDataDocument” type=“epcismd:EPCISMasterDataDocumentType”/>
  <xsd:complexType name=“EPCISMasterDataDocumentType”>
    <xsd:annotation>
      <xsd:documentation xml:lang=“en”>
      MasterData document that contains a Header and a Body.
            </xsd:documentation>
    </xsd:annotation>
    <xsd:complexContent>
      <xsd:extension base=“epcglobal:Document”>
        <xsd:sequence>
          <xsd:element name=“EPCISMasterDataHeader” type=“epcismd:EPCISMasterDataHeaderType” minOccurs=“0”/>
          <xsd:element name=“EPCISMasterDataBody” type=“epcismd:EPCISMasterDataBodyType”/>
          <xsd:element name=“extension” type=“epcismd:EPCISMasterDataDocumentExtensionType” minOccurs=“0”/>
          <xsd:any namespace=“##other” processContents=“lax” minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“EPCISMasterDataHeaderType”>
    <xsd:annotation>
      <xsd:documentation xml:lang=“en”>
      MasterData specific header(s) including the Standard Business Document Header.
          </xsd:documentation>
        </xsd:annotation>
      <xsd:sequence>
        <xsd:element ref=“sbdh:StandardBusinessDocumentHeader”/>
        <xsd:any namespace=“##other” processContents=“lax” minOccurs=“0” maxOccurs=“unbounded”/>
    </xsd:sequence>
    <xsd:anyAttribute processContents=“lax”/>
  </xsd:complexType>
  <xsd:complexType name=“EPCISMasterDataBodyType”>
    <xsd:annotation>
      <xsd:documentation xml:lang=“en”>
      MasterData specific body that contains Vocabularies.
        </xsd:documentation>
    </xsd:annotation>
    <xsd:sequence>
      <xsd:element name=“VocabularyList” type=“epcismd:VocabularyListType” minOccurs=“0”/>
      <xsd:element name=“extension” type=“epcismd:EPCISMasterDataBodyExtensionType” minOccurs=“0”/>
      <xsd:any namespace=“##other” processContents=“lax” minOccurs=“0” maxOccurs=“unbounded”/>
    </xsd:sequence>
    <xsd:anyAttribute processContents=“lax”/>
  </xsd:complexType>
  <!-- MasterData CORE ELEMENT TYPES -->
  <xsd:complexType name=“VocabularyListType”>
    <xsd:sequence>
      <xsd:element name=“Vocabulary” type=“epcismd:VocabularyType” maxOccurs=“unbounded”/>
    </xsd:sequence>
  </xsd:complexType>
  <xsd:complexType name=“VocabularyType”>
    <xsd:sequence>
      <xsd:element name=“VocabularyElementList” type=“epcismd:VocabularyElementListType” minOccurs=“0”/>
      <xsd:element name=“extension” type=“epcismd:VocabularyExtensionType” minOccurs=“0”/>
      <xsd:any namespace=“##other” processContents=“lax” minOccurs=“0” maxOccurs=“unbounded”/>
    </xsd:sequence>
    <xsd:attribute name=“type” type=“xsd:anyURI” use=“required”/>
    <xsd:anyAttribute processContents=“lax”/>
  </xsd:complexType>
  <xsd:complexType name=“VocabularyElementListType”>
    <xsd:sequence>
      <xsd:element name=“VocabularyElement” type=“epcismd:VocabularyElementType” maxOccurs=“unbounded”/>
    </xsd:sequence>
  </xsd:complexType>
  <xsd:complexType name=“VocabularyElementType”>
    <xsd:sequence>
      <xsd:element name=“attribute” type=“epcismd:AttributeType” minOccurs=“0” maxOccurs=“unbounded”/>
      <xsd:element name=“children” type=“epcismd:IDListType” minOccurs=“0” maxOccurs=“unbounded”/>
      <xsd:element name=“extension” type=“epcismd:VocabularyElementExtensionType” minOccurs=“0”/>
      <xsd:any namespace=“##other” processContents=“lax” minOccurs=“0” maxOccurs=“unbounded”/>
    </xsd:sequence>
    <xsd:attribute name=“id” type=“xsd:anyURI” use=“required”/>
    <xsd:anyAttribute processContents=“lax”/>
  </xsd:complexType>
  <xsd:complexType name=“AttributeType”>
    <xsd:simpleContent>
      <xsd:extension base=“xsd:anyType”>
        <xsd:attribute name=“id” type=“xsd:anyURI” use=“required”/>
        <xsd:anyAttribute processContents=“lax”/>
      </xsd:extension>
    </xsd:simpleContent>
  </xsd:complexType>
  <xsd:complexType name=“IDListType”>
    <xsd:sequence>
      <xsd:element name=“id” type=“xsd:anyURI” maxOccurs=“unbounded”/>
    </xsd:sequence>
    <xsd:anyAttribute processContents=“lax”/>
  </xsd:complexType>
  <xsd:complexType name=“EPCISMasterDataDocumentExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISMasterDataHeaderExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISMasterDataBodyExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“VocabularyExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“VocabularyElementExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
</xsd:schema>
```

The following diagram defines the tables used to store the Master Data objects. These tables can be derived based on the Master Data Java Data objects.

| Table Name | Column Name | Column Type | Attributes |
|---|---|---|---|
| vocabulary_element_meta | vocabulary_element_meta_id | VARCHAR(255) | Key |
| | Name | VARCHAR(255) | |
| | Description | VARCHAR(255) | |
| vocabulary_attribute_meta | parent_vocabulary_element_meta_id | VARCHAR(255) | Key |
| | Name | VARCHAR(255) | Key |
| | Type | VARCHAR(255) | |
| | Description | VARCHAR(255) | |
| | Index | INTEGER | |
| vocabulary_element | vocabulary_element_id | VARCHAR(255) | Key |
| | vocabulary_element_meta_id | VARCHAR(255) | |
| | last_modified | DATE | |
| vocabulary_attribute | parent_vocabulary_element_id | VARCHAR(255) | Key |
| | Name | VARCHAR(255) | Key |
| | Value | VARCHAR(255) | Index |
| vocabulary_element_child | parent_vocabulary_element_id | VARCHAR(255) | Key |
| | vocabulary_element_id | VARCHAR(255) | Key |

FIG. 2G shows a master data user interface implementation.

The Master Data user interface can be implemented with Java Server Faces (JSF). The JSF implementation can be composed of JSF pages, one or more management classes, and the Master Data Java API objects. Following the Model View Controller (MVC) pattern, the Master Data Java API classes can provide the model, the JSF pages provide the View, and the Management class acts as the Controller. The Management classes can delegate to the interface provided by the Master Data EJB Session bean.

The ALECLI can be extended to support Master Data. The Command Line Interface (CLI) can provide a framework for Master Data automated testing and may eventually be exposed as a public interface. The Master Data CLI can provide support for creation, display, and deletion of Vocabulary Types and creation, display, deletion and modification of Vocabulary Elements.

Vocabulary Type Commands can include:

Vocabulary Type Creation:

```
master-data create vocabulary-type <vocabulary_type_uri>
        [description <description>]
        (attribute name <name> type <type> [description
        <description>])*
Vocabulary Type Display:
    show master-data vocabulary-type <vocabulary_type_uri> [ as
    (text | xml)]
Vocabulary Type Deletion:
    master-data delete vocabulary-type <vocabulary_type_uri>
Vocabulary Type Import/Export (as XML):
    master-data ( import | export) vocabulary-type
    [<vocabulary_type_uri>] file <file-name>
```

Vocabulary element commands can include:

Vocabulary Element Creation:

```
  master-data create vocabulary-element <vocabulary_element_uri>
    (attribute name <name> value <value>)*
Vocabulary Element Display:
  show master-data vocabulary-element <vocabulary_element_uri>
  [ as (text | xml)]
Vocabulary Element Deletion:
  master-data delete vocabulary-element <vocabulary_element_uri>
Vocabulary Element Update:
  master-data set vocabulary-element <vocabulary_element_uri>
    (attribute name <name> value <value>)+
Vocabulary Element Import/Export (as XML)
  master-data ( import | export) vocabulary-element
  [<vocabulary_element_uri>] file
  <file-name>
```

This following describes the Enterprise Server within the space of the query interface, subscriptions, and interoperability with an AS2 EDI Engine. In the base use case, an administrator can configure a subscription to send query results to a trading partner via the AS2 protocol periodically. The administrator can configure queries through a web GUI (the “Subscription Console”) and then create subscriptions that periodically execute queries and report them through a separately configured connection to an AS2 engine.

The query interface can be in spec with the EPCglobal Working Draft of Jan. 8, 2006. This includes all of the predefined queries and subscription interface. The implemented APIs can include: subscribe, unsubscribe, poll, getQueryNames, getSubscriptionIDs, getStandardVersion, and getVendorVersion. The SimpleEventQuery can be supported. The SimpleMasterDataQuery can be supported, as a stretch goal. This interface can be exposed as a SOAP service and internally via a Java API directly called from within the Enterprise Server's other components. The subscription service should support the full QuerySchedule mechanism for scheduling delivery of reports to various recipients. The subscription service would not support the use of a trigger URI to trigger report generation. Future releases should bring trigger driver support in from the RFID Edge. The subscription service can support the notification URI schemes supported by the Edge Server Notification infrastructure (http, jms, console, and file).

The subscription service can support a configurable AS2 notification URI. The AS2 URI scheme can be configured as a Notification framework driver instance, configured through the same interface used to configure other notification drivers. A standard AS2 scheme can provide all the necessary information to send a notification to the trading partner. It may be as simple as “as2:trading-partner-name”. A Cyclone integration driver can be used to provide the AS2 URI scheme to the Notification framework. This can effectively be an adapter layer to turn a symbolic AS2 notification into a JMS message to the Cyclone engine, to be turned back into an AS2 transaction.

The subscription administration web interface provides a tabular view of the query subscriptions placed in the system. The interface can be designed with an understanding of the SimpleEventQuery and provide friendly dialogs to parameterize the query, rather than exposing the raw parameter lists that associate each query. The interface can provide a dialog to specify a notification delivery schedule, exposing the entirety of the QuerySchedule capability. This interface can be accessible even to novice users. The interface can provide a dialog to specify the notification recipient. For existing notification mechanisms, this can use the notification URI editor code from the Edge Administration Console, providing a consistent user experience. This web application can provide for customized (plug-in) customization of query/subscription parameters.

All screens can have two panels. Left panel can be a navigational panel, with links to different functional screens. Links with the yellow background denote current selection. By clicking on a link in the left panel, a corresponding screen can display in the right panel. Screens and panels can conform to the usual WLS Console look and feel. They can contain all customary navigational and help elements.

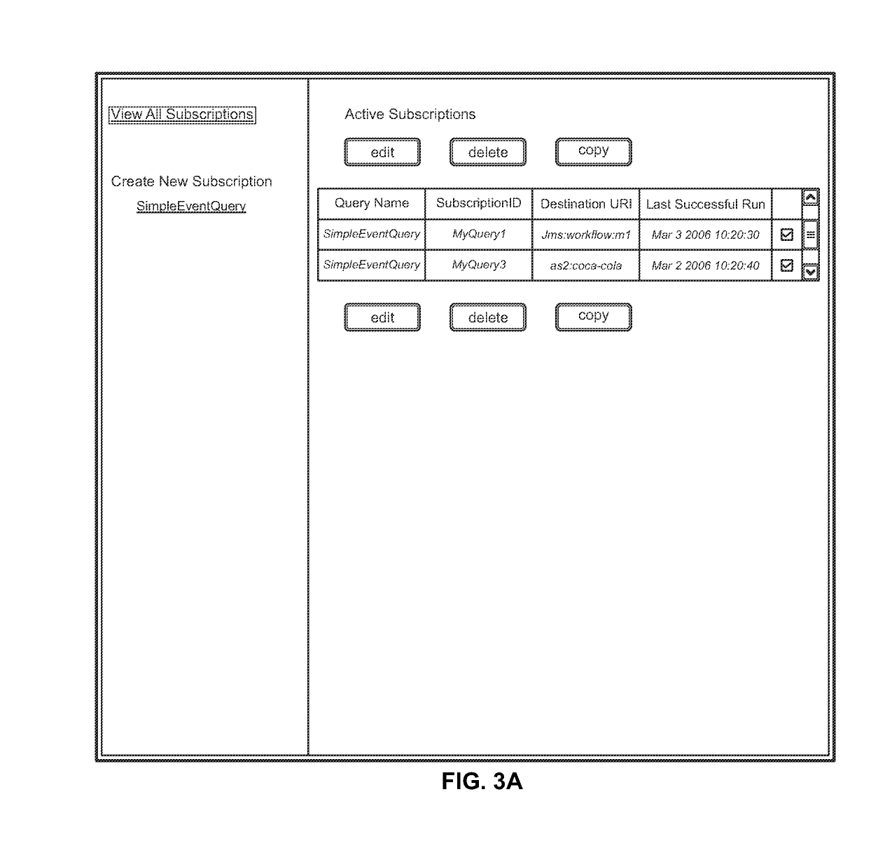

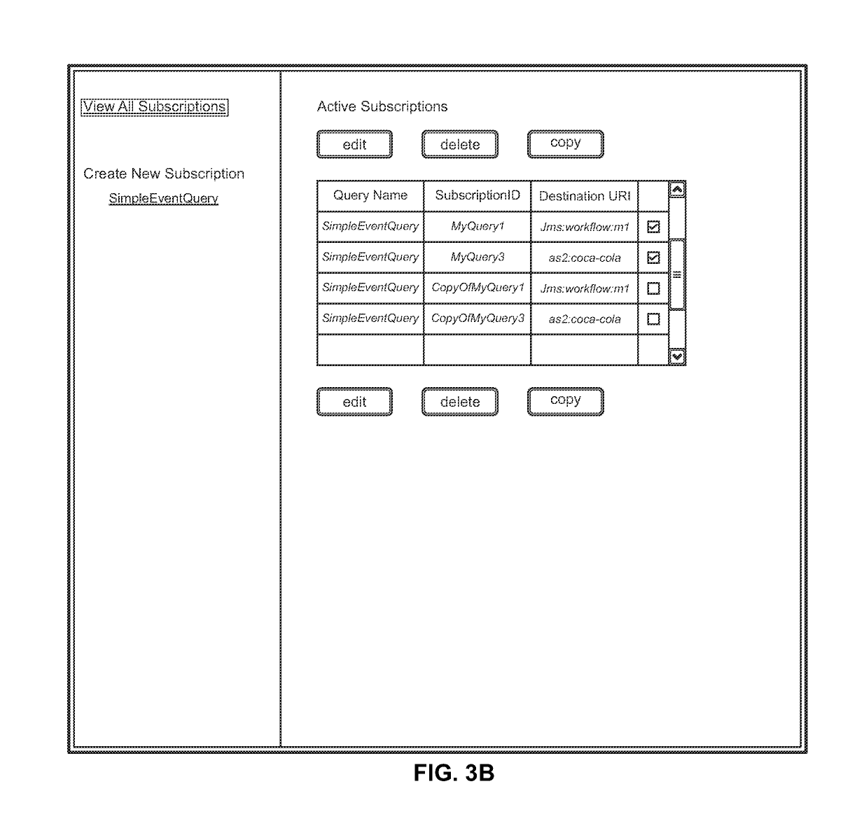

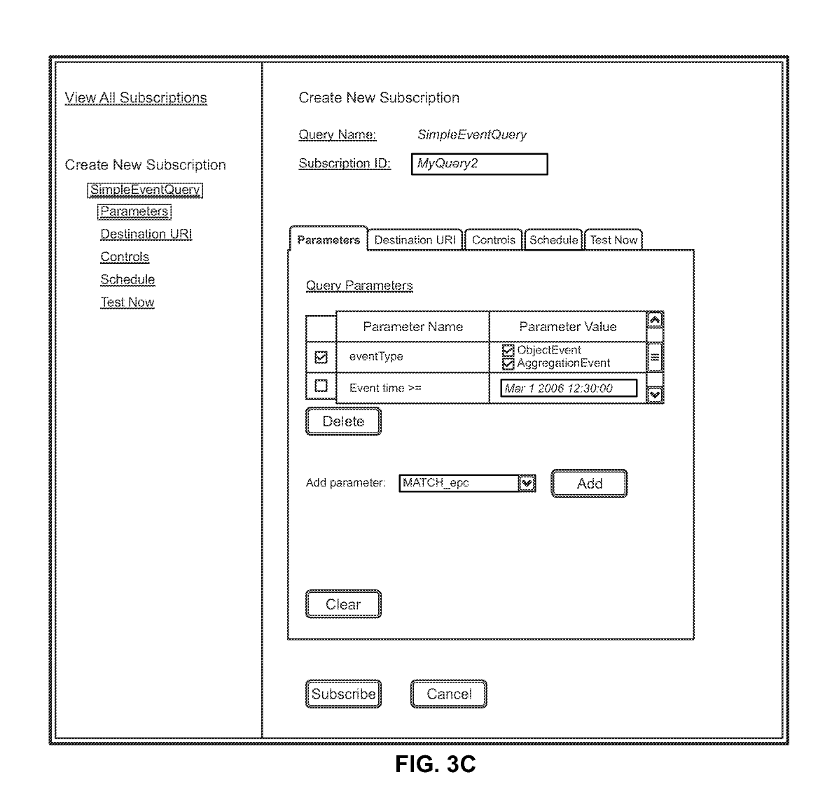

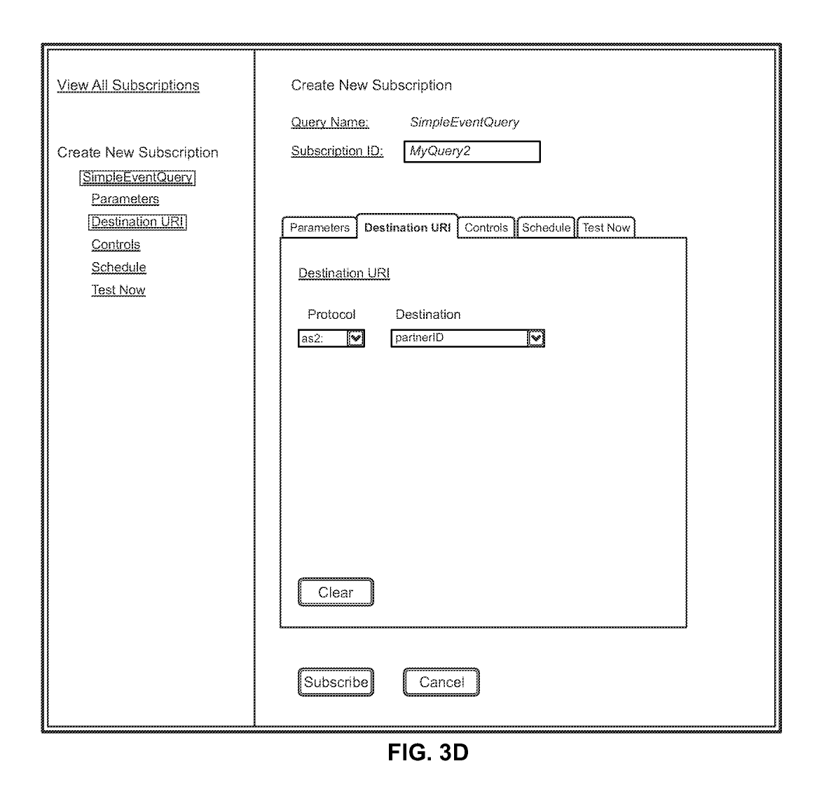

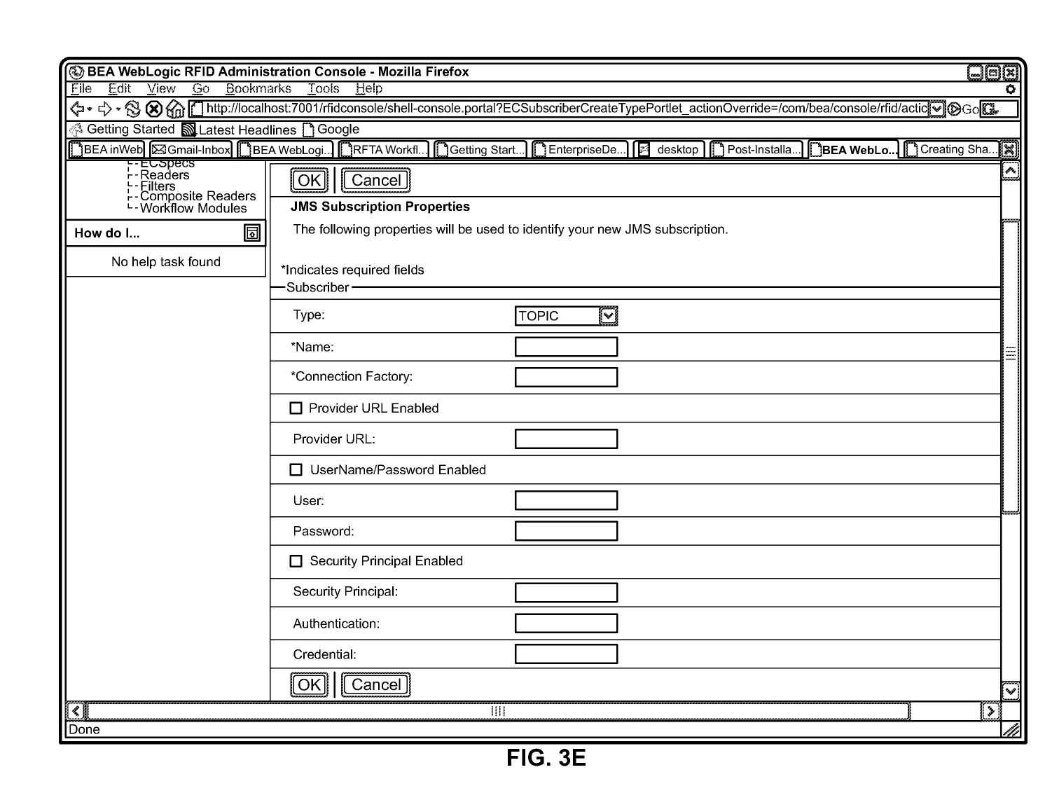

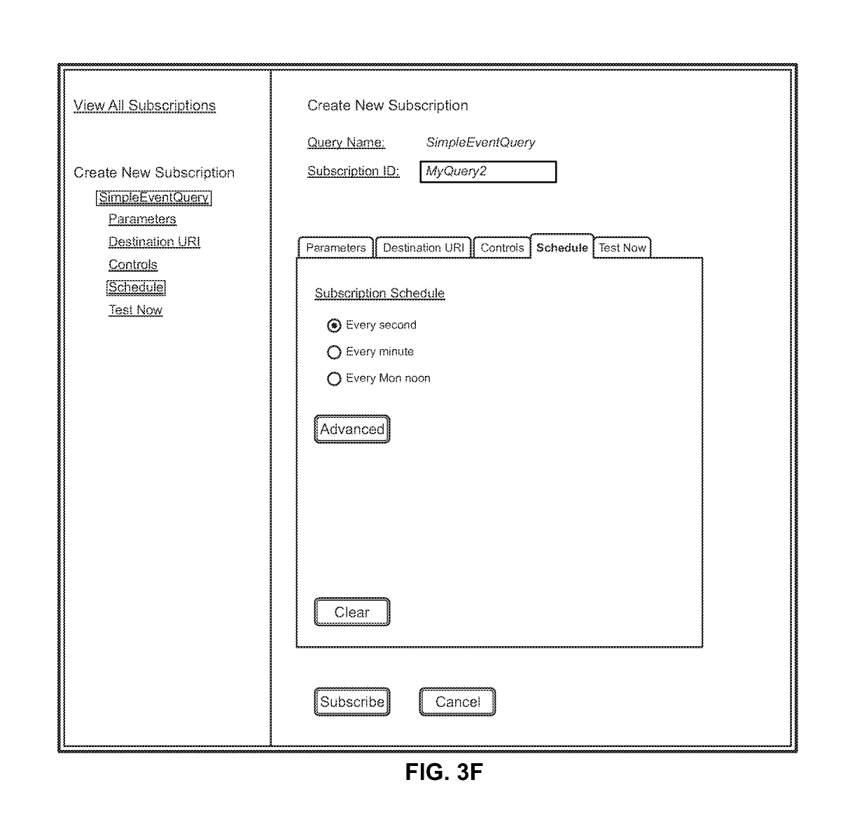

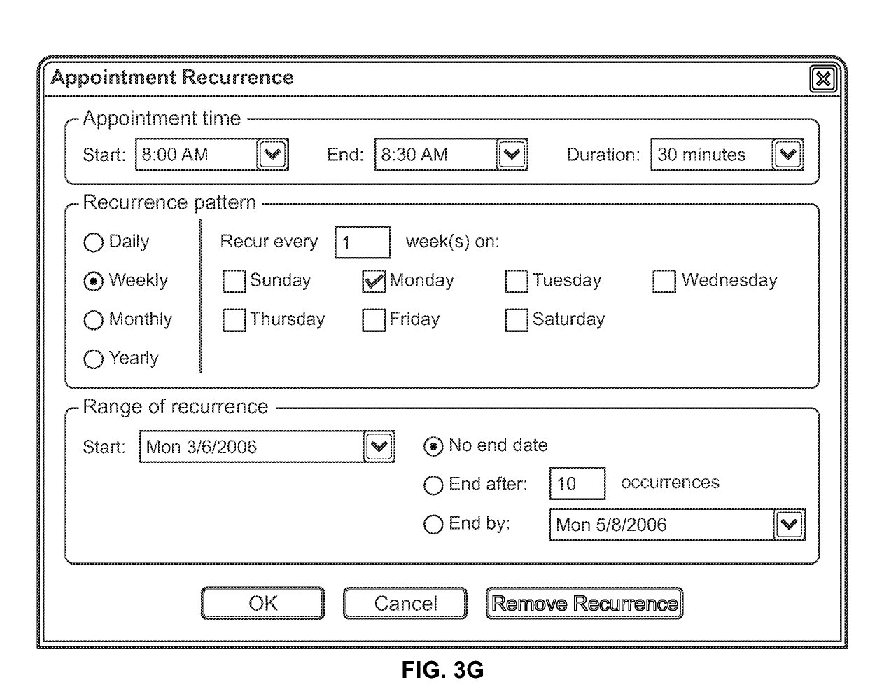

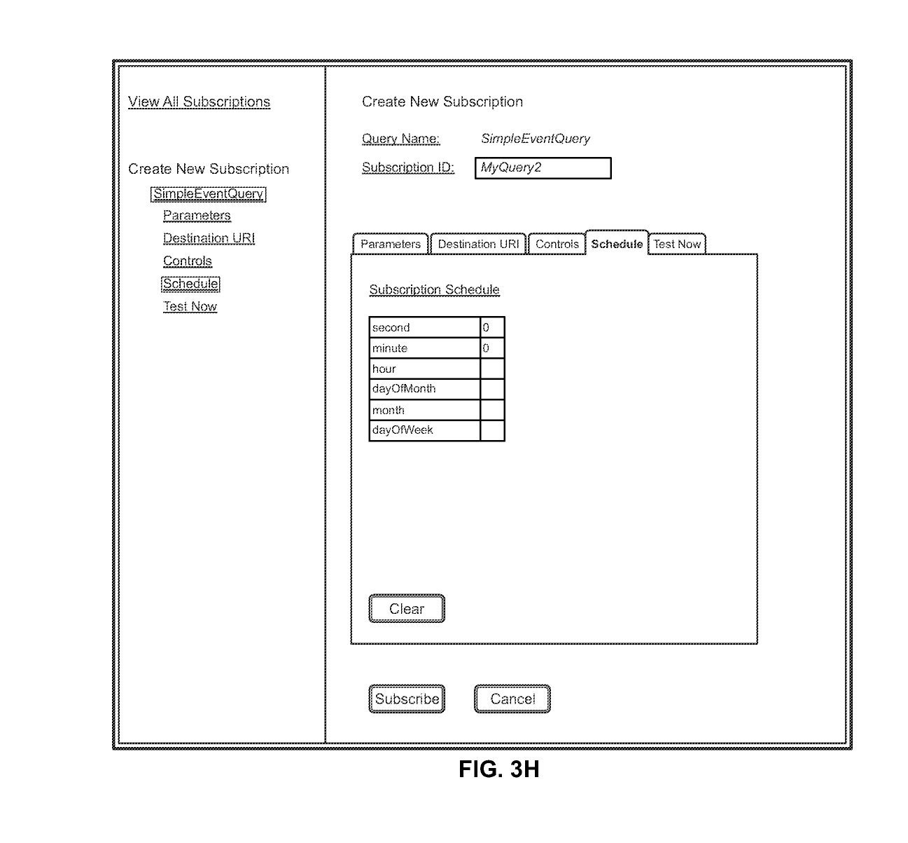

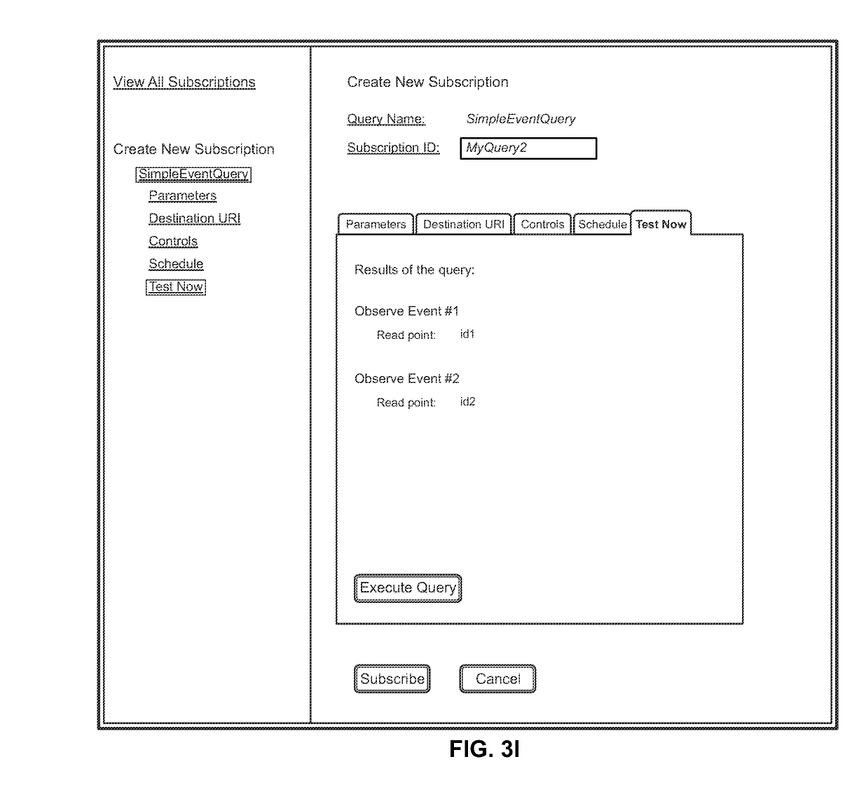

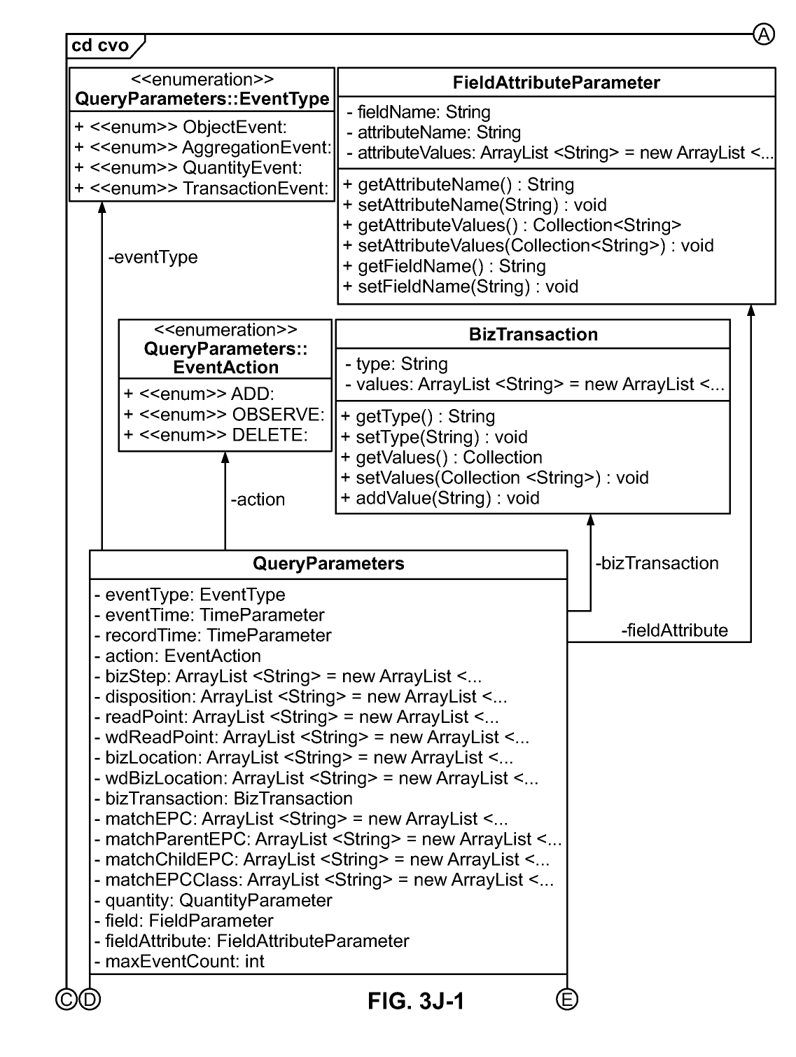

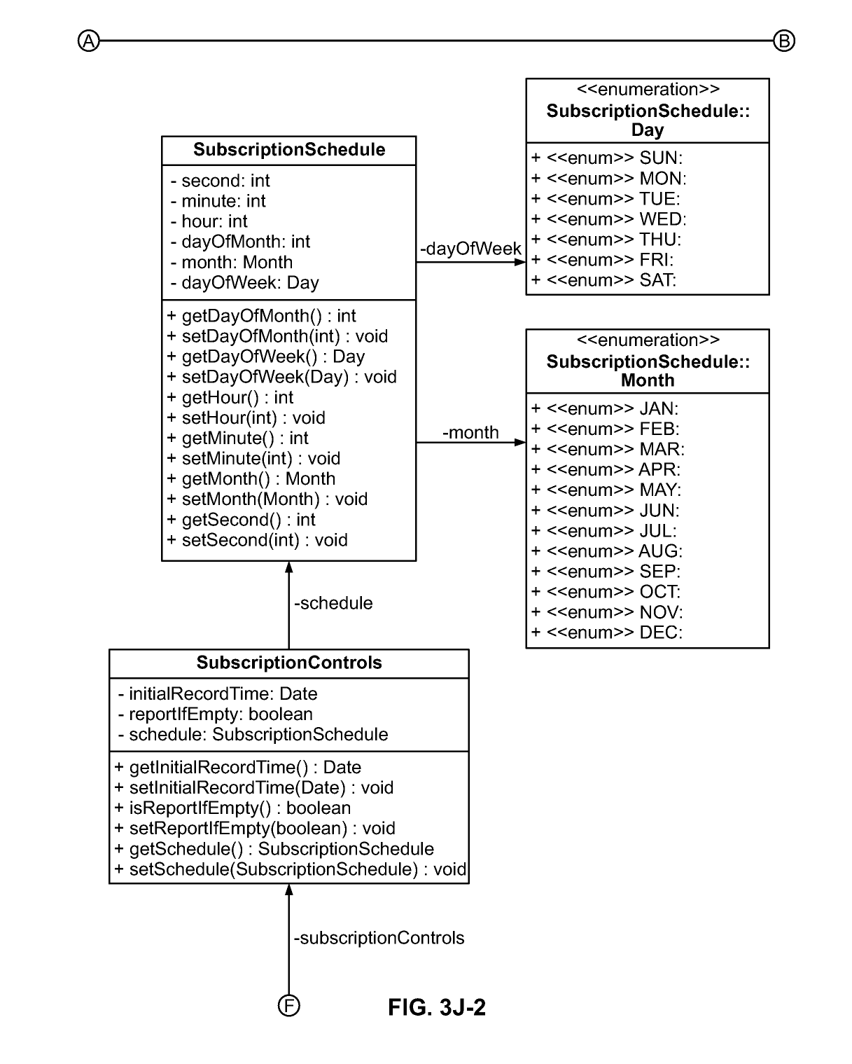

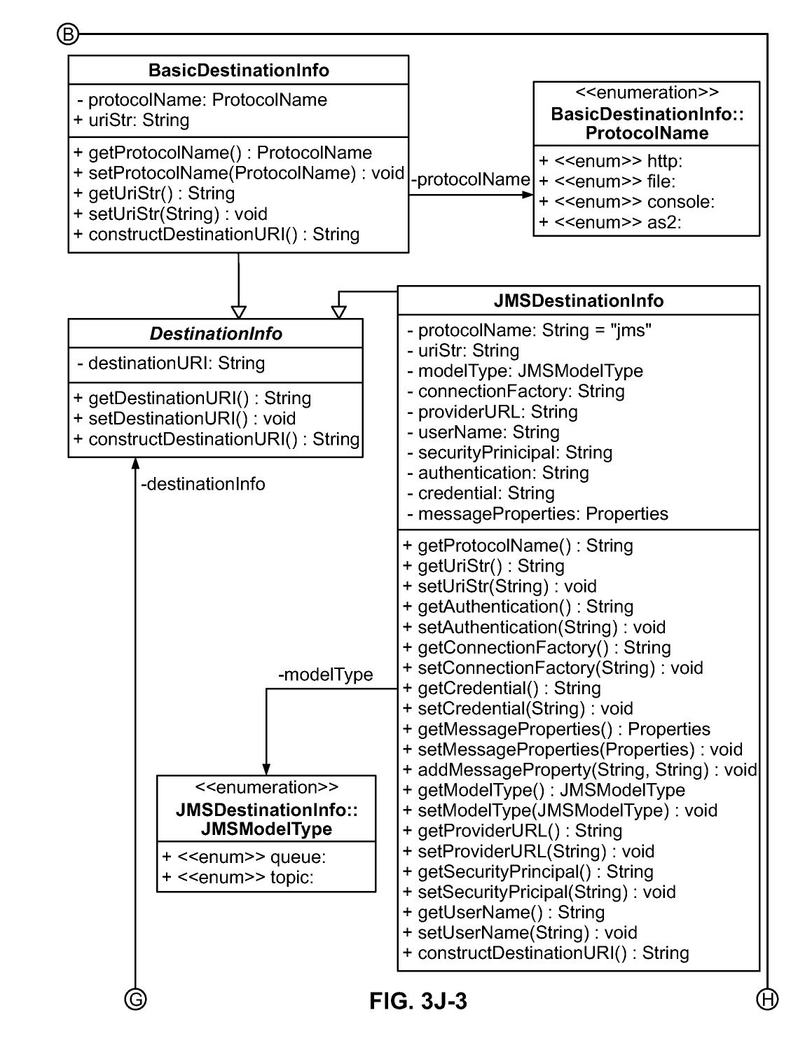

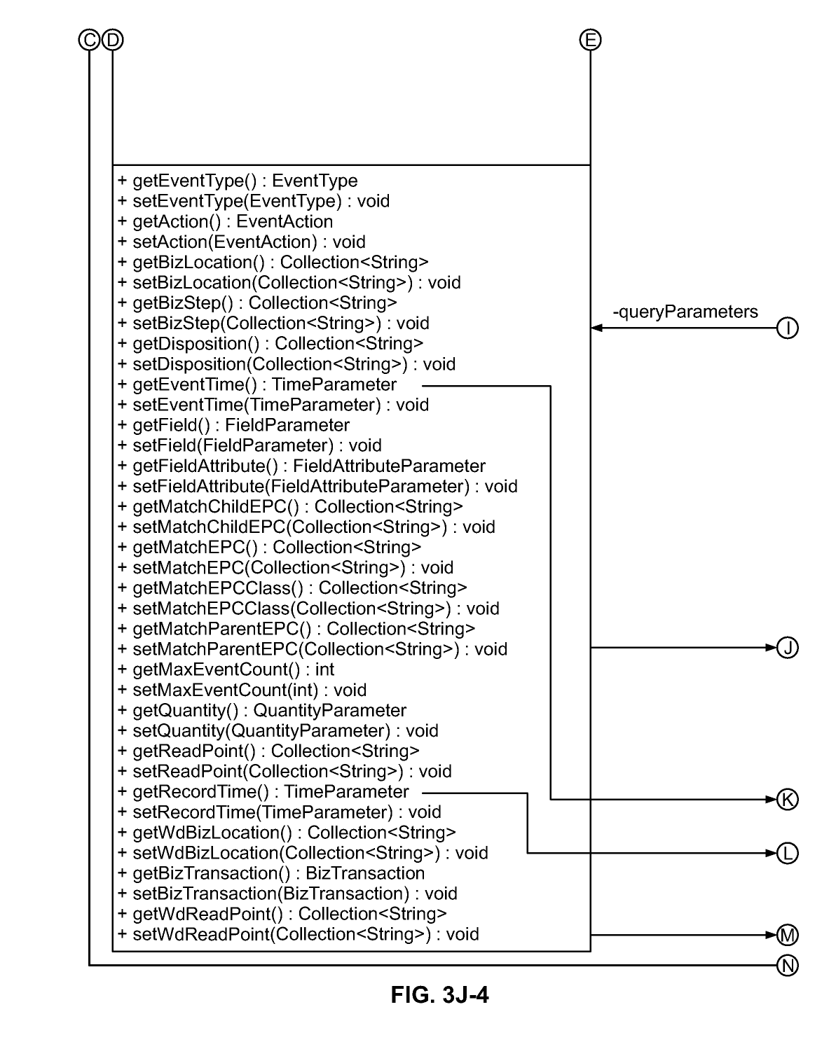

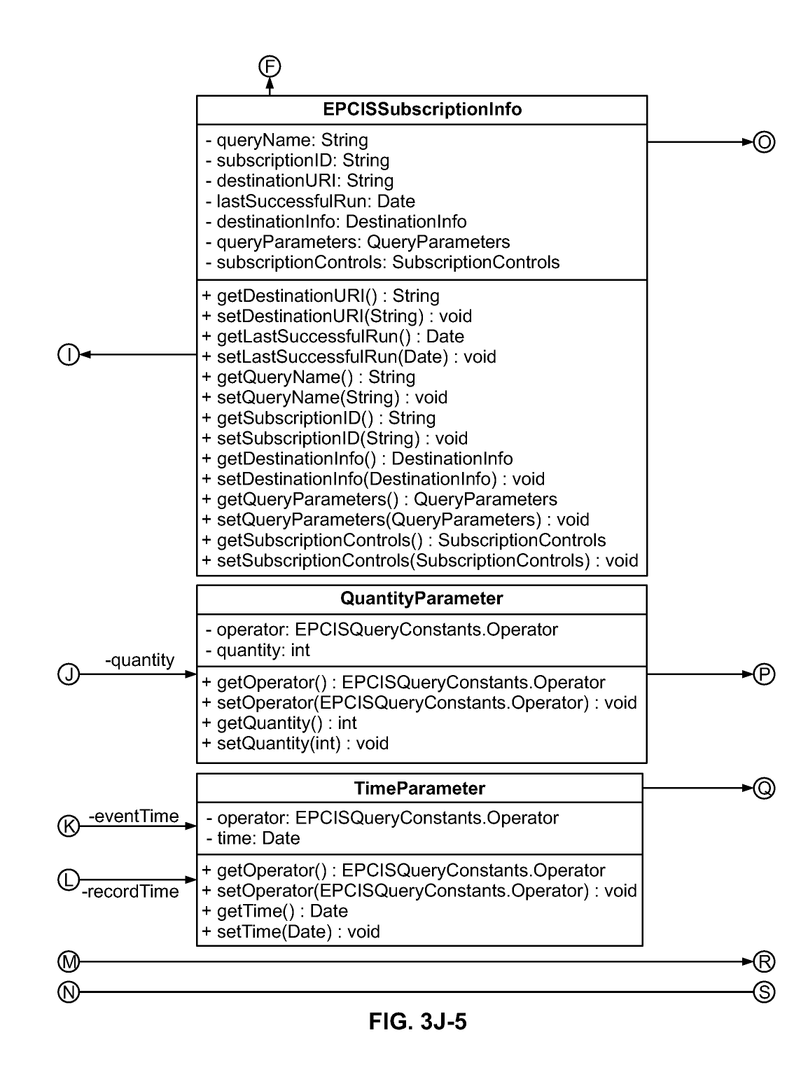

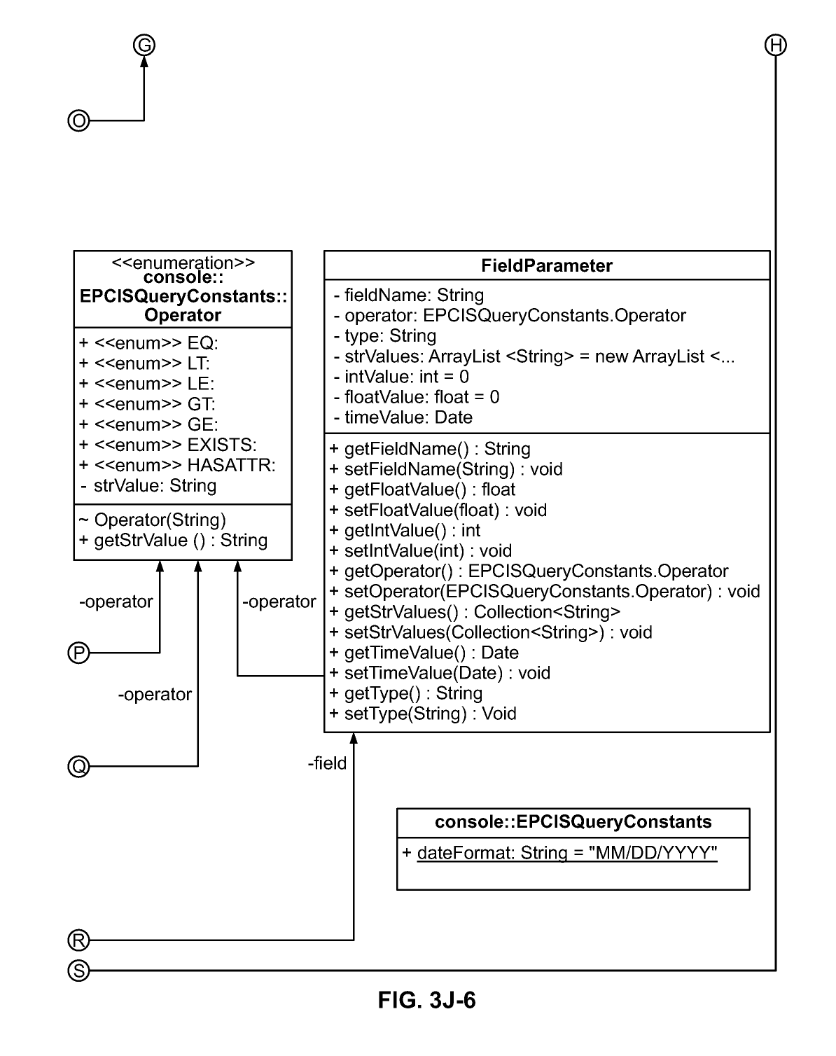

FIG. 3C shows first page of the Admin GUI can display all active subscriptions:

“Delete” button—delete (unsubscribe) this subscription “Create New Subscription” section contains links to administration screens for creating different types of queries/subscriptions. For the first release we support the SimpleEventQuery type only, in the future releases other types of queries might be added. “SimpleEventQuery” link—brings up Query Administration screens to define and subscribe new SimpleEventQuery queries. Additional links under the “SimpleEventQuery” link point to specific areas of the query/subscription configuration. “Edit” button—edit selected subscription. If multiple subscriptions are selected, the first one can be used. It brings up the same Query Administration screens with all query information pre-populated into the tables. The only differences between the screens are:

“Edit Subscription” label on the left panel (instead of the “Create New Subscription” label)

“Edit Subscription” label on the administration screens (instead of the “Create New Subscription” label)

Delete” button—delete selected subscription(s). Queries of the deleted subscriptions are not saved. “Copy” button—clone selected subscription(s). New subscriptionIDs can be generated based on the old ones. All other parameters can be copied from the old queries. If one subscription is selected, the “Edit Subscription” screen can be brought up with all pre-populated parameters. When multiple subscriptions are selected for copying, copies of each selected subscription can be created, the table with subscriptions is updated and the same screen (“View All Subscriptions”) stays active. After the “Copy” button is clicked, the screen can look as shown in the FIG. 3B.

All Query Administration screens can be arranged into tabs. They can contain non-editable “Query Name” field and editable “Subscription ID” field as well as a set of the following common buttons: “Subscribe”—subscribe this query (with whatever parameters and controls have been specified so far) “Clear”—clear all user-specified values of this section (tab) “Cancel”—abandon all changes and return to the “View All Subscriptions” screen means can be provided for storing and retrieving partially and fully defined queries in a persistent repository. This would also require the full activation/suspension framework to be implemented as well.

The first query administration screen is shown below in the FIG. 3C. It allows defining query parameters. A few most common parameters can be selected and displayed in the parameters table, pre-populated with the default values. A user can be able to select additional parameters from the menu. After making a selection, the user can click “Add” button and the selected parameter can be added to the parameter table. In case of a complex parameter, customized configuration screens can pop-up. After finishing this configuration, the user can close the window and the parameter can be added to the parameter table. Parameters can be removed by selecting them using the checkboxes in the left-most column and pressing “Delete” button. Query parameters can be validated using plug-in customized validators.

Destination URI can be configured identically to the RFID Admin Console. Depending on the destination type, the Admin screen can display different configuration options and parameters to fill in FIG. 3D is an example of the configuration screen for the AS2 protocol.

Screens for other subscriber types can be similar to the RFID Admin Console ones. As an example, FIG. 3E shows how a JMS subscriber is configured.

FIG. 3E shows a subscription control screen. One of the subscription controls is the Schedule control. Clicking the “Edit” button can bring the Schedule configuration screen.

FIG. 3F shows a subscription schedule screen. Subscription schedules can be defined with different levels of details. For less technical users, and less complex schedules, the most commonly used schedules with friendly descriptions can be presented as a list of choices.

To define more complex schedules, a user would click the “Advanced” button which would bring up a screen, like that shown in FIG. 3G, where the user could define all separate parameters of the schedule—in a cron-like fashion. Some provisions can be made to remember what level of details was used to define a schedule for a particular query when editing it in the future.

FIG. 3H shows a “Test now” screen Queries can be tested before subscribing them by going to the “Test Now” screen and executing the query. The results of the query can be displayed in a simple text or XML format such as in FIG. 3I.

FIG. 3J shows a domain objects model designed to be used as the “Model” layer in the Subscription web application. Most objects can be used as backing beans in the application's JSPs and Struts actions.

Exemplary reports can include:
1. History Report (where have assets been)
2. Missing Assets Report
3. Dwell Time Report
4. Transit Time Report
5. Aggregation EPCs:
   The reports can be available via:
1. Web based GUI. It should be possible to export the reports to file in XML or CSV formats.
2. Samples to be used with Crystal Reports that should be run separately. It is sufficient if the samples are available through dev2dev site after 2.0 releases.
3. DB views for some or all of the reports for the supported databases.

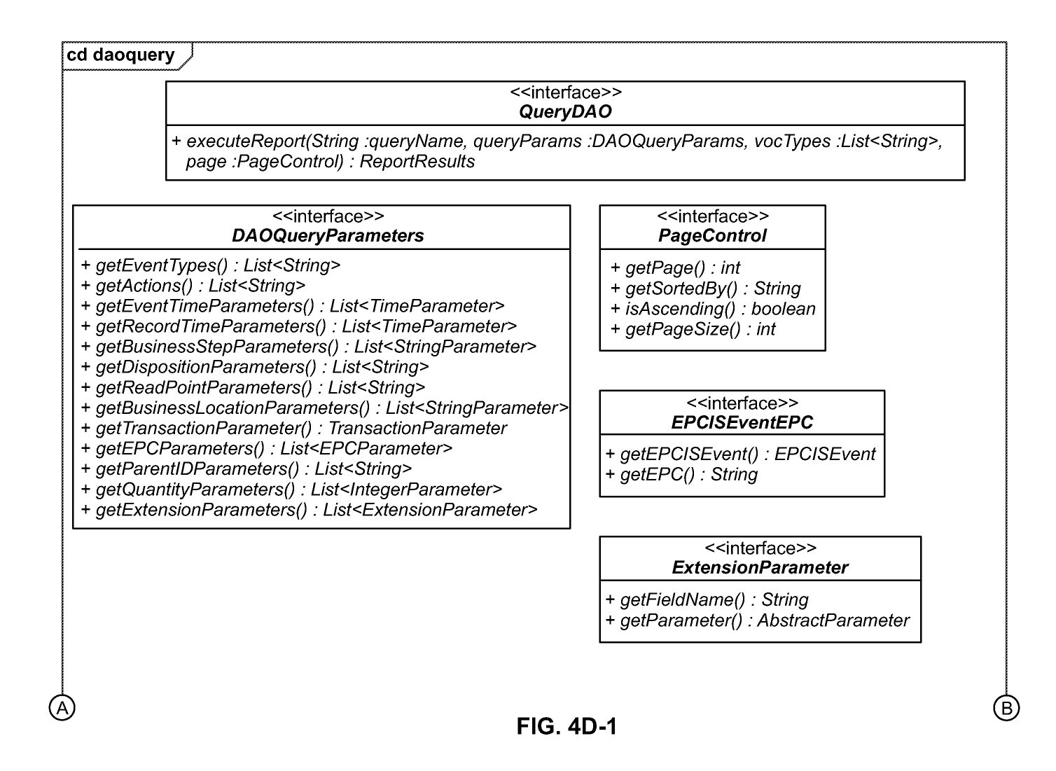

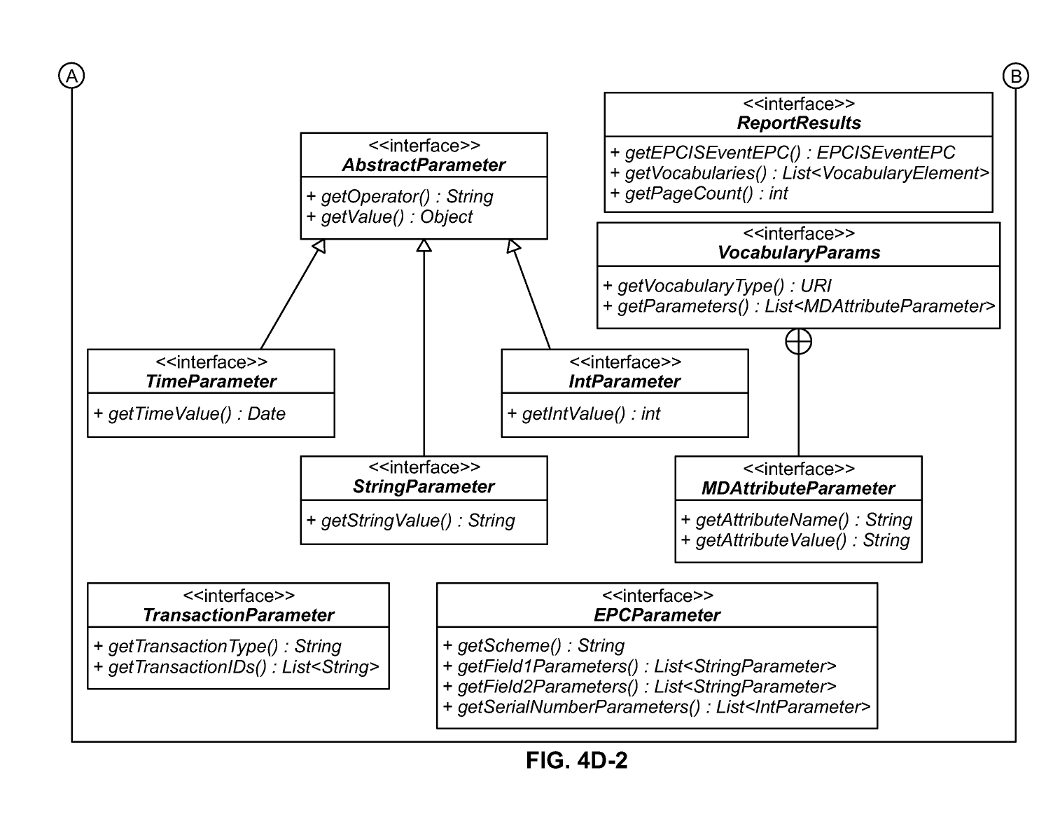

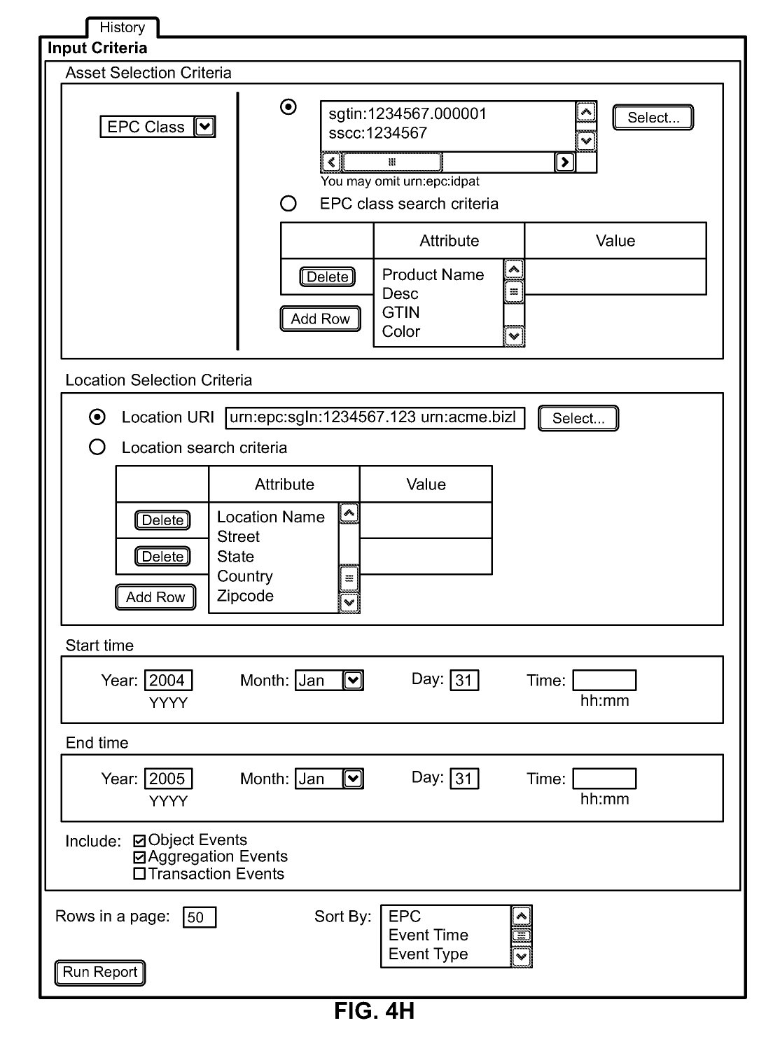

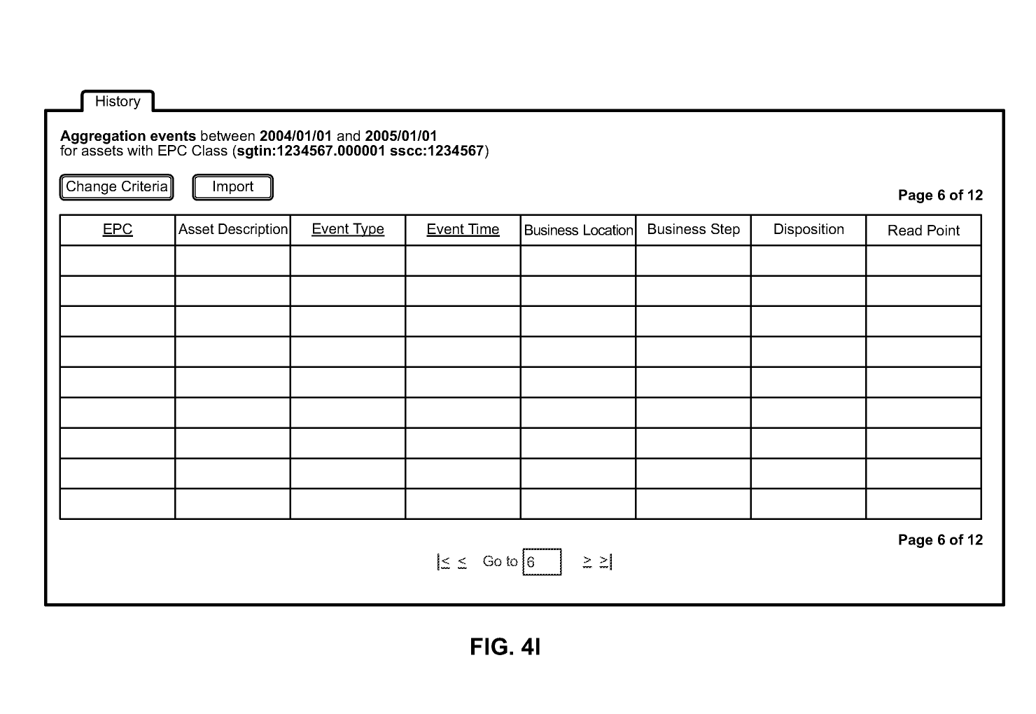

EPCIS reports are based on EPCIS events data and master data. Master Data may be maintained in the same data source as EPCIS events or they may be maintained separately by the customer. For example, product catalog is typically maintained by other customer applications. However, they can translate some of this information as EPCClass vocabulary and import it into our data source. In one embodiment, we can support master data maintained by our EPCIS implementation only. An API can be exposed to integrate multiple data sources (other master data sources, our EPCIS repository and our master data sources) with our reports implementation. This may be done using other products, like AquaLogic Data Services Platform, which are designed to integrate data from multiple sources. FIG. 4A shows an architecture diagram of one embodiment.

In addition to the architecture of FIG. 4A, we can be able to support the architecture of FIG. 4B. This may be specified using EPCIS query implementation configuration.

This diagram, the layer below impl is replaced with a DSP-based implementation. This implies that the interface between DAO and impl classes are somewhat well defined and that the layers DAO and down may be replaced with something else later.

FIG. 4C shows another architecture option.

From report output screen, user may choose the export the report in CSV format or XML format. Export can export the full report and not just the page that is displayed at the time.

The report can be sent to the browser with content type as application/x-download, so that the browser can take care of saving it to a local file or displaying it in an application.

This can be accomplished by the following sequence of processes:

1. User clicks on the export button.
2. A background thread is kicked off to get the report entries page by page and save it to a temporary location on the server, in the appropriate format (CSV or XML). UTF-8 character encoding can be used to convert to bytes, so that the different locale characters can be preserved.
3. A progress bar can be displayed to the user showing the report generation progress.
4. After the complete report is generated (progress bar can indicate 100%), a response can be sent to the browser with content-type=application/x-download and charset=UTF-8. Content length can be set as the length of the temporary file of the generated report and the temporary file contents can be streamed to the browser.
5. The action that the browser can take can vary from browser to browser, but, it may put up a dialog asking if the file should be saved or opened using some application.

XML for a report entry can contain the EPC for that entry and the events associated with the entry. For event XML, we can use the XSD defined by EPCIS component. Below is the XML schema definition for a report:

```
<xsd:element name=”EventReport” type=”EventReportType”/>
<xsd:complexType name=”EventReportType”>
  <xsd:element name=”ReportEntry” type=”ReportEntryType”
        minOccurs=”1” maxOccurs=”unbounded”/>
</xsd:complexType>
<xsd:complexType name=”ReportEntryType”>
  <xsd:sequence>
    <xsd:element name=”epc” type=”epcglobal:EPC”
          minOccurs=”1” maxOccurs=”1”/>
    <xsd:element name=”EventList” type=”epcis:EventListType”
          minOccurs=”1” maxOccurs=”1”/>
    <xsd:any namespace=”##other” processContents=”lax”
        minOccurs=”0” maxOccurs=”unbounded”/>
  </xsd:sequence>
  <xsd:anyAttribute processContents=”lax”/>
</xsd:complexType>
```

The CSV format can follow the exact same format as it is displayed in the reports console. In the current release, the report output need not be customizable and hence there can be only one CSV format per report. Escaping of the column entries can follow the conventions followed by Microsoft Excel™.

| | |
|---|---|
| The CSV format can follow the exact same | The report output need not be customizable |
| format as it is displayed in the reports | and hence there can be only one CSV |
| console. In the current release | format per report. Escaping of the column |
| | entries can follow the conventions followed |
| | by Microsoft Excel ™. |
| EPC | String representing the full URI |
| | representation of the EPC as it was sent to |
| | the EPCIS implementation. |
| Asset Description | This can be available only if EPCClass |
| | master data is available. This column can |
| | be a String representing the first attribute of |
| | the EPC Class master data entry |
| | corresponding to the EPC. |
| Event Type | Object Event or Transaction Event or |
| | Aggregation Event with parent ID |
| Event Time | Locale specific representation of the event |
| | datetime. |
| Business Location | String representing: |
| | A description of the business location if |
| | business location master data is available |
| | for the event's business location |
| | Business location URI if master data is |
| | not available. |
| Business Step | String representing: |
| | A description of the business step if |
| | business step master data is available for |
| | the event's business step |
| | Business step URI if master data is not |
| | available. |
| Disposition | String representing: |
| | A description of the disposition if |
| | disposition master data is available for the |
| | event's disposition |
| | Disposition URI if master data is not |
| | available. |
| Read Point | String representing: |
| | A description of the read point if read |
| | point master data is available for the |
| | event's read point |
| | Read Point URI if master data is not |
| | available. |

EPCIS reports can be obtained using the EPCIS query EJB. The internal query API can be enhanced to support reports. Enhancements include:
1. In reports, we display certain master data attributes, like product description, that can provide meaningful information to the user. To do this, we can specify the master data and its attributes that should be returned along with the result events. For this release, this may just be a list of vocabulary type URIs identifying the master data types.
2. Queries can be able to return the relevant EPC and master data information along with EPCIS events. The UML below shows class ReportResult for this.
3. Qquery methods can support paging.
4. New query parameters can be used if the report queries cannot be satisfied using the standard EPC global specified query parameters.

Special query names to handle dwell report, transit report and may be missing assets report. Poll can be used with these query names and appropriate query parameters for these reports.

The impl layer (refer to the architecture diagram) can be responsible for
1. Understanding any EPCglobal or EPCIS specific conventions.
2. Converting the query parameters to query parameters for the data source layer.

The parameters can be specified so that the data source layer can be able to blindly apply the query parameters for the specific query type. For example, the data source can know the query that should be executed for SimpleEventsQuery. It can apply the specified parameters to the query. It can also have knowledge about which master data types correspond to which event fields. FIG. 4D shows a UML diagram for the API that the impl layer can be used to talk with the DOA layer.

Exemplary database schema

EPCIS Event Table

EPCIS Event:

| | | Column |
|---|---|---|
| Column Name | Type | constraints |
| event_id | Integer | PK |
| event_time | Date | |
| record_time | Date | |
| action | String | |
| read_point_uri | String | |
| business_step_uri | String | |
| business_location_uri | String | |
| disposition_uri | String | |
| event_type | String | |

Indexes can be used at least on the fields that are searched on (business_location_uri, read_point_uri, entent_time).

EPC:

| | | Column |
|---|---|---|
| Column Name | Type | constraints |
| epc_id | Integer | PK |
| uri | String | Indexed |
| scheme | String | Indexed |
| pure_identity_uri | String | Indexed |
| filter_value | String | Indexed |
| company_prefix | String | Indexed |
| reference | String | Indexed |
| serial_number | String | Indexed |
| epc_class | String | Indexed (new |
| | | column) |

EPCIS_Event_EPC:

| Column Name | Type | Column constraints |
|---|---|---|
| event_epc_id | Integer | PK |
| event_id | Integer | Indexed |
| parent_epc | String | Indexed |
| child_epc | String | Indexed |

Master Data Tables

Vocabulary_Element_Meta:

| | | Column |
|---|---|---|
| Column Name | Type | constraints |
| vocabulary_element_meta_index | Integer | PK |
| vocabulary_element_meta_id | String | Unique Index |
| name | String | |
| description | String | |

Vocabulary_Attribute_meta:

| | | Column |
|---|---|---|
| Column Name | Type | constraints |
| vocabulary_attribute_meta_index | Integer | PK |
| parent_vocabulary_element_meta_id | String | |
| vocabulary_attribute_meta_id | String | |
| name | String | |
| type | String | |
| sequence_index | Integer | |
| description | String | |

Indexes can be used onfields lik parent_vocabulary_element_meta_id and vocabulary_attribute_meta_id.

Vocabulary_Element:

| | | Column |
|---|---|---|
| Column Name | Type | constraints |
| vocabulary_element_index | Integer | PK |
| vocabulary_element_id | String | Unique Index |
| vocabulary_element_meta_id | String | |
| last_modified | Date | |

Vocabulary_attribute:

| | | Column |
|---|---|---|
| Column Name | Type | constraints |
| vocabulary_attribute_index | Integer | PK |
| Parent_vocabulary_element_id | String | |
| vocabulary_attribute_meta_id | String | |
| Value | String | |

Index can be used on the other 3 fields.

The system can handle hierarchical master data

There is no good way to traverse a tree structure in SQL. (oracle has ‘connect by’ clause, but, that is not a standard). To get around this problem and search for ‘descendants of’ somewhat efficiently, a separate table can be used to store the ancestors of master data elements. This can be maintained as master data is created. The table structure can be as shown below:

Vocabulary_Element_Ancestors

| | | Column |
|---|---|---|
| Column Name | Type | constraints |
| vocabulary_element_id | String | PK |
| vocabulary_ancestor_id | String | PK |

To use EPC Class as an input criterion effectively, a field EPC_Class to can be used in the EPC table, which can store the EPC Class for the EPC. The serial number as a separate field in the EPC table.

Product catalog can be integrated into the asset selection criteria. Users can include assets in a report by specifying the EPC Class for the assets, EPC values of the assets, GTIN or company prefix. FIG. 4E illustrates a GUI to allow users can be able to specify EPC Class for the assets.

Users manually type in the EPC Class values or select it from a list using the ‘Select . . . ’ button. Users can also specify the EPC Class by including the search criteria for it. For example, they may be able to say that they are interested in all assets with GTIN=gtin1 and Color=red. In one embodiment, the ‘Select . . . ’ button and ‘EPC class search criteria’ can be enabled only if the vocabulary type for EPC Class is available and has elements. The screen shots for entering EPCs, GTINs or Company Prefixes are shown in FIG. 4F.

If there is no access to business locations master data, users can to type in the business location URI as the input criteria. If business locations master data is available, user should be able to specify the business location by:
1. Typing in the business location URI
2. Selecting a business location from a list: Hierarchical locations can be displayed, from where user can drill down to the next level or select a location.
3. Specifying search criteria for business location: Available the attributes can be displayed and users can specify the value to match the attribute.

FIG. 4G shows a screen shot for this. ‘Select . . . ’ and ‘Location search criteria’ can be enabled only if business location vocabulary is available (the type is defined and there are elements).

Meaningful information can be displayed in the reports instead of just the URI, if we have that information available. For example, instead of displaying the business location URI, we could display the location name attribute. In master data administration design, the first attribute of a vocabulary type can be chosen as the identifying attribute. The same attribute can be used in the report output as well.

History Report

A history report can show where/when assets were seen and in what context. This may be used to track how assets flow within a system.

Users can be able to specify
the assets they are interested in (optional).
time range (optional): The user can enter the start date (not time) and end date for the report. The report produced can include all the events in the time period, including events on the start and end date.
event types that the user is interested in (optional): A drop down of the event types can be provided. Quantity Event can not be available in the list.

FIG. 4F is a screen shot of an report input criteria GUI
Exemplary Output Format
The events can be shown ordered by EPC, Event Time by default. The most recent events can be shown first.
Users can be able to sort on Event Type or Event Time by clicking on the column heading. In those cases, EPC can be applied as additional sort key.
Asset description can show the columns designated as report fields in EPCClass vocabulary type.

‘Event Type’ can show the event type and any information specific to the event type. For aggregation event, if the EPC is the parent, it can say something like ‘Parent in aggregation event’. If it is the child, it can say ‘In aggregation event with parent <epc>’. For aggregation events, user can be able to click on this to find the EPCs involved in the aggregation event.

Exemplary Algorithm and JDO Query

This gets all the EPCIS events within the time range, where the parent EPC or child EPC matches the asset selection criteria. If GTIN is specified as asset selection criteria, it can be converted to EPCClass before using it in the query.

Exemplary JDO Query:

```
Select event from EPCISEventEPCData, childEPC where
  <event.eventTime in time range, if time criteria is specified> and
  eventTypesList.contains(event.eventType) and
  (select vocabularyElementID from VocabularyElement where
    vocabularyElementMetaID = urn:epcglobal:epcis:vtype:EPCClass
    vocabularyAttributeList.contains(var1) and
    var1.vocabularyAttributeMetaID = <attr1> and
    var1.value = <attr1_value> and
    <same for other attributes>).contains(childEPC.epcClass)
  order by childEPC.uri, event.eventTime;
```

The range of the rows that should be returned can be specified to the JDO Query object.

The missing assets report tries to answer ‘which assets are missing’ question by reporting the assets that have not been seen since a specified time. If a location is specified here, this can give a report of assets that have not been seen at the specified location. Input criteria for this report can be:
Asset selection criteria (optional): Same as Error! Reference source not found.
Events start time (optional): This parameter can be used to reduce the number of events that can be considered for generating the report. Only events with time greater than or equal to the start time can be used to generate the report.
Location selection criteria (optional): The location specified here can be treated as hierarchical location. In other words, all the events for this location or its descendents can be included in the report.
Missing time threshold: This is the amount of time after which an asset can be reported as missing. User can be able to specify this in number of days. In one embodiment, only assets that have not been seen for the specified number of days or more can be shown as missing.

The input screen for this can look similar to the history report input screen.

Output Format
By default, the report can be shown in ascending order of last seen time.
The column ‘Last seen’ can show the time of last sight and the missing number of days

Users can be able to sort on any of the fields by clicking on the column heading.

| | | | | | | | | |
|---|---|---|---|---|---|---|---|---|
| EPC | Asset | Days | Last | Event | Business | Disposition | Business | Read |
| | Description | since | seen | Type | Location | | Step | point |
| | | last | time | | | | | |
| | | sight | | | | | | |

Output screen can look similar to that of history report.

The report can show all EPCs that have events before the threshold time and none after that. So, the query should get the event with the max(event time) for all EPCs that do not have events after threshold time.

An exemplary, SQL Query for this is shown below. The query below shows getting only ‘asset_description’ from EPCClass vocabulary. Similar thing should be done for other vocabulary types as well (business location, read point, disposition, business step).

```
SELECT epc.uri, event_time, event_type, ... epc_class.value, ...
FROM epc, epcis_event_epc, epcis_event.
(SELECT e.vocabulary_element_id, value
  FROM vocabulary_element e, vocabulary_attribute a,
    vocabulary_attribute_meta a_m
  WHERE e.vocabulary_element_meta_id =
urn:epcglobal:epcis:vtype:EPCClass
  AND a.parent_vocabulary_element_id = e.vocabulary_element_id
  AND a.vocabulary_attr_meta_id = a_m.vocabulary_attr_meta_id
  AND a_m.parent_vocabulary_element_meta_id =
urn:epcglobal:epcis:vtype:EPCClass
  AND a_m.sequence_index = 1) epc_class
WHERE epcis_event_epc.child_epc_id = epc.epc_id
AND epc.epc_class = <epc class sub query>
AND epcis_event.event_id = epcis_event_epc.event_id
AND epcis_event.business_location_uri = <location selection sub query.
AND epcis_event.event_time =
    (SELECT MAX(event_time) FROM epcis_event ee,
    epcis_event_epc eee
    WHERE eee.child_epc_id = epcis_event_epc.child_epc_id
    AND eee.event_id = ee.event_id)
AND epc_class.vocabulary_element_id = epc.epc_class
AND epcis_event.event_time < threshold_time
ORDER BY event_time;
```

A dwell time report can show how long assets stayed at a particular location. This may be used to find out if assets are moving out of locations at the required rate.

Input criteria for this report would be:

Asset selection criteria (optional).
Time range during which the asset was at the location
Location selection criteria: This can be similar to above except that locations selected can not be treated as hierarchical locations.

Exemplary Output Format
By default the entries can be shown in descending order of Dwell time. EPC can be used as secondary key.

Users can be able to sort on EPC, Entry Time or Exit Time by clicking on the column heading.

| | | | | |
|---|---|---|---|---|
| EPC | Asset Description | Entry Time | Exit Time | Dwell Time |

Exemplary Algorithm and JDO Query

This report can be calculated by getting, for each epc,
min(event time) before the specified time range for the specified location.
min(event time) at a different location.

A travel time report can be used to show how long assets take to move from one point to another. This report can be used only to calculate the transit time from one point to another point. This can not include assets that did not reach the destination yet.

Input criteria for this report can be:

Source read point
Destination read point
Asset selection criteria (optional)
Departure time range (optional): This can be used to specify that the report should show only assets that started from the source during the specified time range.
Arrival time range (optional): This can be used to specify that the report should show only assets that reached the destination during the specified time range.

If both departure time range and arrival time range are specified, the report can show all the assets that departed during the departure time range or arrived during the arrival time range.

By default, the report can be shown in descending order of transit time, with EPC as the secondary sort key.

User could sort on EPC, Departure Time or Arrival Time by clicking on the column heading.

| | | | | |
|---|---|---|---|---|
| EPC | Asset | Departure Time | Arrival Time | Transit Time |
| | Description | | | (in days) |

It may be useful make the EPC value in the report a link and show users the events from the departure time to arrival time for that EPC.

This report can exclude assets that left the source and arrived at the destination multiple times in the time range specified.

This report can be generated by finding for each EPC,
max(event time) at source read point
min(event time) at destination read point and computing the difference

This document defines end-user requirements for EPCIS reports. The intent is to provide an overarching framework and roadmap.

Dimensions can Include:
Closed loop vs open loop
In a closed loop system, the set of assets can more or less fixed (though the asset base may change slowly due to expansion, contraction, or replacement), and the customer is interested in the whole population. It is meaningful to ask what is “missing.” Examples include tracking fixed assets, reusable transport items, etc.
In an open loop system, the set of assets is constantly changing, as new items enter the system and old items are consumed or leave. Examples include tracking manufactured goods through a supply chain.
Single enterprise vs multi-enterprise
In a single enterprise system, all data of interest is generated within one enterprise.

In a multi-enterprise system, the data of interest is generated within more than one enterprise, and so data can be gathered from others via data exchange to get a complete picture. Conversely, it is likely that the end user can need to deliver data to others so that they can get a complete picture.

These two dimensions can be orthogonal:

| | Closed Loop | Open Loop |
|---|---|---|
| Single Enterprise | Fixed asset tracking; e.g., | Tracking disposable assets |
| | postal service roll cages. | through a manufacturing |
| | | process |
| Multi Enterprise | Returnable transport | Manufactured goods supply |
| | container; e.g. CHEP | chain |
| | pallet | |

Individual assets vs class structure.

All vocabulary types, including EPCs, location identifiers, business step/disposition identifiers, can have hierarchical relationships that are important for reporting. In specifying a report, a user can specify an element high in a hierarchy to designate a category of identifiers to consider; e.g., “show me all locations in Kansas.” The output of a report may group or sort according to hierarchy.

Hierarchical relationships useful for reporting may arise from several sources:
The identifier itself may have a class structure; e.g., an SGTIN EPC implies a parent GTIN. SGTIN, SGLN, and GRAI identifiers have this kind of structure.
There can be an explicit hierarchical relationship expressed in the master data for identifiers; e.g., specific GIAIs could be identified as children of some other identifier.
There can be an explicit hierarchical relationship expressed in the master data for class-level identifiers, which in turn implicitly extends down to the instance-level identifiers contained in those classes.

A given identifier can have more than one parent, and hence there can be a multi-hierarchy. For example, a specific case of 6.4 oz Acme Mint-flavor Toothpaste may have an SGTIN, which is a child of a GTIN EPCClass identifier for 6.4 Acme Mint-flavor Toothpaste, which is both a child of a class identifier representing “Toothpaste” as well as a class identifier representing “perishable goods.”

Aggregations may be used to infer observations of aggregated EPCs. For example, subsequent to a case-to-pallet aggregation, an observation of the pallet tag may be used to infer an observation of the case tags.

The best user experience is obtained if the reports speak the customer's language. Thus, there can be several reports which share a common core of processing, but vary in their presentation to speak more directly to the customer. In considering this, it is worth thinking about specific vertical requirements; e.g., What reports do suppliers need? Retailers? Pharma ePedigree?

Examples of Asset-Oriented Reports
What assets are there? (Summary based on last sighting of each asset.)
Where are the assets now? (Summary based on last sighting of each asset.)
Where have assets been? (Detailed event history for each asset.)
What assets are missing? (Summary based on assets not seen within some time interval—mainly of interest only in closed-loop systems.)

Example of Location-Oriented Reports:
What locations are there? (Summary based on master data only.)
What's at each location? (Summary based on last sighting of each asset, organized by business location.)
What's passed through each location? (Detailed event history for each location, organized by read point.)
How long have assets stayed at each location? (aka “Dwell Time”, based on comparing entries/exits, organized by business location)
How long have assets taken to go from point A to point B? (aka “Transit Time”, based on comparing exit to entry, organized by read point)
Did any assets leave location x anytime during y? [requires observes that report going to location]
Did any assets arrive @ location x anytime during y?

Example of Business Process-Oriented Reports
What business steps & dispositions are there? (Summary based on master data only.)
What's in each disposition? (Summary based on last sighting of each asset, organized by disposition.)
What's passed through each business step? (Detailed event history for each location, organized by business step.)
How long have assets stayed in each business condition? (analogous to “Dwell Time”, based on comparing entries/exits, organized by disposition)
How long have assets taken to go from business step A to business step B? (analogous to “Transit Time”, based on comparing exit to entry, organized by business step)
What new assets were there during y?
How many of each asset did we decommission during y?

Examples of Exception-Oriented Reports
What assets took too long to transit?
What assets sat too long?
What assets didn't I receive?

Examples of Complex Reports

The reports in this section are more complex and more like real analytics than the previous ones. They're here as a reference point, but likely to be prioritized further out.
QC: tag readability: % of tags seen at different points in supply chain by sku? Trend over time? Variance among locns
A possible group of missing reports has to do w/reconciling: did locn x receive all of Shipment/Pallet/Order y? or more generally, “What missing or extra things did we receive at locn x during
What about questions like: what was in Shipment/Pallet/Order y? result could be manifest (sku x qty) or attendee list (EPCs). There's also the inverse question: what Shipment/Pallet/Orders was x in during T?
“Missing items”

Airline baggage carriers: each carrier has a destination which implies a routing through portals. It has a due date (time). When an individual carrier gets assigned to a destination/time, which gets communicated to the workflow. As each portal reads a tag, it checks whether that tag is on track or off track. If off track, then sends alarm (configurable destinations such as stack lights, horns, GUIs, log files, JMX/SNMP . . . ). If late, it sends a possibly different alarm. All data gets logged for transit time and other reports as well. Reporting would report all logged alarms.
Other similar customer problems: visiprise tracking of components for assembly, Rolex tracking of materials for assembly? Forklifts and/or pallets showing up at docks. Forklift picking a pallet.
The picking example implies that the route may not be deterministic but a more general directed graph (it doesn't matter if it goes to B or C first but A−>(B & C)−>D is the route.
A variant can be that each portal would query a system of record for whether the tag is on track. This variant makes more sense as an extension of the system of record receiving an observe event rather than an edge capability, perhaps.
Another variant would be to commission and produce a tag for each asset for each trip e.g., individual bags, parts for assembly.
an old variant that we've not played in is active tags for shipping containers and observing in rail, trucking, and dock yards.
AWOL items (e.g., roll cages, CHEP pallets, fur coats, pharmaceuticals, backup tapes, . . . ) where items are tracked through directional portals.
A mapping of portals/biz location and time that indicates a threshold for AWOL thus triggering inclusion in a report or alarming (SNMP/JMX, message to a dashboard app . . . ) For all last seen locns, for all tags, if now—seen >threshold, send alarm.
Inventory missing (same items as above plus things like IV pumps, computing h/w, etc) where inventory is done by scanning all items in inventory occasionally.
After scan, note all missing items from expected inventory list where expected inventory is tag x locn. Separate completely missing from in wrong place.
   Exemplary Report Details

Exemplary Asset-Oriented Reports

What assets are there? Where are the assets now?
User inputs:
Time horizon
Asset selection criteria
Business location selection criteria
Disposition selection criteria
Output customization
Algorithm:
Get events where T>=horizon, EPC matches asset selection criteria
Retain only most recent per EPC
Filter using business location selection, disposition selection
Output:
<Asset description> <Last seen> <Location description> <Business description>

Where have assets been?
User inputs:
Time range
Asset selection criteria (could chain from prior report)
Output customization
Algorithm:
Get events where T is within range, EPC matches asset selection criteria
Order by EPC, then Time descending
Output:
<Asset description> <Event time> <Location description> <Business description>

What assets are missing?

The following report is “what assets have no observation since time T?”, which is an approximation to the business question “what assets are missing?” Its usefulness hinges on the user's ability to select a suitable time threshold. E.g., if the business process is such that all assets should be sighted at least once a week, then this report is useful with a threshold of one week. For other business processes this might not be possible because there is no clear threshold between missing and merely slow-moving.
User inputs:
Time horizon
“Missing” threshold
Asset selection criteria
Business location selection criteria
Output customization
Algorithm:
Get events where T>=horizon, EPC matches asset selection criteria
Retain only most recent per EPC
Retain only those where T<(now minus threshold)
Filter using business location selection
Output:
<Asset description> <Last seen> <Location description> <Business description>

What locations are there? What is at each location?
User inputs:
Business location or read point selection criteria
Output customization
Algorithm:
Get master data for matching business locations or read point
Output:
<Location description>

How long have assets stayed at each location?
User inputs:
Time horizon
Business location
Asset selection criteria
Output customization
Outlier criteria (optional): limit report to show assets that have stayed longer than some threshold
Algorithm:
Get events where T>=horizon, EPC matches asset selection criteria
Find maximal segments E1 . . . *En where E1 . . . *En has a business location matching specified business location (could be a child), and E(n+1) does not.
Dwell time is T(n+1)−T1
Output:
<Asset description> <Dwell time>

How long have assets take to go from point A to point B?
User inputs:
Time horizon
Read point A
Read point B
Asset selection criteria
Output customization
Outlier criteria (optional): limit report to show assets that have taken longer than some threshold
Algorithm:
Get events where T>=horizon, EPC matches asset selection criteria
Blah (TBD)

Exception-Oriented Reports

These can to be very similar to other reports, just with threshold criteria to select which data to show. E.g., “what assets sat too long” is basically a dwell time report showing only assets that dwelt longer than a specified interval. The inputs and outputs, however, may turn out to benefit from tailoring to the exception-oriented use cases.

Input and Output Features Common to all Reports

A key component of making reporting user friendly is to ask for input in customer-oriented terms, and likewise present output in those terms. This means using descriptive names instead of URIs, combinations of inputs/outputs derived by considering the business intent of the report rather than how it relates to the structure of the underlying data, etc. Master data can play a key role in providing user-facing representations of data elements (in both input and output).

Asset Selection Criteria:
“All assets”
Specific EPCs
Specific EPC classes
Specific category identifiers (MD hierarchy)
General predicate on MD attributes

Location Selection Criteria
“All locations”
Specific locations—would like to choose from list of available locations at each hierarchy level
General predicate on MD attributes

Output Customization—<Asset Description>

Elect any Combination of:
EPC
EPC Class
Specified MD attribute of EPC
Specified MD attribute of EPC class

Output Customization—<Location Description>
Select any Combination of:
Location identifier
Specified MD attribute of location

Can also ask to uplevel location identifier to specified level in hierarchy.

The EPCIS Service can be defined by the EPCglobal EPCIS Specification Version 1.0 Working Draft (17 Jan. 2006).

As defined in the EPCglobal EPCIS Specification, the EPCIS Service can be composed of 3 main components:
EPCIS Capture Interface
EPCIS Query Interface
Master Data Service

The EPCIS Capture Interface can provide the ability to capture and persist EPCIS Events. The capture interface can be exposed as a JMS Queue and a SOAP interface.

The EPCIS Query Interface supports querying the repository of EPCIS Events based on a query and associated query parameters. A Query can define what and how the query is executed, where the Query Parameters can provide values for variables defined by the Query.

Query Parameters include: time constraints, Event Types, Event fields, action, disposition, and Master Data name value attributes. Synchronous and Asynchronous Queries can be supported through polling and subscription mechanisms. Queries for MasterData Vocabulary Elements can also be supported. The Query Interface can be exposed as a SOAP interface.

The EPCIS Query Interface can provide administration methods for Subscription creation, lookup, and removal.

The EPCIS Event Object model to reflect changes in the EPCglobal EPCIS

Specification. Modification can include:
Removal of GUID from EPCISEvent class.
Addition of the BusinessTransaction class and reference to instances of this class from the BusinessTrasaction EPCIS Event field.

Updates to the EPCIS Capture Interface:
Modify the EPCIS capture interface to support the capture of a List of EPCIS Events.

The EPCIS Query Interface as defined by the EPCglobal EPCIS Specification (Working Draft, Jan. 17, 2006) can be supported. The EPCIS Query Interface is a SOAP Service specified defined by a WSDL and set of XSD files. This is an update to the existing EPCIS Query Interface provided by the ES1.0 and ES1.1 versions of the EPCIS Service. The main differences are:
Support for subscription based report generation in addition to polling.
Support for query extensions that specify Master Data name value pairs.
Support for creation, lookup, and removal of EPCIS Query Subscriptions.

A subscription based report generation can allow consumers of the EPCIS Service to subscribe to the EPCIS Query service for asynchronous EPCIS report delivery. The EPCIS Query Interface can be extended to support subscription lifecycle management, including subscription creation, lookup and removal. The EPCIS Query Interface can continue to support synchronous generation of EPCIS reports through the use of a Poll( ) Method. A subscription can be defined by a query and a corresponding set of query parameters that provide values for the variable parts of the query. A subscription can also include an endpoint URL that identifies the subscriber and delivery transport. In addition, a subscription contains subscription controls that determine when a report should be generated. As specified by the EPCglobal EPCIS1.0 Specification, only two predefined Queries can be supported: SimpleEventQuery and SimpleMasterDataQuery. Dynamic definition of queries need not be supported. The SimpleEventQuery can provide the ability to query for EPCIS Events. Query Parameters can include time constraints, event type, action, disposition and all EPCIS event fields. EPCIS Event Fields can be specified in terms of MasterData name value pairs for matching Vocabulary Elements. The SimpleMasterDataQuery can provide the ability to query for Master Data Vocabulary Elements (instances of Vocabulary Types). The SimpleMasterDataQuery need only supported through the Poll interface. Attempts to subscribe to a SimpleMasterDataQuery can result in a SubscribeNotPermittedException.

Additional query parameters that specify search criteria, specifically name value pairs of associated Master Data Vocabulary Attributes can be supported. The ability to include Master Data as part of the query can require EPCIS Service integration with the Master Data Service.

Where an EPCClass is an EPCPattern or EPC in pure identity form. The EPCIS Service can be detected when an EPCClass is specified as a query parameter and look for EPCIS Events with associated EPCs or EPCClasses that match the given EPCClass. A match can be detected when the extent defined by the given EPCClass encompasses the EPCs or EPCClasses associated with an EPCIS Event.

Information about existing subscriptions can be persisted. Restarting the EPCIS Service can result in reactivation of any subscriptions that were active prior to the Service restart.

QueryResults can contain the results of an EPCIS Event Query. The QueryResults can be returned synchronously through an invocation of the Poll method, or asynchronously as the result of an active Subscription. The following means can supported for asynchronous delivery of QueryResults:
HTTP Notification
HTTPS Notification
JMS Notification Topic or Queue
AS2 Notification

In all delivery mechanisms, the content can be transferred in XML format as specified by the EPCIS XML Schema definition.

A Management Bean (M Bean) can provide a management bean for programmatic configuration and control of the EPCIS Event Capture/Query Service and associated Subscription Service.

If the Master Data Service supports connections to External Data Sources, the EPCIS Query interface can be able to leverage this feature as is.

Synchronous Report Generation can be done.

A consumer of the EPCIS Query Interface can use the Poll method to generate and return an EPCIS Event report. The user can pass the name of the query and associated query parameters to constrain query results. The Query Results can be returned to the caller as a list of EPCISEvents for a SimpleEventQuery or as a list of Vocabulary Elements for a SimpleMasterDataQuery.

Asynchronous Report Generation can also be done.

A client of the EPCIS Query Interface can use the Subscribe (method to set up a subscription to a report. The QueryResults can be delivered to the destination URI specified in the Subscribe request. The Subscription Controls can determine the time and frequency of report generation as well as the delivery transport. The selected Query and specified QueryParameters can control the contents of the QueryResults. The given subscription identifier can provide a way to reference the subscription.

A consumer of the EPCIS Query Interface can receive asynchronous delivery of EPCIS Event Queries in the form of QueryResults. In the case of a SimpleEventQuery, the QueryResultscan contain a list of EPCIS Events. Asynchronous delivery of SimpleMasterDataQuery is not supported.

A client of the EPCIS Query Interface can remove a subscription by calling the

Unsubscribe (method on the EPCIS Query interface, passing in the subscription identifier provided when the subscription was created. This canresult in subscription termination, and removal of the subscription from the persistent store.

The client augment the QueryParameters with name value pairs of MasterData to further constrain QueryResults.

The client can define a SimpleEventQuery specifying the Query Parameter for the EPCIS Event EPCs as an EPCClass. The contents of the QueryResult can then be restricted to EPCIS Events that have associated EPCs that match the specified EPCClass.

The EPCIS Reports client can use the SimpleMasterDataQuery to poll for Vocabulary Elements of a specific Vocabulary Type with matching attribute name value pairs. A list of matching Vocabulary Elements can be returned. The returned vocabulary types may be used to resolve EPCIS Event Field URIs, for example, business location URIs with descriptive location name in the resulting report.

The EPCIS Capture Service can support the capture of EPCIS Events through via a JMS Queue and a SOAP interface. One or more EPCIS Events may be captured at a time.

The EPCIS Query Service can support the public interface for the synchronous and asynchronous query of EPCIS Event information.
Return a list of available query names
Subscribe to a Query for asynchronous notification
Unsubscribe from an existing query
Poll for synchronous query response
Return a list of active Subscription Ids
Return a Subscription for a given Subscription ID (Note: this is currently missing from the EPCIS Spec)
Return the EPCIS Event Service standard (EPCglobal) and vendor (BEA) version

The EPCIS Query interface can support access to its interfaces through the following mechanisms.
SOAP Interface
Web based user interface (defined in a separate document: ES 2.0 EPCIS Query User Interface Design)

Non public access to EPCIS Query interface can be provided by the following interfaces:
Java API
Command Line Interface (CLI)
EJB Session Bean
Management Bean

The EPCIS Service can be composed of the following implementation components:
Java API (set of Java classes that define a canonical representation of EPCIS Events and MasterData)
Converters to support conversion between Java API, WLS generated SOAP classes, and JDO classes.
EJB Session Bean (common entry point for implementation of public interfaces providing transaction and threading management).
Server side implementation object (provides the service implementation delegated to by the EJB Session Bean)
WLS SOAP Service (client and server bindings/implementations for SOAP Service)
JMS (client and server bindings/implementations for EPCIS Event Capture)
Persistence Object Layer based on Java Data Objects (JDO), provides object to relational database mapping.
Relational Database Schema
EPCIS Query User Interface based on Java Server Faces and WLS Light Weight Portal Framework
CLI, command line interface for scripting access to EPCIS Event Capture/Query Service

The Enterprise Server can be deployed as a WLS application on an application server in the form of an expanded ear file. The EPCIS Query Service can be a subset of the public interface supplied by the EPCIS Event Service. The EPCIS Event Service can be deployed as a service within the Enterprise Server. The Master Data Service can be a sibling of the EPCIS Event Capture/Query Service. The EPCIS Event Capture/Query Service is intended to be configured as a client of the Master Data Service.

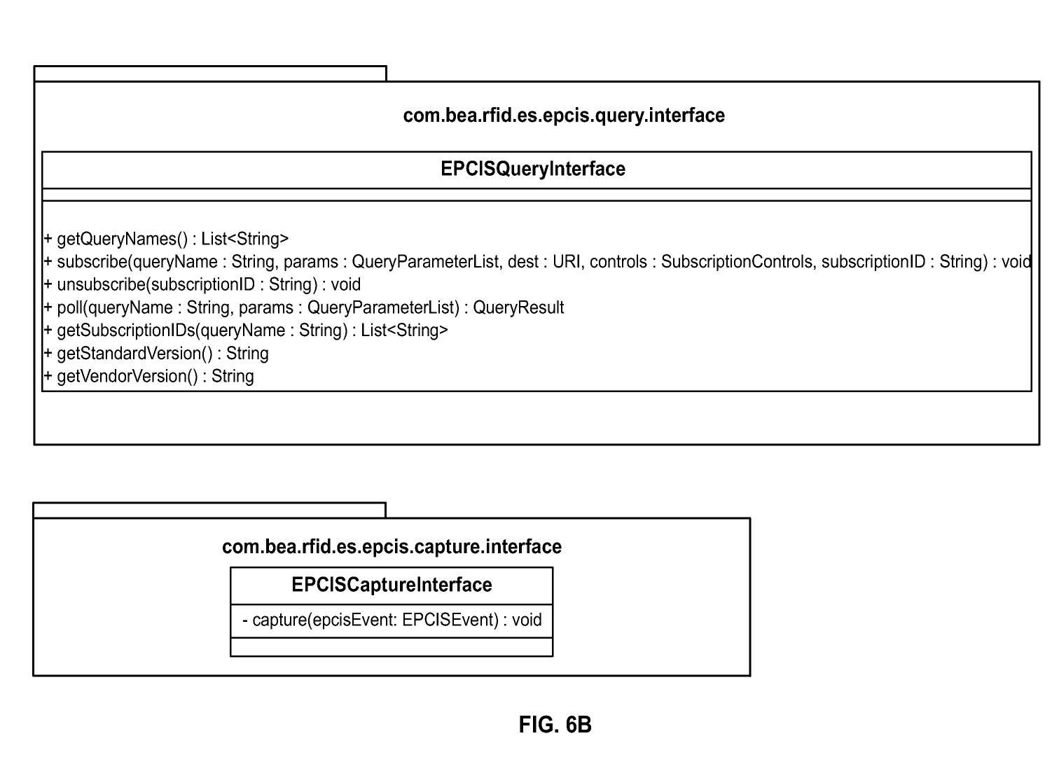

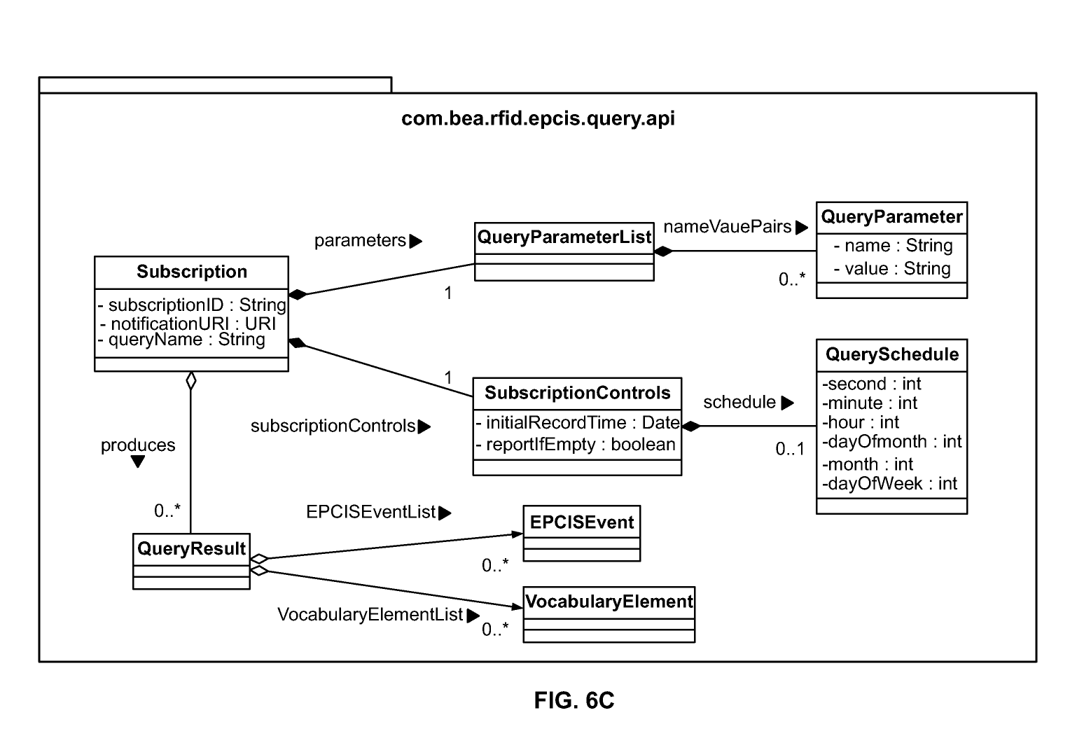

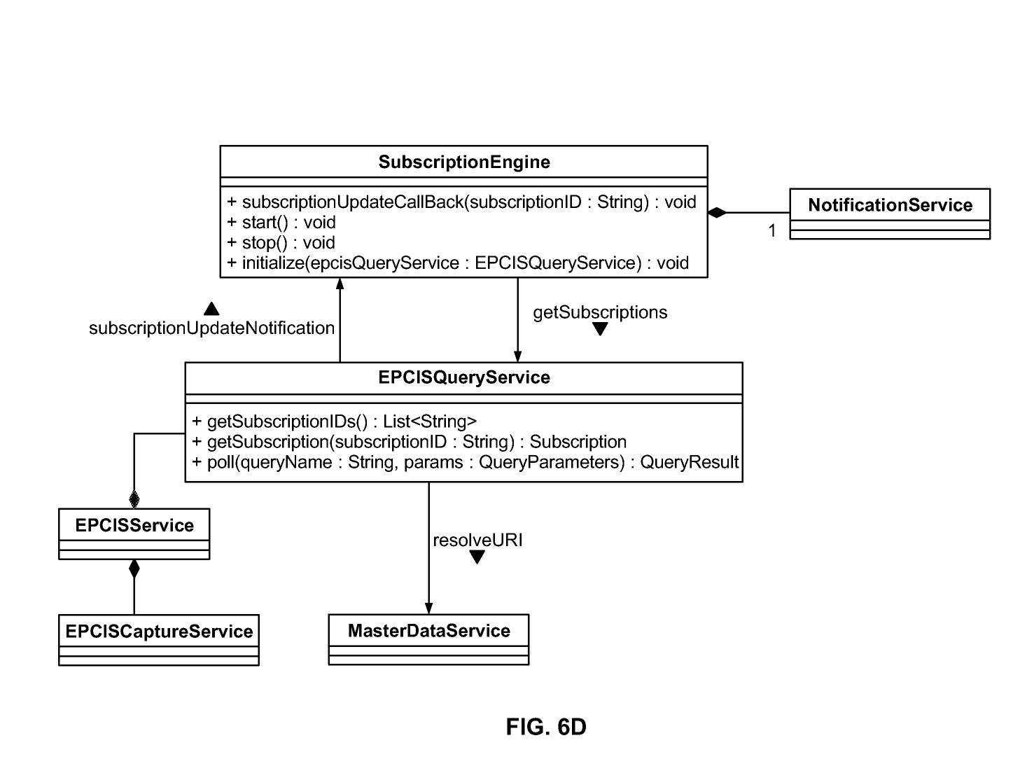

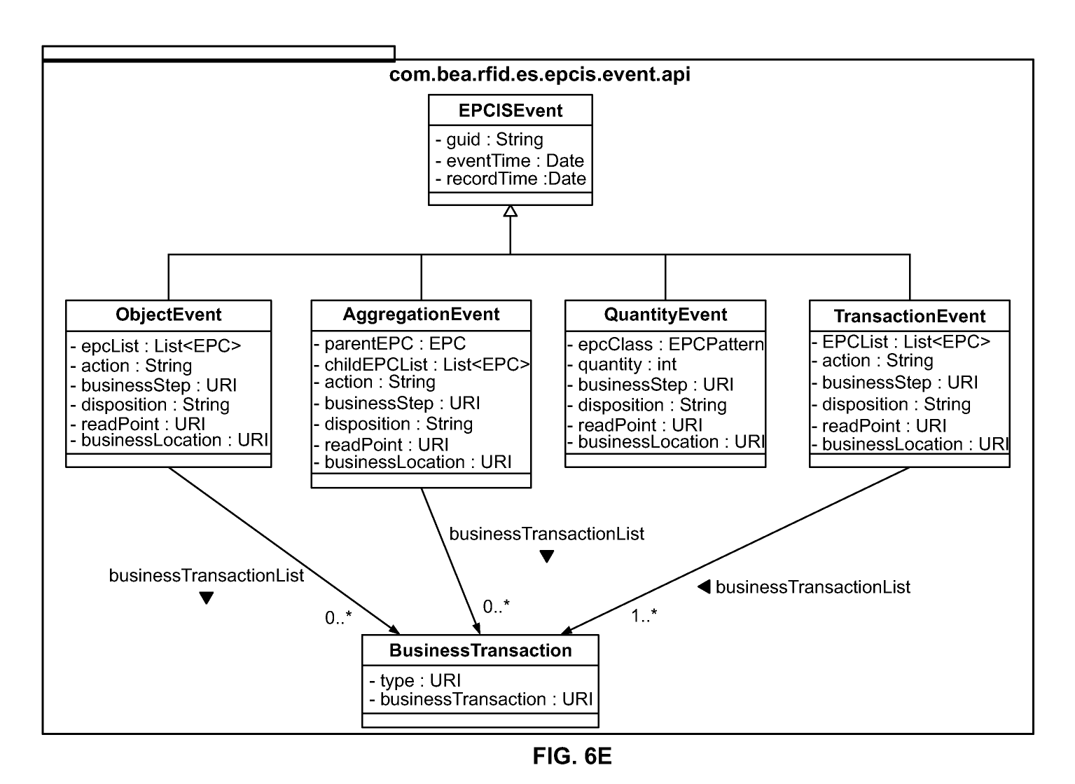

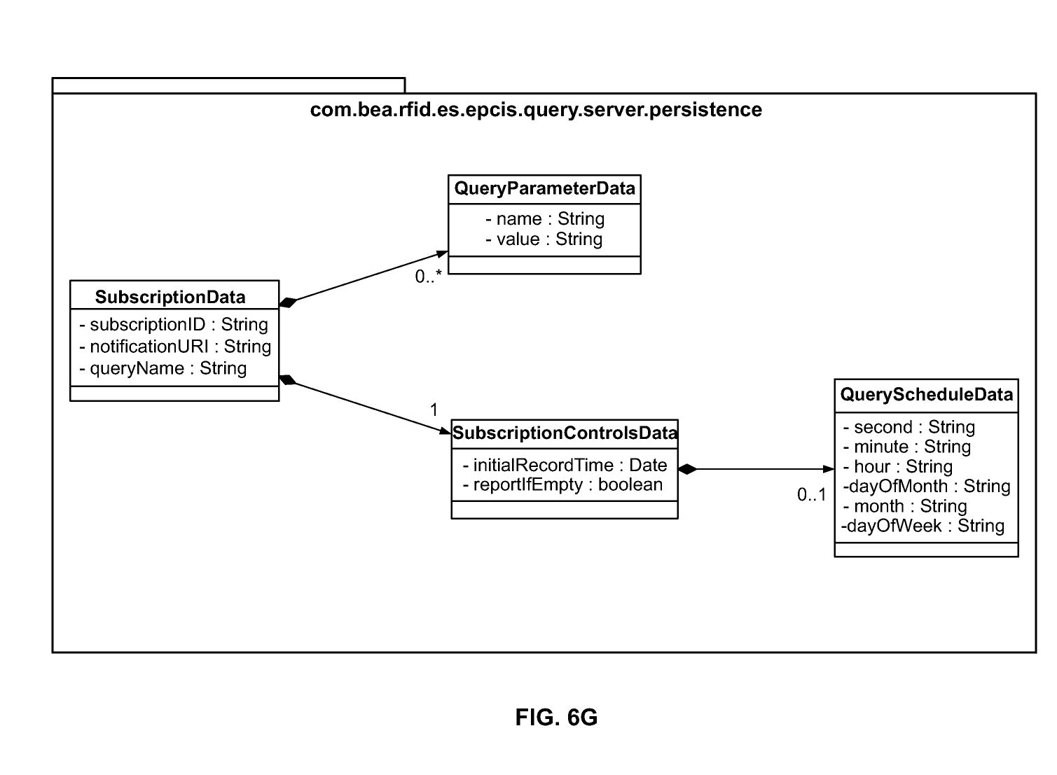

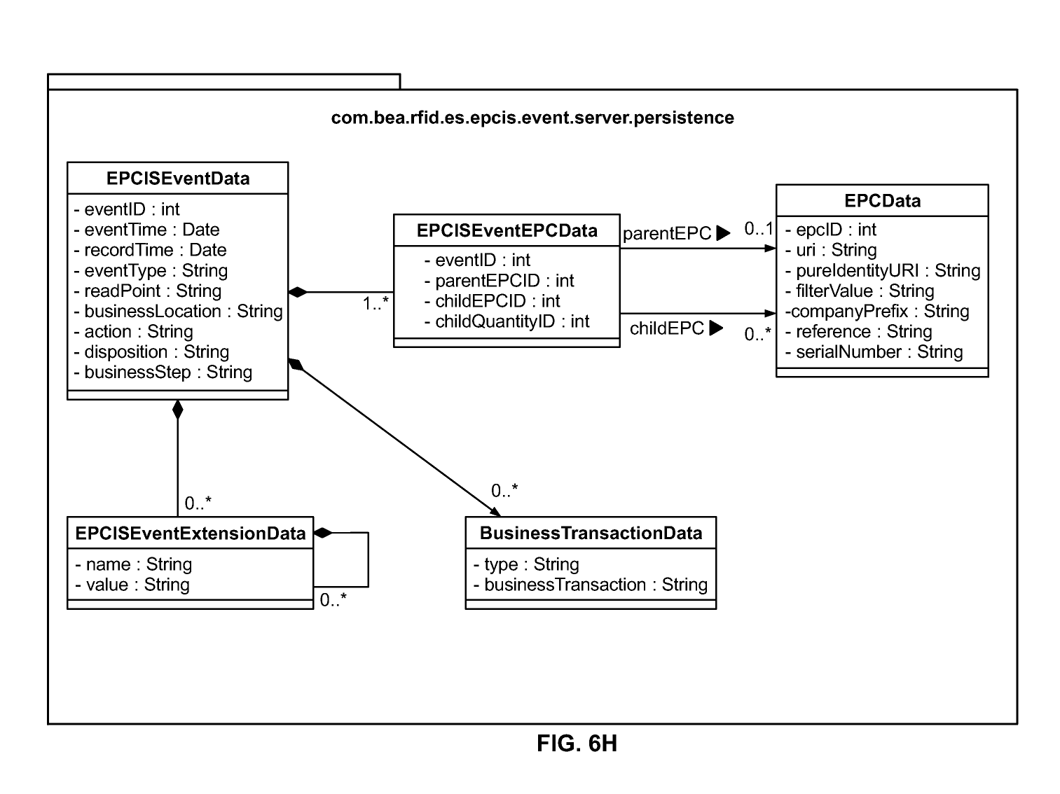

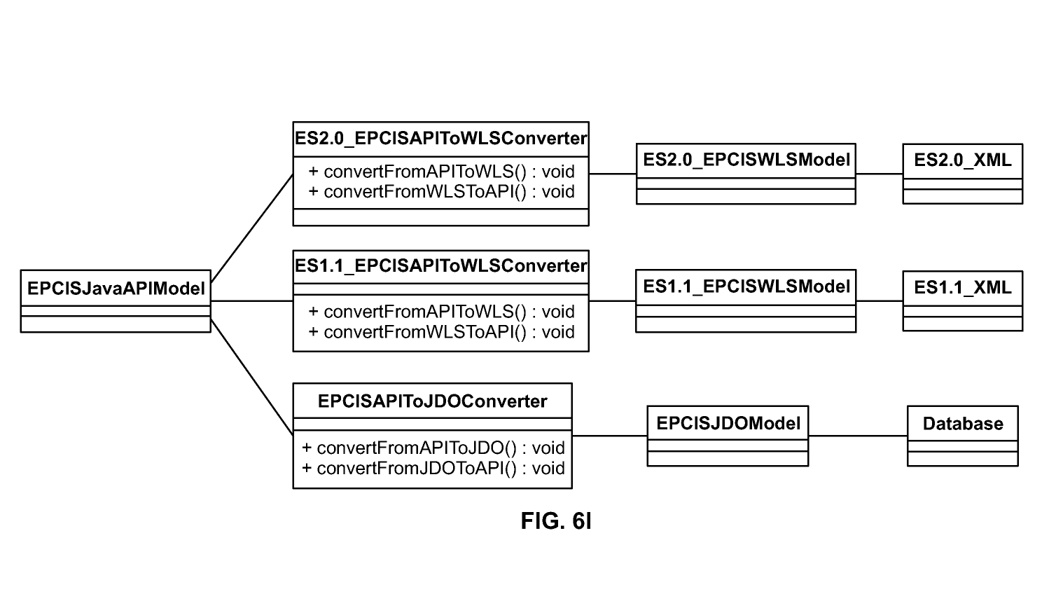

The Query Service can be implemented following the standard service implementation model previously used by the ES1.1 EPCIS Service. FIG. 6A outlines the EPCIS Service implementation components including sibling MasterData ServiceX

On embodiment has 6 main components for the EPCIS Event Capture and Query Service.
EPCIS Query Interface
EPCIS Query API Model
EPCIS Event API Model
EPCIS Query Subscription Module
EPCIS Master Data Interface
EPCIS Master Data API Model

The EPCIS Query Interface can define the methods exposed by the EPCIS Service to support Polling and Subscription management. The EPCIS Query API Model can define the classes that represent subscriptions and associated information. The EPCIS Event API Model can define the classes that represent the EPCIS Events. The EPCIS Query Subscription Module defines the mechanism for asynchronous report delivery. The EPCIS MasterData Interface and API Model define the interface and classes for management of Vocabulary Types and Vocabulary Elements. Master Data can provide supporting information for EPCIS Events, allowing resolution of the URIs specified by the EPCIS Event attributes: business step, disposition, read point, business location, and business transaction. Master data can also be referenced indirectly through Event Extension Data attached to an EPCIS Event. Master Data can be covered in a separate design document.

The EPCIS Query Interface can support the management of subscriptions, a synchronous polling mechanism, and methods for determining the standard and vendor specific version numbers.

The following methods can be be supported by the EPCIS Query Interface:
getQueryNames( ): List<String>
Returns a list of all query names previously defined with define and not yet undefined.
Throws:
SecurityException: Access control violation
ImplementationException: Implementation specific exception
subscribe(queryName : String, params : QueryParameters, dest : URI, controls
SubscriptionControls, subscriptionID : String) : void
Registers a subscriber for a previously defined query having the specified name. The params argument provides the values to be used for any named parameters embedded in the definition of the query. The dest parameter specifies a destination where results from the query are to be delivered. The controls parameter controls how the subscription is to be processed; in particular, it specifies the conditions under which the query is to be invoked (e.g., specifying a periodic schedule). The subscriptionID is an arbitrary string that is copied into every response delivered to the specified destination, and otherwise not interpreted by the EPCIS service. The client may use the subscriptionID to identify from which subscription a given result was generated, especially when several subscriptions are made to the same destination.
Throws:
NoSuchNameException : Specified query does not exist
InvalidURIException : The URI specified for the subscriber cannot be parsed.
DuplicateSubscriptionException: The specified Subscription ID is identical to a previous subscription that was created and not yet unsubscribed.
QueryParameterException : One or more query parameters are invalid.
QueryTooComplexException : Either the query or the query parameters exceeded the abilities of the implementation.
SubscriptionControlsException : Invalid SubscriptionControls
SubscribeNotPermittedException : The specified query is not supported with subscribe, only poll.
SecurityException : Access control violation
ImplementationException : Implementation specific exception
unsubscribe(subscriptionID: String): void
Removes a previously registered subscription having the specified subscriptionID.
Throws:
NoSuchSubscriptionException : Specified Subscription ID does not exist
SecurityException : Access control violation
ImplementationException : Implementation specific exception
poll(queryName : String, params : QueryParameters) : QueryResult
Invokes a previously defined query having the specified name, returning the results. The params argument provides the values to be used for any named parameters embedded in the definition of the query.
Throws:
NoSuchSubscriptionException : Specified Subscription ID does not exist
QueryParameterException : One or more query parameters are invalid.
QueryTooComplexException : Either the query or the query parameters exceeded the abilities of the implementation.
QueryTooLargeException : The query resulted in too much data.
SecurityException : Access control violation
ImplementationException : Implementation specific exception
getSubscriptionIDs(queryName : String) : List<String>
Returns a list of all subscriptionIDs currently subscribed to the specified named query.
Throws:
NoSuchNameException : Specified query does not exist
SecurityException : Access control violation
ImplementationException : Implementation specific exception
getSubscription (subscriptionID : String) : Subscription
Returns the subscription with matching subscription ID.
Throws:
NoSuchNameException : If no subscription with matching subscription ID exist.
SecurityException : Access control violation
ImplementationException : Implementation specific exception
getStandardVersion( ) : String
Returns a string that identifies what version of the specification this implementation complies with. The possible values for this string are defined by EPCglobal. To indicate compliance with this Version 1.0 of the EPCIS specification, the implementation SHALL return the string 1.0.
getVendorVersion( ) : String
Returns a string that identifies what vendor extensions this implementation provides. The possible values of this string and their meanings are vendor-defined, except that the empty string SHALL indicate that the implementation implements only standard functionality with no vendor extensions. When an implementation chooses to return a non-empty string, the value returned SHALL be a URI where the vendor is the owning authority. For example, this may be an HTTP URL whose authority portion is a domain name owned by the vendor, a URN having a URN namespace identifier issued to the vendor by IANA, an OID URN whose initial path is a Private Enterprise Number assigned to the vendor, etc.

Exemplary Query Types include SimpleEventQuerry, SimpleMasterDataQuerry and CurrentAggregationQuery. The resulting Query Result contains a set of EPCIS Events matching the given QueryParameters.

For SimpleMasterDataQuery

The resulting QueryResult contains a set of VocabularyElements matching the given QueryParameters.

CurrentAggreationQuery can be used to determine the current child elements associated with a given parent. It can return a QueryResult object that includes a CurrentAggregation instance. The CurrentAggregation can contain a list of EPCs that define the current EPCs associated with the AggregationEvents that match the query parameters. Current EPCS for a given parent EPC can be all EPCs that have been added to the parent and not removed since the last de-aggregation event (i.e. AggregationEvent with Action equal to Delete and an empty child EPC list). If there is no de-aggregation event, then all Aggregation events for the parent EPC can be used. The CurrentAggregation object can also includes a list of all EPCIS Events up to but not including the last de-aggregation event. Note that depending on the given queryParameters, the EPCIS Events of multiple parent EPCs may be aggregated together. This could happen if the parentEPC was not specified, but some other event field was used to identify the currentAggregation (e.g. OrderNumber as part of the BusinessTransaction field). In this situation, the list of child EPCs would also be a composite of multiple parent EPCs.

```
Current Aggregation
{
    childEPCList : List<EPC>
    epcisEventList : List<AggregationEvent>
```

The EPCIS Query Object model of FIG. 6C defines the Subscription and associated classes, including QueryParameterList, QueryParameter, SubscriptionControls, QuerySchedule, and QueryResult.

QueryParameters can be a Container for a set of QueryNameValue instances.

| Attribute | Type | Description |
|---|---|---|
| queryNameValueList | List<QueryNameValue> | List of |
| | | QueryNameValue |
| | | instances. |

QueryNameValue can be a Name value pair that defines a single Query Parameter.

| Attribute | Type | Description |
|---|---|---|
| name | String | Unique name that identifies a query |
| | | parameter variable. |
| value | String | Value to be used in place of the |
| | | associated query variable. |

The QueryResult can be a container for the list of EPCIS Events resulting from an invocation of the associated query and set of query parameters.

| Attribute | Type | Description |
|---|---|---|
| objectList | List<Object> | A list of EPCISEvents when |
| | | returned from |
| | | SimpleEventQuery, or a list of |
| | | VocabularyElements when |
| | | returned from a |
| | | SimpleMasterDataQuery. |

Subscription can define an instance of a Query Subscription for the asynchronous generation of EPCIS Reports.

| Attribute | Type | Description |
|---|---|---|
| Id | String | Unique identifier for the |
| | | subscription. |
| notificationURI | URI | URI that identifies the |
| | | receiver for the |
| | | subscription. |
| queryName | String | Name that identifies the |
| | | Query to be applied. Either |
| | | “SimpleEventQuery” or |
| | | “SimpleMasterDataQuery”. |

Standing queries can be subscribed to via the subscribe method. For each subscription, a SubscriptionControls instance defines how the query is to be processed.

| Attribute | Type | Description |
|---|---|---|
| schedule | QuerySchedule | (Optional) Defines the periodic |
| | | schedule on which the query is |
| | | to be executed. See Section. |
| | | Exactly one of schedule or |
| | | trigger SHALL be |
| | | specified, but not both. |
| trigger | URI | (Optional) Specifies a |
| | | triggering event known to the |
| | | EPCIS service that can serve to |
| | | trigger execution of this query. |
| | | The available trigger URIs are |
| | | service-dependent. Exactly one |
| | | of schedule or trigger |
| | | SHALL be specified, but not |
| | | both. |
| initialRecordTime | Time | (Optional) Specifies a time |
| | | used to constrain what events |
| | | are considered when processing |
| | | the query when it is executed |
| | | for the first time. If omitted, |
| | | defaults to the time at which the |
| | | subscription is created. |
| reportIfEmpty | Boolean | If true, a QueryReports instance |
| | | is always sent to the subscriber |
| | | when the query is executed. If |
| | | false, a QueryReports instance |
| | | is sent to the subscriber only |
| | | when the results are non-empty. |

A QuerySchedule can be specified to specify a periodic schedule for query execution for a specific subscription. Each field of QuerySchedule is a string that specifies a pattern for matching some part of the current time. The query can be executed each time the current date and time matches the specification in the QuerySchedule. Each QuerySchedule field is a string, whose value conforms to the following grammar:

X QueryScheduleField ::= Element ( “,” Element )*
Element ::= Number | Range
Range ::= “[“ Number “−“ Number “]”
Number ::= Digit+
Digit ::= “0” | “1” | “2” | “3” | “4”
| “5” | “6” | “7” | “8” | “9”

| Attribute | Type | Description |
|---|---|---|
| second | Integer | (Optional) Specifies that the query time has a |
| | | matching second's value. The range for this |
| | | parameter is 0 through 59, inclusive. |
| minute | Integer | (Optional) Specifies that the query time has a |
| | | matching minute value. The range for this |
| | | parameter is 0 through 59, inclusive. |
| hour | Integer | (Optional) Specifies that the query time has a |
| | | matching hour value. The range for this parameter |
| | | is 0 through 23, inclusive, with 0 denoting the |
| | | hour that begins at midnight, and 23 denoting |
| | | the hour that ends at midnight. |
| dayOfMonth | Integer | (Optional) Specifies that the query time has a |
| | | matching day of month value. The range for this |
| | | parameter is 1 through 31, inclusive. (Values of |
| | | 29, 30, and 31 can only match during months that |
| | | have at least that many days.) |
| month | Integer | (Optional) Specifies that the query time has a |
| | | matching minute value. The range for this |
| | | parameter is 1 through 12, inclusive. |
| dayOfWeek | Integer | (Optional) Specifies that the query time has a |
| | | matching day of week value. The range for this |
| | | parameter is 1 through 7, inclusive, with 1 |
| | | denoting Monday, 2 denoting Tuesday, and so |
| | | forth, up to 7 denoting Sunday. |

The implementation of the EPCIS Event queries can detect when EPC query parameters are defined as an EPCClass and modify the search to include SQL constraints referring to the associated columns of the EPC table.

The Subscription Module can provide the mechanism for the generation and delivery of EPCIS Reports. The primary components of the Subscription Module include the Subscription Engine and Notification Service. The Subscription Engine can be a client of the EPCISQuery Service. The Subscription Engine can use the public interfaces exposed by the EPCISQueryService to determine the set of active subscriptions. Management and Persistence of Subscription information can be managed by the EPCIS Query Service.

FIG. 6D shows a EPCIS Query Service and Subscription Engine Object Model of one embodiment.

On initialization, the Subscription Engine can use the EPCIS Query interface to determine the current set of active Subscriptions. To keep the set of Subscriptions in synch between the Subscription Engine and the EPCIS Query Service, the EPCIS Query Service can notify the Subscription Engine of Subscription changes. The EPCIS Query Service can pass the subscription ID of the modified subscription to the Subscription Engine. The subscription Engine can then use the getSubscrition(id) method to get the Subscription details from the EPCIS Query Service and update its own state appropriately. Changes to Subscriptions can include creation, modification and removal.

The Subscription Engine can use the EPCISQuery Service to determine the set of active Subscriptions. For each Subscription, reports can be generated based on the Subscription Controls and Query Schedule. When the Subscription Engine determines that it is time to execute a query, it can do so by delegating to the EPCISQueryService poll( ) method. Interaction between the Subscription Engine and the EPCIS Query Service can be through the EJB Session Interface exposed by both objects.

Once a report is generated, the Subscription Engine can deliver the QueryResults by delegating to the Notification Service. The Edge Server Notification Service wicanll be reused to send Query Results to subscribers. The transports currently supported by the Notification Service can be supported.

The Java API can define a canonical representation for the manipulation of EPCIS Event instances. This extends the existing EPCIS Event classes. The EPCIS model can remain for the most part unchanged, except in cases where the EPCglobal EPCIS Specification has changed. The changes are:
Removal of the GUID attribute from the EPCISEvent class.
Addition of BusinessTransaction class, to replace previous BusinessTransaction Field URI List. This change affects the ObjectEvent, AggregationEvent and TransactionEvent classes.

The Object Model of FIG. 6E describes the EPCIS Event types as defined by the EPCglobal EPC Information Services (EPCIS) Version 1.0 Specification.

The Java API can support serialization and de-serialization to and from XML. A factory object can provide methods for creating instances of the Java API objects, the constructors can be package private.

The EPCIS EJB Session Bean can implement the interface defined by the EPCIS and EPCIS Query Java API and provides an aggregation point for all external interfaces (SOAP and JSF). The WLS application server can provide thread and transaction management for the Master Data Session Bean. The Session Bean can delegate to an implementation object to perform the work of each operation. The EPCIS Query SOAP Service, User Interface and Message Driven Bean (MDB) can interact directly with the local interface of the EPCIS EJB Session bean.

The JDO Persistence Layer can provide the object to relational mapping required for persisting objects to the database. The layer can define an implementation of the Master Data Java API. A mapping class can support the transformation between Java API instances and Java Data objects.

FIG. 6G shows an EPCIS Query JOD Implementation Model of one embodiment.

The JDO model, the ID attributes are defined as Strings, where in the Java API model they are defined as URIs. This is to support the JDO mapping to the Database tables.

FIG. 6H shows a EPCIS Event JOD Implementation Model 9 with new Business TransactionsData class) or one embodiment.

The architecture can require different representations of the objects as they are marshaled through the system. One embodiment has 4 object representations:

| | |
|---|---|
| Java API | Canonical representation |
| WLS | Weblogic objects used by SOAP layer |
| JDO | Java Data Objects used in persistence layer |
| XML | XML representation, product of WLS serializers |

FIG. 6I shows Object Encodings with converters of one embodiment.

For backward compatibility, there can be 2 EPCIS API to WLS Converters, one for ES 2.0 XML and another for ES1.1 XML. Users can access the EPCIS Query Service through the CLI, the Java API, SOAP interface or the Web based user interface. The SOAP interface and Web based user interface can be publicly available.

In one Conversion Example the CLI interacts with Java API objects. Using the EPCISAPIToWLSConverter, the Java API objects are transformed to WLS generated classes that marshal the objects through the SOAP interface. Once on the server, the EPCISAPIToWLSConverter converter is used to transform the WLS objects back to JavaAPI objects. The EPCISAPIToJDOConverter supports conversion to JDO classes. The JDO classes are used to persist the objects to the relational database.

The WSDL that defines the SOAP Interface for the EPCIS Query interface can be defined by the 17 Jan. 2006 version of the EPCglobal EPCIS Working Draft specification

The following is a Web Service Definition Language (WSDL) 1.1 [WSDL1.1] specification defining the standard SOAP binding of the Core Query Operations module of one embodiment. An EPCIS implementation MAY provide a SOAP binding of the Core Query Operations Module; if a SOAP binding is provided, it SHALL conform to the following WSDL. This SOAP binding is compliant with the WS-i Basic Profile Version 1.0 [WSI].

The schema definition can follow the EPCIS XSD defined in the EPCglobal EPCIS Specification version 1.0.

The following is an XML Schema (XSD) defining for the Core Event Types data definition module.

```
<?xml version=“1.0” encoding=“UTF-8”?>
<xsd:schema xmlns:epcis=“urn:epcglobal:epcis:xsd:1”
xmlns:sbdh=“http://www.unece.org/cefact/namespaces/StandardBusinessDocumentHeader”
xmlns:epcglobal=“urn:epcglobal:xsd:1” xmlns:xsd=“http://www.w3.org/2001/XMLSchema”
targetNamespace=“urn:epcglobal:epcis:xsd:1” elementFormDefault=“unqualified”
attributeFormDefault=“unqualified” version=“1.0”>
  <!-- Spec based on WD-epcis-20050608.doc -->
  <xsd:annotation>
    <xsd:documentation xml:lang=“en”>
      <epcglobal:copyrighr>Copyright (C) 2005, 2004 EPCglobal Inc., All Rights
Reserved.</epcglobal:copyright>
      <epcglobal:disclaimer>EPCglobal Inc., its members, officers, directors,
employees, or agents shall not be liable for any injury, loss, damages, financial or otherwise,
arising from, related to, or caused by the use of this document. The use of said document shall
constitute your express consent to the foregoing exculpation.</epcglobal:disclaimer>
      <epcglobal:specification>EPC INFORMATION SERVICE (EPCIS) Version
1.0</epcglobal:specification>
    </xsd:documentation>
  </xsd:annotation>
  <xsd:import namespace=“urn:epcglobal:xsd:1” schemaLocation=“./EPCglobal.xsd”/>
  <xsd:import
namespace=“http://www.unece.org/cefact/namespaces/StandardBusinessDocumentHeader”
schemaLocation=“./StandardBusinessDocumentHeader.xsd”/>
  <!-- EPCIS CORE ELEMENTS -->
  <xsd:element name=“EPCISDocument” type=“epcis:EPCISDocumentType”/>
  <xsd:complexType name=“EPCISDocumentType”>
    <xsd:annotation>
      <xsd:documentation xml:lang=“en”>
      document that contains a Header and a Body.
      </xsd:documentation>
    </xsd:annotation>
    <xsd:complexContent>
      <xsd:extension base=“epcglobal:Document”>
        <xsd:sequence>
          <xsd:element name=“EPCISHeader”
type=“epcis:EPCISHeaderType” minOccurs=“0”/>
          <xsd:element name=“EPCISBody” type=“epcis:EPCISBodyType”/>
          <xsd:element name=“extension”
type=“epcis:EPCISDocumentExtensionType” minOccurs=“0”/>
          <xsd:any namespace=“##other” processContents=“lax”
minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“EPCISHeaderType”>
    <xsd:annotation>
      <xsd:documentation xml:lang=“en”>
      specific header(s) including the Standard Business Document Header.
      </xsd:documentation>
    </xsd:annotation>
    <xsd:sequence>
      <xsd:element ref=“sbdh:StandardBusinessDocumentHeader”/>
      <xsd:any namespace=“##other” processContents=“lax” minOccurs=“0”
maxOccurs=“unbounded”/>
    </xsd:sequence>
    <xsd:anyAttribute processContents=“lax”/>
  </xsd:complexType>
  <xsd:complexType name=“EPCISBodyType”>
    <xsd:annotation>
      <xsd:documentation xml:lang=“en”>
      specific body that contains EPCIS related Events.
      </xsd:documentation>
    </xsd:annotation>
    <xsd:sequence>
      <xsd:element name=“EventList” type=“epcis:EventListType” minOccurs=“0”/>
      <xsd:element name=“extension” type=“epcis:EPCISBodyExtensionType”
minOccurs=“0”/>
      <xsd:any namespace=“##other” processContents=“lax” minOccurs=“0”
maxOccurs=“unbounded”/>
    </xsd:sequence>
    <xsd:anyAttribute processContents=“lax”/>
  </xsd:complexType>
  <!-- EPCIS CORE ELEMENT TYPES -->
  <xsd:complexType name=“EventListType”>
    <xsd:choice maxOccurs=“unbounded”>
      <xsd:element name=“ObjectEvent” type=“epcis:ObjectEventType”/>
      <xsd:element name=“AggregationEvent” type=“epcis:AggregationEventType”/>
      <xsd:element name=“QuantityEvent” type=“epcis:QuantityEventType”/>
      <xsd:element name=“TransactionEvent” type=“epcis:TransactionEventType”/>
      <xsd:element name=“extension” type=“epcis:EPCISEventListExtensionType”/>
      <xsd:any namespace=“##other” processContents=“lax”/>
    </xsd:choice>
  </xsd:complexType>
  <xsd:complexType name=“EPCListType”>
    <xsd:sequence>
      <xsd:element name=“epc” type=“epcglobal:EPC” minOccurs=“0”
maxOccurs=“unbounded”/>
    </xsd:sequence>
  </xsd:complexType>
  <xsd:simpleType name=“ActionType”>
    <xsd:restriction base=“xsd:string”>
      <xsd:enumeration value=“ADD”/>
      <xsd:enumeration value=“OBSERVE”/>
      <xsd:enumeration value=“DELETE”/>
    </xsd:restriction>
  </xsd:simpleType>
  <xsd:simpleType name=“ParentIDType”>
    <xsd:restriction base=“xsd:anyURI”/>
  </xsd:simpleType>
  <!-- Standard Vocabulary -->
  <xsd:simpleType name=“BusinessStepIDType”>
    <xsd:restriction base=“xsd:anyURI”/>
  </xsd:simpleType>
  <!-- Standard Vocabulary -->
  <xsd:simpleType name=“DispositionIDType”>
    <xsd:restriction base=“xsd:anyURI”/>
  </xsd:simpleType>
  <!-- User Vocabulary -->
  <xsd:simpleType name=“EPCClassType”>
    <xsd:restriction base=“xsd:anyURI”/>
  </xsd:simpleType>
  <!-- User Vocabulary -->
  <xsd:simpleType name=“ReadPointIDType”>
    <xsd:restriction base=“xsd:anyURI”/>
  </xsd:simpleType>
  <!-- User Vocabulary -->
  <xsd:simpleType name=“BusinessLocationIDType”>
    <xsd:restriction base=“xsd:anyURI”/>
  </xsd:simpleType>
  <!-- User Vocabulary -->
  <xsd:simpleType name=“BusinessTransactionIDType”>
    <xsd:restriction base=“xsd:anyURI”/>
  </xsd:simpleType>
  <!-- Standard Vocabulary -->
  <xsd:simpleType name=“BusinessTransactionTypeIDType”>
    <xsd:restriction base=“xsd:anyURI”/>
  </xsd:simpleType>
  <xsd:complexType name=“BusinessTransactionType”>
    <xsd:simpleContent>
      <xsd:extension base=“epcis:BusinessTransactionIDType”>
        <xsd:attribute name=“type”
type=“epcis:BusinessTransactionTypeIDType” use=“optional”/>
      </xsd:extension>
    </xsd:simpleContent>
  </xsd:complexType>
  <xsd:complexType name=“BusinessTransactionListType”>
    <xsd:sequence>
      <xsd:element name=“bizTransaction” type=“epcis:BusinessTransactionType”
maxOccurs=“unbounded”/>
    </xsd:sequence>
  </xsd:complexType>
  <!-- items listed alphabetically by name -->
  <!-- Some element types accommodate extensibility in the manner of
  “Versioning XML Vocabularies” by David Orchard (see
  http://www.xml.com/pub/a/2003/12/03/versioning.html).
  In this approach, an optional <extension> element is defined
  for each extensible element type, where an <extension> element
  may contain future elements defined in the target namespace.
  In addition to the optional <extension> element, extensible element
  types are declared with a final xsd:any wildcard to accommodate
  future elements defined by third parties (as denoted by the ##other
  namespace).
  Finally, the xsd:anyAttribute facility is used to allow arbitrary
  attributes to be added to extensible element types. -->
  <xsd:complexType name=“EPCISEventType” abstract=“true”>
    <xsd:annotation>
      <xsd:documentation xml:lang=“en”>
      base type for all EPCIS events.
      </xsd:documentation>
    </xsd:annotation>
    <xsd:sequence>
      <xsd:element name=“eventTime” type=“xsd:dateTime”/>
      <xsd:element name=“recordTime” type=“xsd:dateTime” minOccurs=“0”/>
      <xsd:element name=“baseExtension” type=“epcis:EPCISEventExtensionType”
minOccurs=“0”/>
      <xsd:any namespace=“##other” processContents=“lax” minOccurs=“0”
maxOccurs=“unbounded”/>
    </xsd:sequence>
    <xsd:anyAttribute processContents=“lax”/>
  </xsd:complexType>
  <xsd:complexType name=“ObjectEventType”>
    <xsd:annotation>
      <xsd:documentation xml:lang=“en”>
      Object Event captures information about an event pertaining to one or more
      objects identified by EPCs.
    </xsd:documentation>
    </xsd:annotation>
    <xsd:complexContent>
      <xsd:extension base=“epcis:EPCISEventType”>
        <xsd:sequence>
          <xsd:element name=“epcList” type=“epcis:EPCListType”/>
          <xsd:element name=“action” type=“epcis:ActionType”/>
          <xsd:element name=“bizStep” type=“epcis:BusinessStepIDType”
minOccurs=“0”/>
          <xsd:element name=“disposition”
type=“epcis:DispositionIDType” minOccurs=“0”/>
          <xsd:element name=“readPoint” type=“epcis:ReadPointIDType”
minOccurs=“0”/>
          <xsd:element name=“bizLocation”
type=“epcis:BusinessLocationIDType” minOccurs=“0”/>
          <xsd:element name=“bizTransactionList”
type=“epcis:BusinessTransactionListType” minOccurs=“0”/>
          <xsd:element name=“extension”
type=“epcis:ObjectEventExtensionType” minOccurs=“0”/>
          <xsd:any namespace=“##other” processContents=“lax”
minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“AggregationEventType”>
    <xsd:annotation>
      <xsd:documentation xml:lang=“en”>
      Aggregation Event captures an event that applies to objects that
      a physical association with one another.
    </xsd:documentation>
    </xsd:annotation>
    <xsd:complexContent>
      <xsd:extension base=“epcis:EPCISEventType”>
        <xsd:sequence>
          <xsd:element name=“parentID” type=“epcis:ParentIDType”
minOccurs=“0”/>
          <xsd:element name=“childEPCs” type=“epcis:EPCListType”/>
          <xsd:element name=“action” type=“epcis:ActionType”/>
          <xsd:element name=“bizStep” type=“epcis:BusinessStepIDType”
minOccurs=“0”/>
          <xsd:element name=“disposition”
type=“epcis:DispositionIDType” minOccurs=“0”/>
          <xsd:element name=“readPoint” type=“epcis:ReadPointIDType”
minOccurs=“0”/>
          <xsd:element name=“bizLocation”
type=“epcis:BusinessLocationIDType” minOccurs=“0”/>
          <xsd:element name=“bizTransactionList”
type=“epcis:BusinessTransactionListType” minOccurs=“0”/>
          <xsd:element name=“extension”
type=“epcis:AggregationEventExtensionType” minOccurs=“0”/>
          <xsd:any namespace=“##other” processContents=“lax”
minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“QuantityEventType”>
    <xsd:annotation>
      <xsd:documentation xml:lang=“en”>
      Quantity Event captures an event that takes place with respect to a
specified quantity of
      object class.
      </xsd:documentation>
    </xsd:annotation>
    <xsd:complexContent>
      <xsd:extension base=“epcis:EPCISEventType”>
        <xsd:sequence>
          <xsd:element name=“epcClass” type=“epcis:EPCClassType”/>
          <xsd:element name=“quantity” type=“xsd:int”/>
          <xsd:element name=“bizStep” type=“epcis:BusinessStepIDType”
minOccurs=“0”/>
          <xsd:element name=“disposition”
type=“epcis:DispositionIDType” minOccurs=“0”/>
          <xsd:element name=“readPoint” type=“epcis:ReadPointIDType”
minOccurs=“0”/>
          <xsd:element name=“bizLocation”
type=“epcis:BusinessLocationIDType” minOccurs=“0”/>
          <xsd:element name=“extension”
type=“epcis:QuantityEventExtensionType” minOccurs=“0”/>
          <xsd:any namespace=“##other” processContents=“lax”
minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“TransactionEventType”>
    <xsd:annotation>
      <xsd:documentation xml:lang=“en”>
      Transaction Event describes the association or disassociation of physical
objects to a
      transaction.
    </xsd:documentation>
    </xsd:annotation>
    <xsd:complexContent>
      <xsd:extension base=“epcis:EPCISEventType”>
        <xsd:sequence>
          <xsd:element name=“bizTransactionList”
type=“epcis:BusinessTransactionListType”/>
          <xsd:element name=“epcList” type=“epcis:EPCListType”/>
          <xsd:element name=“action” type=“epcis:ActionType”/>
          <xsd:element name=“bizStep” type=“epcis:BusinessStepIDType”
minOccurs=“0”/>
          <xsd:element name=“disposition”
type=“epcis:DispositionIDType” minOccurs=“0”/>
          <xsd:element name=“readPoint” type=“epcis:ReadPointIDType”
minOccurs=“0”/>
          <xsd:element name=“bizLocation”
type=“epcis:BusinessLocationIDType” minOccurs=“0”/>
          <xsd:element name=“extension”
type=“epcis:TransactionEventExtensionType” minOccurs=“0”/>
          <xsd:any namespace=“##other” processContents=“lax”
minOccurs=“0” maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“EPCISDocumentExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISHeaderExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISBodyExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISEventListExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“EPCISEventExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“ObjectEventExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“AggregationEventExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“QuantityEventExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
  <xsd:complexType name=“TransactionEventExtensionType”>
    <xsd:sequence>
      <xsd:any namespace=“##local” processContents=“lax” maxOccurs=“unbounded”/>
    </xsd:sequence>
    <xsd:anyAttribute processContents=“lax”/>
  </xsd:complexType>
</xsd:schema>
```

The following is an XML Schema (XSD) defining the XML binding of master data for the Core Event Types data definition module. This schema is only used for returning results from the SimpleMasterDataQuery query type.

```
<?xml version=“1.0” encoding=“UTF-8”?>
<xsd:schema xmlns:epcismd=“urn:epcglobal:epcis-masterdata:xsd:1”
  xmlns:sbdh=“http://www.unece.org/cefact/namespaces/StandardBusinessDocumentHeader”
  xmlns:epcglobal=“urn:epcglobal:xsd:1”
  xmlns:epcis=“urn:epcglobal:epcis:xsd:1”
  xmlns:xsd=“http://www.w3.org/2001/XMLSchema”
  targetNamespace=“urn:epcglobal:epcis-masterdata:xsd:1”
  elementFormDefault=“unqualified”
  attributeFormDefault=“unqualified”
  version=“1.0”>
  <xsd:annotation>
    <xsd:documentation xml:lang=“en”>
      <epcglobal:copyright>Copyright (C) 2005, 2004 EPCglobal Inc., All Rights
Reserved.</epcglobal:copyright>
      <epcglobal:disclaimer>EPCglobal Inc., its members, officers, directors, employees, or
agents shall not be liable for any injury, loss, damages, financial or otherwise, arising from,
related to, or caused by the use of this document. The use of said document shall constitute
your express consent to the foregoing exculpation.</epcglobal:disclaimer>
      <epcglobal:specification>EPC INFORMATION SERVICE (EPCIS) Version
1.0</epcglobal:specification>
    </xsd:documentation>
  </xsd:annotation>
  <xsd:import namespace=“urn:epcglobal:xsd:1” schemaLocation=“./EPCglobal.xsd”/>
  <xsd:import
      namespace=“http://www.unece.org/cefact/namespaces/StandardBusinessDocumentHeader”
      schemaLocation=“./StandardBusinessDocumentHeader.xsd”/>
  <xsd:import
    namespace=“urn:epcglobal:epcis:xsd:1”
    schemaLocation=“./EPCglobal-epcis-1_0.xsd”/>
  <!-- MasterData CORE ELEMENTS -->
  <xsd:element name=“EPCISMasterDataDocument” type=“epcismd:EPCISMasterDataDocumentType”/>
  <xsd:complexType name=“EPCISMasterDataDocumentType”>
    <xsd:annotation>
      <xsd:documentation xml:lang=“en”>
      MasterData document that contains a Header and a Body.
        </xsd:documentation>
    </xsd:annotation>
    <xsd:complexContent>
      <xsd:extension base=“epcglobal:Document”>
        <xsd:sequence>
          <xsd:element name=“EPCISHeader” type=“epcis:EPCISHeaderType” minOccurs=“0”/>
          <xsd:element name=“EPCISBody” type=“epcismd:EPCISMasterDataBodyType”/>
          <xsd:element name=“extension” type=“epcismd:EPCISMasterDataDocumentExtensionType”
minOccurs=“0”/>
          <xsd:any namespace=“##other” processContents=“lax” minOccurs=“0”
maxOccurs=“unbounded”/>
        </xsd:sequence>
        <xsd:anyAttribute processContents=“lax”/>
      </xsd:extension>
    </xsd:complexContent>
  </xsd:complexType>
  <xsd:complexType name=“EPCISMasterDataBodyType”>
    <xsd:annotation>
      <xsd:documentation xml:lang=“en”>
      MasterData specific body that contains Vocabularies.
            </xsd:documentation>
    </xsd:annotation>
        <xsd:sequence>
          <xsd:element name=“VocabularyList” type=“epcismd:VocabularyListType” minOccurs=“0”/>
          <xsd:element name=“extension” type=“epcismd:EPCISMasterDataBodyExtensionType”
minOccurs=“0”/>
          <xsd:any namespace=“##other” processContents=“lax” minOccurs=“0” maxOccurs=“unbounded”/>
        </xsd:sequence>
        <xsd:anyAttribute processContents=“lax”/>
      </xsd:complexType>
      <!-- MasterData CORE ELEMENT TYPES -->
      <xsd:complexType name=“VocabularyListType”>
        <xsd:sequence>
          <xsd:element name=“Vocabulary” type=“epcismd:VocabularyType” maxOccurs=“unbounded”/>
        </xsd:sequence>
      </xsd:complexType>
      <xsd:complexType name=“VocabularyType”>
        <xsd:sequence>
          <xsd:element name=“VocabularyElementList” type=“epcismd:VocabularyElementListType”
minOccurs=“0”/>
          <xsd:element name=“extension” type=“epcismd:VocabularyExtensionType” minOccurs=“0”/>
          <xsd:any namespace=“##other” processContents=“lax” minOccurs=“0” maxOccurs=“unbounded”/>
        </xsd:sequence>
        <xsd:attribute name=“type” type=“xsd:anyURI” use=“required”/>
        <xsd:anyAttribute processContents=“lax”/>
      </xsd:complexType>
      <xsd:complexType name=“VocabularyElementListType”>
        <xsd:sequence>
          <xsd:element name=“VocabularyElement” type=“epcismd:VocabularyElementType”
maxOccurs=“unbounded”/>
        </xsd:sequence>
      </xsd:complexType>
      <xsd:complexType name=“VocabularyElementType”>
        <xsd:sequence>
          <xsd:element name=“attribute” type=“epcismd:AttributeType” minOccurs=“0”
maxOccurs=“unbounded”/>
          <xsd:element name=“children” type=“epcismd:IDListType” minOccurs=“0”/>
          <xsd:element name=“extension” type=“epcismd:VocabularyElementExtensionType” minOccurs=“0”/>
          <xsd:any namespace=“##other” processContents=“lax” minOccurs=“0” maxOccurs=“unbounded”/>
        </xsd:sequence>
        <xsd:attribute name=“id” type=“xsd:anyURI” use=“required”/>
        <xsd:anyAttribute processContents=“lax”/>
      </xsd:complexType>
      <xsd:complexType name=“AttributeType”>
        <xsd:simpleContent>
          <xsd:extension base=“xsd:anyType”>
            <xsd:attribute name=“id” type=“xsd:anyURI” use=“required”/>
            <xsd:anyAttribute processContents=“lax”/>
          </xsd:extension>
        </xsd:simpleContent>
      </xsd:complexType>
      <xsd:complexType name=“IDListType”>
        <xsd:sequence>
          <xsd:element name=“id” type=“xsd:anyURI” minOccurs=“0” maxOccurs=“unbounded”/>
        </xsd:sequence>
        <xsd:anyAttribute processContents=“lax”/>
      </xsd:complexType>
      <xsd:complexType name=“EPCISMasterDataDocumentExtensionType”>
        <xsd:sequence>
          <xsd:any namespace=“##local” processContents=“lax” maxOccurs=“unbounded”/>
        </xsd:sequence>
        <xsd:anyAttribute processContents=“lax”/>
      </xsd:complexType>
      <xsd:complexType name=“EPCISMasterDataHeaderExtensionType”>
        <xsd:sequence>
          <xsd:any namespace=“##local” processContents=“lax” maxOccurs=“unbounded”/>
        </xsd:sequence>
        <xsd:anyAttribute processContents=“lax”/>
      </xsd:complexType>
      <xsd:complexType name=“EPCISMasterDataBodyExtensionType”>
        <xsd:sequence>
          <xsd:any namespace=“##local” processContents=“lax” maxOccurs=“unbounded”/>
        </xsd:sequence>
        <xsd:anyAttribute processContents=“lax”/>
      </xsd:complexType>
      <xsd:complexType name=“VocabularyExtensionType”>
        <xsd:sequence>
          <xsd:any namespace=“##local” processContents=“lax” maxOccurs=“unbounded”/>
        </xsd:sequence>
        <xsd:anyAttribute processContents=“lax”/>
      </xsd:complexType>
      <xsd:complexType name=“VocabularyElementExtensionType”>
        <xsd:sequence>
          <xsd:any namespace=“##local” processContents=“lax” maxOccurs=“unbounded”/>
        </xsd:sequence>
        <xsd:anyAttribute processContents=“lax”/>
      </xsd:complexType>
</xsd:schema>
```

The following schema defines request and response messages for each method in the Core Query Operations Module.

```
<?xml version=“1.0” encoding=“UTF-8”?>
<xsd:schema targetNamespace=“urn:epcglobal:epcis-query:xsd:1”
  xmlns:epcis=“urn:epcglobal:epcis:xsd:1”
  xmlns:epcismd=“urn:epcglobal:epcis-masterdata:xsd:1”
  xmlns:epcisq=“urn:epcglobal:epcis-query:xsd:1”
  xmlns:epcglobal=“urn:epcglobal:xsd:1”
  xmlns:xsd=“http://www.w3.org/2001/XMLSchema”
  elementFormDefault=“unqualified”
  attributeFormDefault=“unqualified”
  version=“1.0”>
  <xsd:annotation>
    <xsd:documentation xml:lang=“en”>
      <epcglobal:copyright>
        Copyright (C) 2005 EPCglobal Inc., All Rights Reserved.
      </epcglobal:copyright>
      <epcglobal:disclaimer>
          EPCglobal Inc., its members, officers, directors, employees, or
          agents shall not be liable for any injury, loss, damages, financial
          or otherwise, arising from, related to, or caused by the use of
          this document. The use of said document shall constitute your
          express consent to the foregoing exculpation.
      </epcglobal:disclaimer>
      <epcglobal:specification>
        EPCIS Query 1.0
      </epcglobal:specification>
    </xsd:documentation>
  </xsd:annotation>
  <xsd:import namespace=“urn:epcglobal:xsd:1” schemaLocation=“./EPCglobal.xsd”/>
  <xsd:import namespace=“urn:epcglobal:epcis:xsd:1” schemaLocation=“./EPCglobal-epcis-1_0.xsd”/>
  <xsd:import namespace=“urn:epcglobal:epcis-masterdata:xsd:1” schemaLocation=“./EPCglobal-epcis-
masterdata-1_0.xsd”/>
  <xsd:element name=“EPCISQueryDocument” type=“epcisq:EPCISQueryDocumentType”/>
  <xsd:complexType name=“EPCISQueryDocumentType”>
    <xsd:complexContent>
      <xsd:extension base=“epcglobal:Document”>
        <xsd:sequence>
          <xsd:element name=“EPCISHeader” type=“epcis:EPCISHeaderType” minOccurs=“0”/>
          <xsd:element name=“EPCISBody” type=“epcisq:EPCISQueryBodyType”/>
          <xsd:element name=“extension” type=“epcisq:EPCISQueryDocumentExtensionType”
minOccurs=“0”/>
          <xsd:any namespace=“##other” processContents=“lax” minOccurs=“0”
maxOccurs=“unbounded”/>
        </xsd:sequence>
        <xsd:anyAttribute processContents=“lax”/>
      </xsd:extension>
    </xsd:complexContent>
  </xsd:complexType>
      <xsd:complexType name=“EPCISQueryDocumentExtensionType”>
          <xsd:sequence>
              <xsd:any namespace=“##local” processContents=“lax” maxOccurs=“unbounded”/>
            </xsd:sequence>
            <xsd:anyAttribute processContents=“lax”/>
      </xsd:complexType>
  <xsd:complexType name=“EPCISQueryBodyType”>
    <xsd:choice>
      <!-- define, undefine, getQuery unimplemented in EPCIS 1.0
        <xsd:element ref=“epcisq:Define”/>
        <xsd:element ref=“epcisq:Undefine”/>
        <xsd:element ref=“epcisq:GetQuery”/>
        <xsd:element ref=“epcisq:GetQueryResult”/>
      -->
        <xsd:element ref=“epcisq:GetQueryNames”/>
        <xsd:element ref=“epcisq:GetQueryNamesResult”/>
        <xsd:element ref=“epcisq:Subscribe”/>
        <xsd:element ref=“epcisq:Unsubscribe”/>
        <xsd:element ref=“epcisq:GetSubscriptionIDs”/>
        <xsd:element ref=“epcisq:GetSubscriptionIDsResult”/>
        <xsd:element ref=“epcisq:Poll”/>
        <xsd:element ref=“epcisq:PollResult”/>
      <!-- immediate unimplemented in EPCIS 1.0
        <xsd:element ref=“epcisq:Immediate”/>
        <xsd:element ref=“epcisq:ImmediateResult”/>
      -->
        <xsd:element ref=“epcisq:GetStandardVersion”/>
        <xsd:element ref=“epcisq:GetStandardVersionResult”/>
        <xsd:element ref=“epcisq:GetVendorVersion”/>
        <xsd:element ref=“epcisq:GetVendorVersionResult”/>
        <xsd:element ref=“epcisq:EPCISException”/>
        <xsd:element ref=“epcisq:DuplicateNameException”/>
      <!-- queryValidationException unimplemented in EPCIS 1.0
        <xsd:element ref=“epcisq:QueryValidationException”/>
      -->
        <xsd:element ref=“epcisq:InvalidURIException”/>
        <xsd:element ref=“epcisq:NoSuchNameException”/>
        <xsd:element ref=“epcisq:NoSuchSubscriptionException”/>
        <xsd:element ref=“epcisq:DuplicateSubscriptionException”/>
        <xsd:element ref=“epcisq:QueryParameterException”/>
        <xsd:element ref=“epcisq:QueryTooLargeException”/>
        <xsd:element ref=“epcisq:QueryTooComplexException”/>
        <xsd:element ref=“epcisq:SubscriptionControlsException”/>
        <xsd:element ref=“epcisq:SubscribeNotPermittedException”/>
        <xsd:element ref=“epcisq:SecurityException”/>
        <xsd:element ref=“epcisq:ImplementationException”/>
        <xsd:element ref=“epcisq:StandingQueryResults”/>
      </xsd:choice>
    </xsd:complexType>
  <!-- EPCISSERVICE MESSAGE WRAPPERS -->
  <!-- define not implemented in EPCIS 1.0
  <xsd:element name=“Define” type=“epcisq:Define”/>
  <xsd:complexType name=“Define”>
      <xsd:sequence>
        <xsd:element name=“queryName” type=“xsd:string”/>
        <xsd:element name=“spec” type=“epcisq:Query”/>
      </xsd:sequence>
    </xsd:complexType>
    -->
    <!-- undefine not implemented in EPICS 1.0
    <xsd:element name=“Undefine” type=“epcisq:Undefine”/>
    <xsd:complexType name=“Undefined”>
      <xsd:sequence>
        <xsd:element name=“queryName” type=“xsd:string”/>
      </xsd:sequence>
    </xsd:complexType>
    -->
    <!-- getQuery not implemented in EPCIS 1.0
    <xsd:element name=“GetQuery” type=“epcisq:GetQuery”/>
    <xsd:complexType name=“GetQuery”>
      <xsd:seqence>
        <xsd:element name=“queryName” type=“xsd:string”/>
      </xsd:seqence>
    </xsd:complexType>
    <xsd:element name=“GetQueryResult” type=“epcisq:Query”/>
    -->
    <xsd:element name=“GetQueryNames” type=“epcisq:EmptyParms”/>
    <xsd:element name=“GetQueryNameResult” type=“epcisq:ArrayOfString”/>
    <xsd:element name=“Subscribe” type=“epcisq:Subscribe”/>
    <xsd:complexType name=“Subscribe”>
      <xsd:sequence>
        <xsd:element name=“queryName” type=“xsd:string”/>
        <xsd:element name=“params” type=“epcisq:QueryParams”/>
        <xsd:element name=“dest” type=“xsd:string”/>
        <xsd:element name=“controls” type=“epcisq:SubscriptionControls”/>
        <xsd:element name=“subscriptionID” type=“xsd:string”/>
      </xsd:sequence>
    </xsd:complexType>
    <xsd:element name=“Unsubscribe” type=“epcisq:Unsubscribe”/>
    <xsd:complexType name=“Unsubscribe”>
      <xsd:sequence>
        <xsd:element name=“subscriptionID” type=“xsd:string”/>
      </xsd:sequence>
    </xsd:complexType>
    <xsd:element name=“GetSubscriptionIDs” type=“epcisq:GetSubscriptionIDs”/>
    <xsd:complexType name=“GetSubscriptionIDs”>
      <xsd:sequence>
        <xsd:element name=“queryName” type=“xsd:string”/>
      </xsd:sequence>
    </xsd:complexType>
    <xsd:element name=“GetSubscriptionIDsResult” type=“epcisq:ArrayOfString”/>
    <xsd:element name=“Poll” type=“epcisq:Poll”/>
    <xsd:complexType name=“Poll”>
      <xsd:sequence>
        <xsd:element name=“queryName” type=“xsd:string”/>
        <xsd:element name=“params” type=“epcisq:QueryParams”/>
      </xsd:sequence>
    </xsd:complexType>
    <xsd:element name=“PollResult” type=“epcisq:OnDemandQueryResults”/>
    <!-- immediate not implemented in EPCIS 1.0
    <xsd:element name=“Immediate” type=“epcisq:Immediate”/>
    <xsd:complexType name=“Immediate”>
      <xsd:sequence>
        <xsd:element name=“query” type=“epcisq:Query”/>
      </xsd:sequence>
    </xsd:complexType>
    <xsd:element name=“ImmediateResult” type=“epcisq:OnDemandQueryResults”/>
    -->
    <xsd:element name=“GetStandardVersion” type=“epcisq:EmptyParms”/>
    <xsd:element name=“GetStandardVersionResult” type=“xsd:string”/>
    <xsd:element name=“GetVendorVersion” type=“epcisq:EmptyParms”/>
    <xsd:element name=“GetVendorVersionResult” type=“xsd:string”/>
    <xsd:element name=“VoidHolder” type=“epcisq:VoidHolder”/>
    <xsd:complexType name=“VoidHolder”>
      <xsd:sequence>
      </xsd:sequence>
    </xsd:complexType>
    <xsd:complexType name=“EmptyParms”/>
    <xsd:complexType name=“ArrayOfString”>
      <xsd:sequence>
        <xsd:element name=“string” type=“xsd:string” minOccurs=“0” maxOccurs=“unbounded”/>
      </xsd:sequence>
    </xsd:complexType>
    <xsd:complexType name=“SubscriptionControls”>
      <xsd:sequence>
        <xsd:element name=“schedule” type=“epcisq:QuerySchedule”/>
        <xsd:element name=“trigger” type=“xsd:string”/>
        <xsd:element name=“initialRecordTime” type=“xsd:dateTime”/>
        <xsd:element name=“reportIfEmpty” type=“xsd:boolean”/>
        <xsd:element name=“extension” type=“epcisq:SubscriptionControlsExtensionType”
minOccurs=“0”/>
        <xsd:any namespace=“##other” processContents=“lax” minOccurs=“0” maxOccurs=“unbounded”/>
      </xsd:sequence>
    </xsd:complexType>
    <xsd:complexType name=“SubscriptionControlsExtensionType”>
      <xsd:sequence>
        <xsd:any namespace=“##local” processContents=“lax” maxOccurs=“unbounded”/>
      </xsd:sequence>
      <xsd:anyAttribute processContents=“lax”/>
    </xsd:complexType>
    <xsd:complexType name=“QuerySchedule”>
      <xsd:sequence>
        <xsd:element name=“second” type=“xsd:string” minOccurs=“0”/>
        <xsd:element name=“minute” type=“xsd:string” minOccurs=“0”/>
        <xsd:element name=“hour” type=“xsd:string” minOccurs=“0”/>
        <xsd:element name=“dayOfMonth” type=“xsd:string” minOccurs=“0”/>
        <xsd:element name=“month” type=“xsd:string” minOccurs=“0”/>
        <xsd:element name=“dayOfWeek” type=“xsd:string” minOccurs=“0”/>
      <xsd:element name=“extension” type=“epcisq:QueryScheduleExtensionType” minOccurs=“0”/>
      <xsd:any namespace=“##other” processContents=“lax” minOccurs=“0” maxOccurs=“unbounded”/>
      </xsd:sequence>
    </xsd:complexType>
    <xsd:complexType name=“QueryScheduleExtensionType”>
      <xsd:sequence>
        <xsd:any namespace=“##local” processContents=“lax” maxOccurs=“unbounded”/>
      </xsd:sequence>
      <xsd:anyAttribute processContents=“lax”/>
    </xsd:complexType>
    <xsd:complexType name=“QueryParams”>
      <xsd:sequence>
        <xsd:element name=“param” type=“epcisq:QueryParam” minOccurs=“0” maxOccurs=“unbounded”/>
      </xsd:sequence>
    </xsd:complexType>
    <xsd:complexType name=“QueryParam”>
      <xsd:sequence>
        <xsd:element name=“name” type=“xsd:string”/>
        <!-- See note in EPCIS spec text regarding the value for this element -->
        <xsd:element name=“value” type=“xsd:anyType”/>
      </xsd:sequence>
    </xsd:complexType>
    <xsd:complexType name=“OnDemandQueryResults”>
      <xsd:sequence>
        <xsd:element name=“resultsBody” type=“epcisq:QueryResultsBody”/>
        <xsd:element name=“extension” type=“epcisq:OnDemandQueryResultsExtensionType”
minOccurs=“0”/>
        <xsd:any namespace=“##other” processContents=“lax” minOccurs=“0” maxOccurs=“unbounded”/>
      </xsd:sequence>
    </xsd:complexType>
    <xsd:complexType name=“OnDemandQueryResultsExtensionType”>
      <xsd:sequence>
        <xsd:any namespace=“##local” processContents=“lax” maxOccurs=“unbounded”/>
      </xsd:sequence>
      <xsd:anyAttribute processContents=“lax”/>
    </xsd:complexType>
    <xsd:element name=“StandingQueryResults” type=“epcisq:StandingQueryResults”/>
    <xsd:complexType name=“StandingQueryResults”>
      <xsd:sequence>
        <xsd:element name=“queryName” type=“xsd:string”/>
        <xsd:element name=“subscriptionID” type=“xsd:string”/>
        <xsd:element name=“resultsBody” type=“epcisq:QueryResultsBody”/>
        <xsd:element name=“extension” type=“epcisq:StandingQueryResultsExtensionType”
minOccurs=“0”/>
        <xsd:any namespace=“##other” processContents=“lax” minOccurs=“0” maxOccurs=“unbounded”/>
      </xsd:sequence>
    </xsd:complexType>
    <xsd:complexType name=“StandingQueryResultsExtensionType”>
      <xsd:sequence>
        <xsd:any namespace=“##local” processContents=“lax” maxOccurs=“unbounded”/>
      </xsd:sequence>
      <xsd:anyAttribute processContents=“lax”/>
    </xsd:complexType>
    <xsd:complexType name=“QueryResultsBody”>
      <xsd:choice>
        <xsd:element name=“eventList” type=“epcis:EventListType”/>
        <xsd:element name=“vocabularyList” type=“epcismd:VocabularyListType”/>
        <!-- Note that QueryTooLargeException can only occur here as part of a standing
          query result. For poll or immediate, query too large would be raised as
          an exception rather than returned as part of the (non-exception) result
          -->
        <xsd:element name=“QueryTooLargeException” type=“epcisq:QueryTooLargeException”/>
      </xsd:choice>
    </xsd:complexType>
    <!-- EPCIS EXCEPTIONS -->
    <xsd:element name=“EPCISException” type=“epcisq:EPCISException”/>
    <xsd:complexType name=“EPCISException”>
      <xsd:sequence>
        <xsd:element name=“reason” type=“xsd:string”/>
      </xsd:sequence>
    </xsd:complexType>
    <xsd:element name=“DuplicateNameException” type=“epcisq:DuplicateNameException”/>
    <xsd:complexType name=“DuplicateNameException”>
      <xsd:complexContent>
        <xsd:extension base=“epcisq:EPCISException”>
          <xsd:sequence/>
        </xsd:extension>
      </xsd:complexContent>
    </xsd:complexType>
    <!-- QueryValidationException not implemented in EPCIS 1.0
    <xsd:element name=“QueryValidationException” type=“epcisq:QueryValidationException”/>
    <xsd:complexType name=“QueryValidationException”>
      <xsd:complexContent>
        <xsd:extension base=“epcisq:EPCISException”>
          <xsd:sequence/>
        </xsd:extension>
      </xsd:complexContent>
    </xsd:complexType>
    -->
    <xsd:element name=“InvalidURIException” type=“epcisq:InvalidURIException”/>
    <xsd:complexType name=“InvalidURIException”>
      <xsd:complexContent>
        <xsd:extension base=“epcisq:EPCISException”>
          <xsd:sequence/>
        </xsd:extension>
      </xsd:complexContent>
    </xsd:complexType
    <xsd:element name=“NoSuchNameException” type=“epcisq:NoSuchNameException”/>
    <xsd:complexType name=“NoSuchNameException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“NoSuchSubscriptionException” type=“epcisq:NoSuchSubscriptionException”/>
    <xsd:complexType name=“NoSuchSubscriptionException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“DuplicateSubscriptionException”
type=“epcisq:DuplicateSubscriptionException”/>
    <xsd:complexType name=“DuplicateSubscriptionException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“QueryParameterException” type=“epcisq:QueryParameterException”/>
    <xsd:complexType name=“QueryParameterException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“QueryTooLargeException” type=“epcisq:QueryTooLargeException”/>
    <xsd:complexType name=“QueryTooLargeException”>
      <xsd:complexContent>
        <xsd:extension base=“epcisq:EPCISException”>
          <xsd:sequence>
            <xsd:element name=“queryName” type=“xsd:string” minOccurs=“0”/>
            <xsd:element name=“subscriptionID” type=“xsd:string” minOccurs=“0”/>
          </xsd:sequence>
        </xsd:extension>
      </xsd:complexContent>
    </xsd:complexType>
    <xsd:element name=“QueryTooComplexException” type=“epcisq:QueryTooComplexException”/>
    <xsd:complexType name=“QueryTooComplexException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“SubscriptionControlsException” type=“epcisq:SubscriptionControlsException”/>
    <xsd:complexType name=“SubscriptionControlsException”>
      <xsd:complexContent>
        <xsd:extension base=“epcisq:EPCISException”>
        <xsd:sequence/>
        </xsd:extension>
      </xsd:complexContent>
    </xsd:complexType>
    <xsd:element name=“SubscribeNotPermittedException”
type=“epcisq:SubscribeNotPermittedException”/>
    <xsd:complexType name=“SubscribeNotPermittedException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“SecurityException” type=“epcisq:SecurityException”/>
    <xsd:complexType name=“SecurityException”>
      <xsd:complexContent>
        <xsd:extension base=“epcisq:EPCISException”>
          <xsd:sequence/>
        </xsd:extension>
      </xsd:complexContent>
    </xsd:complexType>
    <xsd:element name=“ImplementationException”
            type=“epcisq:ImplementationException”/>
    <xsd:complexType name=“ImplementationException”>
      <xsd:complexContent>
        <xsd:extension base=“epcisq:EPCISException”>
          <xsd:sequence>
            <xsd:element name=“severity”
              type=“epcisq:ImplementationExceptionSeverity”/>
          </xsd:sequence>
        </xsd:extension>
      </xsd:complexContent>
    </xsd:complexType>
    <xsd:simpleType name=“ImplementationExceptionSeverity”>
      <xsd:restriction base=“xsd:NCName”>
        <xsd:enumeration value=“ERROR”/>
        <xsd:enumeration value=“SEVERE”/>
      </xsd:restriction>
    </xsd:simpleType>
</xsd:schema>
```

The following diagram defines the tables used to store the EPCIS Query objects. These tables can be derived based on the EPCIS Query Data objects. The EPCIS Query tables can augment the existing EPCIS database schema by adding support for persistence of subscription information.

The following table defines the database schema used to store the EPCIS Query objects for one embodiment.

| | | Column | Attrib- |
|---|---|---|---|
| Table Name | Column Name | Type | utes |
| subscription | subscription_id | VARCHAR | Key |
| | | (255) | |
| | notification_uri | VARCHAR | |
| | | (255) | |
| | query_name | VARCHAR | |
| | | (255) | |
| query_parameter | parent_subscription_id | VARCHAR | Key |
| | | (255) | |
| | name | VARCHAR | Key |
| | | (255) | |
| | value | VARCHAR | |
| | | (255) | |
| subscription_controls | parent_subscription_id | VARCHAR | Key |
| | | (255) | |
| | initial_record_time | DATE | |
| | report_if_empty | BOOLEAN | |
| query_schedule | parent_subscription_id | VARCHAR | Key |
| | | (255) | |
| | second | INTEGER | |
| | minute | INTEGER | |
| | hour | INTEGER | |
| | day_of_month | INTEGER | |
| | month | INTEGER | |
| | day_of_week | INTEGER | |

The following table defines the database schema used to store the EPCIS Event objects of one embodiment.

| Table Name | Column Name | Column Type | Attributes |
|---|---|---|---|
| epcis_event | action | VARCHAR(255) | |
| | business_location_uri | VARCHAR(255) | |
| | business_step_uri | VARCHAR(255) | |
| | business_transaction_uri | VARCHAR(255) | |
| | disposition_uri | VARCHAR(255) | |
| | event_id | INTEGER | Key |
| | event_time | DATETIME | |
| | event_type | VARCHAR(64) | |
| | guid | VARCHAR(255) | |
| | read_point_uri | VARCHAR(255) | |
| | record_time | DATETIME | |
| epcis_event_epc | event_epc_id | INTEGER | Key |
| | event_id | INTEGER | |
| | child_epc_id | INTEGER | |
| | child_quantity | INTEGER | |
| | parent_epc_id | INTEGER | |
| epc | epc_id | INTEGER | Key |
| | uri | VARCHAR(255) | |
| | scheme | VARCHAR(255) | |
| | pure_identity_uri | VARCHAR(64) | |
| | filter_value | VARCHAR(64) | |
| | company_prefix | VARCHAR(64) | |
| | reference | VARCHAR(64) | |
| | serial_number | VARCHAR(64) | |
| epcis_event_extension | extension_id | INTEGER | Key |
| | event_id | INTEGER | |
| | child_extension_id | INTEGER | |
| | name | VARCHAR(255) | |
| | value | VARCHAR(255) | |
| business_transaction | business_transaction_id | INTEGER | Key |
| | event_id | INTEGER | |
| | type | VARCHAR(255) | |
| | business_transaction | VARCHAR(255) | |

SQL Views can provide access to the Database tables to support the requirement to provide direct access to the database.

A Web based user interface can support administration of EPCIS Query

Subscriptions. Functionality can include creation, modification, and deletion of subscriptions and associated information.

The ALECLI can be extended to support the EPCIS Query interface. The CLI can provide a framework for EPCIS Query automated testing and may eventually be exposed as a public interface. The EPCIS Query CLI can provide support for creation, display, deletion and modification of EPCIS Query Subscriptions.

EPCIS Query Subscription Creation:

```
epcis create subscription <subscription_name>
  query <query-name>
  [initial-record-time <time>]
  [report-if-empty <true/false>]
  [query-schedule
    [ second <second>]
    [ minute <minute> ]
    [hour <hour> ]
    [day-of-month <day> ]
    [month <month> ]
    [day-of-week <day> ]
  ]
  [query-name-value
    ( name <name> value <value> ) *
  ]
```

Subscription Display:
show epcis subscription [<subscription-id>]
Display the subscription with matching subscription id. If the subscription id is omitted, display all subscriptions.
show epcis subscription-id-list
Display the list of subscription-ids for all defined subscriptions.
   Subscription Deletion: epcis delete subscription <subscription-id>
Remove the subscription of given subscription id.
   Subscription Import/Export (as XML):
epcis subscription (import|(export [<subscription-id>]) file <file-name>
If the subscription-id is not specified, then all subscriptions are included in the export.
   EPCIS Query
show epcis event (options . . . .
Update the show command to support all parameters that may be used to specify a QueryParameter.

This document outlines the design for managing enterprise data (information about products, destinations, label templates, and company prefixes) used by compliance express clients.

Information about products, destinations, and label templates was formerly managed by each individual compliance express client, and this can give customers a single place to manage that data. Compliance express clients can update their caches of this data from the Enterprise Server.

Company prefixes can be maintained at the enterprise level and compliance express clients can update local caches of that data from the Enterprise Server

This document can cover the web service and its backing components.

Enterprise Server can provide for maintenances of compliance express-specific enterprise data (Products, Label Templates, Destinations, and Company Prefixes) so that it may be accessed by multiple compliance express clients. It can also provide a web UI for adding, editing, and deleting this data. For backwards compatibility it can support the use of the same comma separated value (csv)-formatted files that were used to import data in compliance express and it can continue to support the CJS database views.

Compliance express Enterprise Data can allow customers to maintain a central repository of data about products, destinations, label templates, and company prefixes. Access to this data can be exposed to compliance express via a web service. A web GUI interface using JSF can allow customers to maintain the information in the repository by either: (a) adding, editing, and deleting individual records or (b) importing files containing groups of records.

This component can use basically the same architecture as the Master Data and Provisioning Service components.

Public access to compliance express enterprise data can be provided by the following interfaces.
SOAP Interfaces (one each for products, destinations, label templates, and company prefixes)
Web based user interface
SQL Views into the database tables.

Non public access to compliance express Enterprise Data is provided by the following interfaces:
Java API
EJB Stateless Session Bean

The compliance express Enterprise Data Service can be composed of the following implementation components:
Java API
EJB Stateless Session Bean (common entry point for public interfaces providing transaction and threading management).
WLS SOAP Service (implementation engine for SOAP Service)
Implementation of Java API
Persistence Object Layer, JDO, provides object to relational database mapping.
Relational Database Schema
Java Server Faces User Interface

The Enterprise Server is deployed as a WLS application in the form of an expanded ear file. The compliance express Enterprise Data Service is deployed as four services within the Enterprise Server.

The compliance express Enterprise Data Service can be implemented following the standard service implementation model previously used by the EPCIS and EPCPS Services. FIG. 4A outlines the CX Enterprise Data implementation components.

This section can detail the classes for implementing compliance express Enterprise Data for Products. For the remaining types of information—destinations, label templates, and company prefixes—only the Java APIs are provided for review as the implementation can be identical.

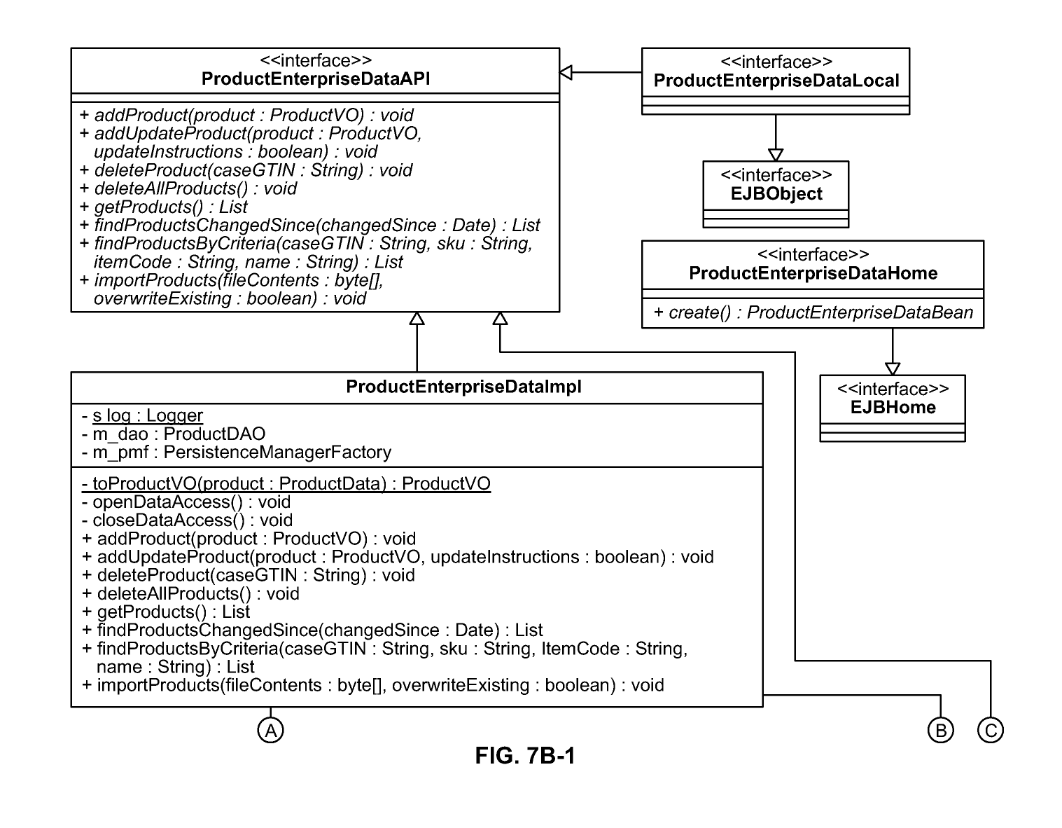

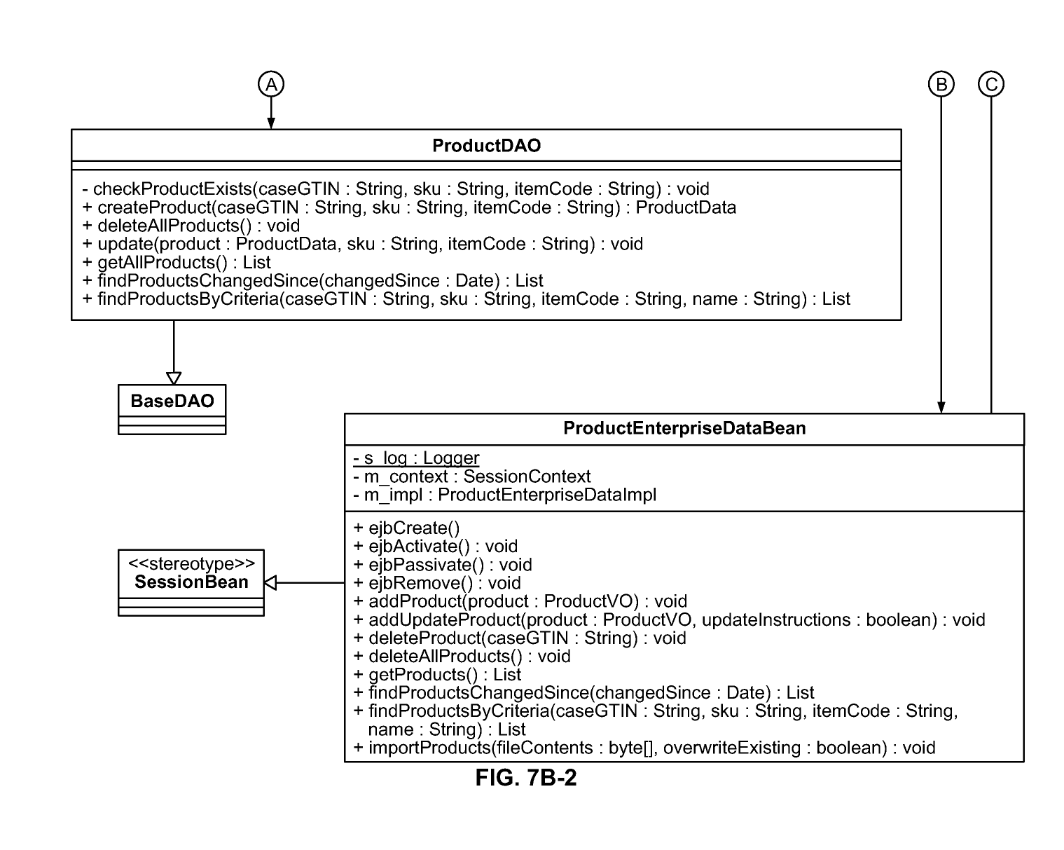

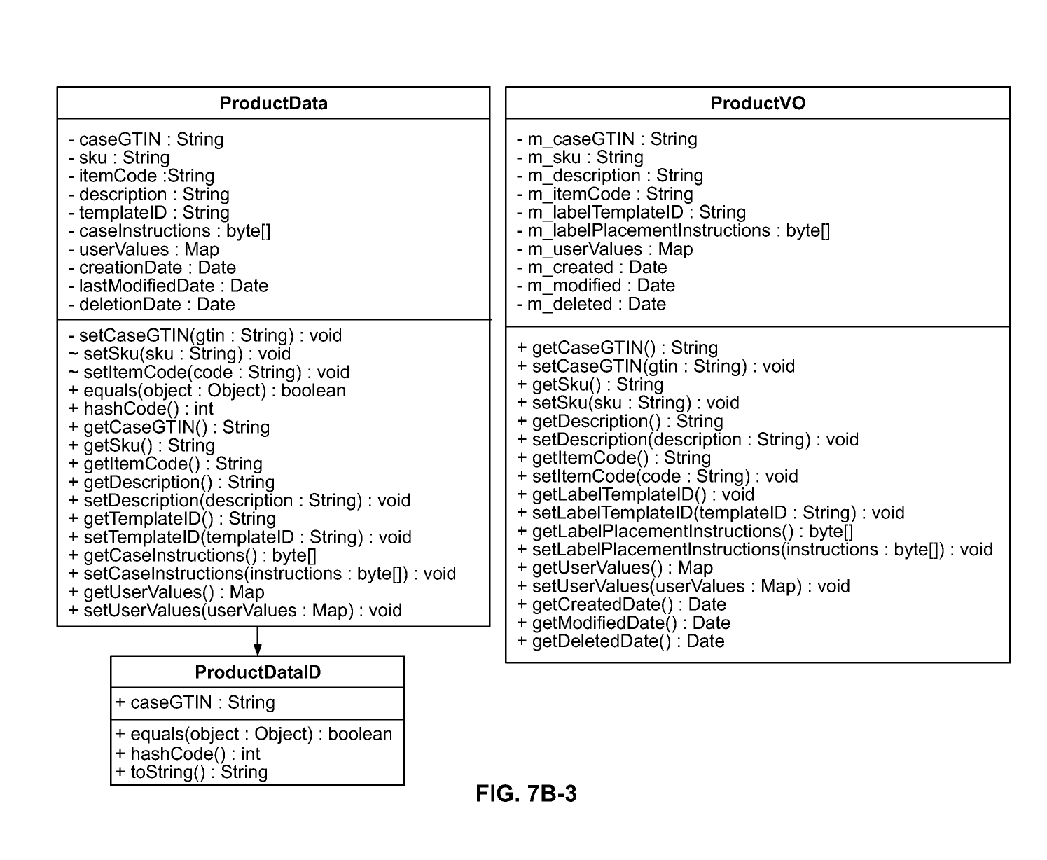

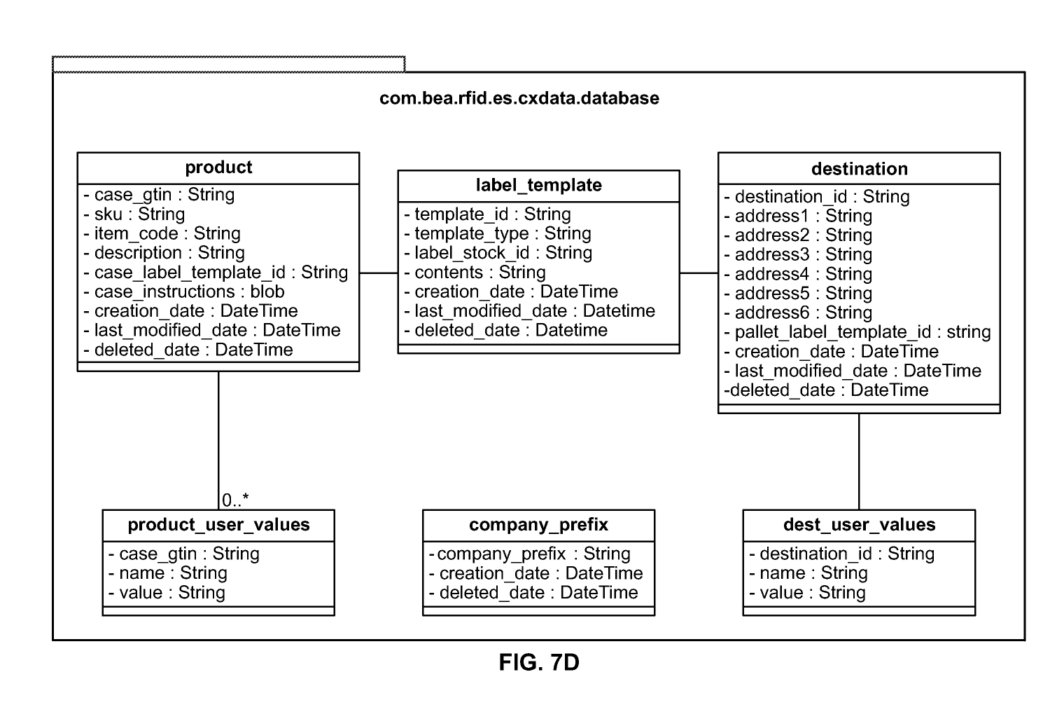

FIG. 7B shows UML for Product API, persistence layer, and implementation class of one embodiment.

FIG. 7C shows Java APIs for Destination, Label Template, and Company Prefix Enterprise Data.

The APIs for compliance express Enterprise Data are designed to: (a) provide methods that compliance express clients can use to get updated enterprise data; and (b) provide methods that can support editing and importing compliance express Enterprise Data via the web interface. For compliance express clients, two methods for retrieving products are provided, one of which limits the number of records returned by specifying a date from which changes is desired. For the web interface, the API provides add/update/delete methods. An import method can allow files uploaded by a web interface to be imported into the database. And, finally, search methods are provided to assist users in finding records they wish to edit; in this version, that means allowing them to perform wildcard searches on selected fields. The API can be implemented by the implementation file, the stateless session bean, and the web service. The API package can also include a Value Object for the data that is managed in that package.

The Session Beans package can include a stateless session bean and home and local interfaces. The bean implements the ProductEnterpriseDataAPI and basically acts as a pass-though to the implementation class. In conjunction with WLS, the session bean can handle transaction and thread management.

The JDO Persistence Layer can provide the object to relational mapping required for persisting objects to the database. This package can contain the data access object and persistence-enabled data objects for each data type.

There can be one implementation class for each API. It also includes a static utility method to create a value object from the data in a persistence-enabled data object.

A Soap Interface can include WSDL to implement the compliance express Enterprise Data APIs.

This database schema can be such that the company_prefix table is new, and there is a deleted_date column in each of the main tables (product, destination, label_template). Since compliance express clients can query for changes since a given date, there needs to be some way to indicate that a record has been deleted. When this field is non-null, it indicates that a record has been deleted; compliance express clients can delete it from their local caches and it can not be displayed in the web interface for editing. If a user tries to add a record with a primary key identical to one that has been deleted, the old record can be overwritten with the new data and the deleted date can be set to null. The company prefix need not have a modified date and one embodiment. Its only field is the primary key, which may not be modified.

FIG. 7F shows JOD Implemenmtation Model of one embodiment.

| Table Name | Column Name | Column Type | Attributes |
|---|---|---|---|
| product | case_gtin | VARCHAR(14) | Primary key |
| | sku | VARCHAR(255) | |
| | itemCode | VARCHAR(14) | |
| | description | VARCHAR(255) | |
| | case_label_template_id | VARCHAR(255) | |
| | case_instructions | BLOB | |
| | creation_date | DATETIME | |
| | last_modified_date | DATETIME | |
| | deleted_date | DATETIME | |
| product_user_values | case_gtin | VARCHAR(14) | |
| | name | VARCHAR(255) | |
| | value | VARCHAR(255) | |
| label_template | template_id | VARCHAR(255) | Primary key |
| | template_type | VARCHAR(20) | |
| | label_stock_id | VARCHAR(255) | |
| | contents | TEXT | |
| | creation_date | DATETIME | |
| | last_modified_date | DATETIME | |
| | deleted_date | DATETIME | |
| destination | destination_id | VARCHAR(255) | |
| | address1 | VARCHAR(255) | |
| | address2 | VARCHAR(255) | |
| | address 3 | VARCHAR(255) | |
| | address 4 | VARCHAR(255) | |
| | address5 | VARCHAR(255) | |
| | address6 | VARCHAR(255) | |
| | pallet_label_template_id | VARCHAR(255) | |
| | creation_date | DATETIME | |
| | last_modified_date | DATETIME | |
| | deleted_date | DATETIME | |
| dest_user_values | destination_id | VARCHAR(255) | |
| | name | VARCHAR(255) | |
| | value | VARCHAR(255) | |
| company_prefix | company_prefix | VARCHAR(12) | Primary key |
| | creation_date | DATETIME | |
| | deleted_date | DATETIME | |

The compliance express Enterprise Data user interface is implemented with Java Server Faces (JSF). The JSF implementation is composed of JSF pages, one or more management classes, and the compliance express Enterprise Data Java API objects. Following the Model View Controller (MVC) pattern, the compliance express Enterprise Data Java API classes provide the model, the JSF pages provide the View, and the Management class acts as the Controller. The Management class delegates to the interface provided by the compliance express Enterprise Data EJB Session bean.

One embodiment may be implemented using a conventional general purpose of a specialized digital computer or microprocessor(s) programmed according to the teachings of the present disclosure, as can be apparent to those skilled in the computer art. Appropriate software coding can readily be prepared by skilled programmers based on the teachings of the present discloser, as can be apparent to those skilled in the software art. The invention may also be implemented by the preparation of integrated circuits or by interconnecting an appropriate network of conventional component circuits, as can be readily apparent to those skilled in the art.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media), the present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code; or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

The forgoing description of preferred embodiments of the present invention has been provided for the purposes of illustration and description. It is not intended to be exhaustive or to limit the invention to the precise forms disclosed. Many modifications and variations can be apparent to one of ordinary skill in the relevant arts. For example, steps preformed in the embodiments of the invention disclosed can be performed in alternate orders, certain steps can be omitted, and additional steps can be added. The embodiments where chosen and described in order to best explain the principles of the invention and its practical application, thereby enabling others skilled in the art to understand the invention for various embodiments and with various modifications that are suited to the particular used contemplated. It is intended that the scope of the invention be defined by the claims and their equivalents.

What is claimed is:

1. An RFID enterprise server master data, the master data being non RFID data, the master data being stored such that new master data types can be added without changing a format of a master data type table.

2. The RFID enterprise server of claims 1, further storing ECPCIS events.

3. The RFID enterprise server of claims 1, wherein the master data database has a type table indicating mater data types, an attribute table including master data attributes a type instance table indicating instances of the master data types, and a master data attribute instance table indicating master data attribute instances.

4. The RFID enterprise server of claim 1, wherein master data attributes link to the master data types.

5. The RFID enterprise server of claims 1, wherein attribute instances link to the corresponding type instance.

6. The RFID enterprise system of claims 1, wherein the master data types include location information.

7. The RFID enterprise storer of claims 1, wherein the master data types include shipping related information.

8. The RFID enterprise server of claim 1, wherein an interface allows for adding master data types.

9. An RFID enterprise server master data, the master data being non RFID data, the master data being stored such that new master data types can be added without changing a format of a master data type table; wherein the master data database has a type table indicating mater data types, an attribute table including master data attributes, a type instance table indicating instances of the master data types, and a master data attribute instance table indicating master data attribute instances.

10. The RFID enterprise server of claims 9, further storing ECPCIS events.

11. The RFID enterprise server of claims 9, wherein master data attributes link to master data types.

12. The RFID enterprise server of claims 9, wherein the attribute instances link to the corresponding type instance.

13. The RFID enterprise system of claims 9, wherein the master data types include location information.

14. The RFID enterprise storer of claims 9, wherein the master data types include shipping related information.

15. The RFID enterprise server of claim 9, wherein an interface allows for adding master data types.

16. An RFID enterprise server receiving RFID data from a number of RFID edge servers, the RFID enterprise server being adapted to produce a number of reports, the report including a history report including where RFID tagged objects have been, a missing asset report indicating which RFID trackable assets are missing, a dwell time report indicating the dwell time of RFID trackable assets at a location, and a transit report indicating the transport time of RFID trackable assets.
